(19) United States
(12) Patent Application Publication
(10) Pub. No.: US 2016/0102837 A1
(43) Pub. Date: Apr. 14, 2016

(54) EXTENDED LED LIGHT SOURCE WITH OPTIMIZED FREE-FORM OPTICS

(71) Applicants: William E. Phillips, III, Cincinnati, OH (US); Todd S. Rutherford, Cincinnati, OH (US)

(72) Inventors: William E. Phillips, III, Cincinnati, OH (US); Todd S. Rutherford, Cincinnati, OH (US)

(21) Appl. No.: 14/510,106

(22) Filed: Oct. 8, 2014

(51) Int. Cl. F21V 5/04

(52) U.S. Cl. CPC F21V 5/04; F21Y 2101/02

(57) ABSTRACT

A shaped lens for use with an LED device to produce a rectangular light pattern on a surface; wherein the LED device comprises a square extended area LED emitting surface (an emitter greater than 1 mm square). A refracting surface of the lens extends upward from a horizontal x-y plane having the square emitter extending horizontally and centered at the x-y-z origin, wherein the lens surface exhibits both two-axis orthogonal symmetry and 180 degree rotational symmetry about the central z-axis; and wherein the lens surface profile around the periphery of any horizontal section is generally rectangular with obtuse corner angles and is generally convex between corner angles; and further wherein the lens surface profile in any vertical section passing through the origin is generally convex upward and inward from the base plane through an apex and continuing convex downward and inward to an intermediate height end point at the z-axis.

### CROSS-REFERENCE TO RELATED APPLICATIONS

This application is a Continuation of U.S. application Ser. No. 13/557,207 filed Jul. 24, 2012 by William E. Phillips, et al. and entitled EXTENDED LED LIGHT SOURCE WITH COLOR DISTRIBUTION CORRECTING OPTICS (Attorney Docket No. ELI-111); which claims the benefit of U.S. Provisional Application No. 61/511,085 filed Jul. 24, 2011 by William E. Phillips, et al., and entitled LED LIGHTING APPARATUS, OPTICS, AND DESIGN METHODS (Attorney Docket No. ELI-110,111,112prv); and which is a Continuation In Part of U.S. application Ser. No. 13/483,045 filed May 29, 2012 by William E. Phillips, et al. and entitled REFLECTORS OPTIMIZED FOR LED LIGHTING FIXTURE (Attorney Docket No. ELI-113); which claims the benefit of U.S. Provisional Application No. 61/490,265 filed May 26, 2011 by William E. Phillips, and entitled LED LIGHTING APPARATUS WITH REFLECTORS (Attorney Docket No. ELI-109prv); and of U.S. Provisional Application No. 61/490,278 filed May 26, 2011 by William E. Phillips, and entitled BACK REFLECTOR OPTIMIZED FOR LED LIGHTING FIXTURE (Attorney Docket No. ELI-113prv).

All of the applications listed hereinabove have at least one applicant in common, and all are incorporated in their entirety herein by reference.

### TECHNICAL FIELD OF THE INVENTION

The present invention relates generally to the field of lighting systems and, more particularly, to apparatus for utilizing LED (light emitting diode) sources for illuminating areas with a predefined pattern of light intensity on a ground plane.

### BACKGROUND OF THE INVENTION

With a continuing quest for lighting apparatus which is low-cost and energy efficient, LEDs have proven to provide light sources which are inherently energy efficient and with advances in LED technology, continue to increase power efficiency as well as life. Further improvements in overall efficiency are sought by efforts to improve the utilization of light output being directed into a desired lighting area. Being that LEDs used as light sources are typically of a small size, there is an additional cost-efficiency and other benefits because the fixtures can be more compact, thereby, for example, reducing material usage, weight, and wind resistance for LED lighting apparatuses.

Lighting systems for various uses typically require the prevention of stray light entering areas not intended to be lit. For example, roadway and parking lot lighting systems are designed to have high levels of light distribution over areas which are to be lighted, while neighboring regions are as free of light as possible. For example, outdoor lighting should not emit light “upward” into the sky. That is, there is a need to be able to direct light in a desired downward and lateral direction onto a predetermined section of property while avoiding light distribution onto an adjacent property. Commonly used “predetermined sections of property” may be referenced according to IES standards for “large area” lighting patterns on a planar surface such as the “ground”. Well-known IES standards for “Type II, Type III, Type IV, and Type V” illuminance patterns are particularly relevant, wherein Type V is “straight-down” lighting with a square boundary (e.g., for parking lot lighting), and the other Types II-IV specify generally rectangular area boundaries that are laterally offset in a preferred direction. Satisfying such concerns can be difficult when LEDs are used as a light source because typically many LEDs are used in a fixture, so light output from an extended light source is particularly difficult to direct into a reasonably uniform level of illumination confined within the boundaries of a prescribed illuminance pattern.

It would be desirable to have an improved efficiency LED light fixture with directional features that improve the illuminance (lighting level) uniformity within a predetermined “large area” lighting pattern. It is further desirable to maximize the amount of light that is directed into the predetermined lighting pattern while minimizing light falling outside the boundaries of the pattern, most particularly for patterns that are offset in a preferential direction from the LED light fixture.

### BRIEF SUMMARY OF THE INVENTION

An LED lighting apparatus and method of operating the apparatus is disclosed for illumination toward a preferential side in a downward and forward direction.

According to the invention, a shaped lens is provided for use with a white light LED device to produce a light pattern on a surface; the lens being shaped to produce a substantially uniform color in the light pattern by compensating for color variation versus elevation angle produced by the LED device. The shaped lens has two-axis orthogonal symmetry and an outer surface divided into a top portion and a side portion separated by a circumferential boundary portion. The top portion and the side portion each have a generally vertically convex surface and the circumferential boundary portion has a discontinuity in curvature providing a substantially vertical portion between the top and side portions.

Further according to the invention:
the surface shape of the lens is determined by an iterative ray tracing procedure which is repeated for rays emanating from a plurality of points selected to approximate the entire light emitting area of the LED device, thus producing a plurality of calculated lens surface shapes; and the surface shape of the lens is a weighted average of the plurality of calculated lens surface shapes.
A method for using an LED device to illuminate a surface with a light pattern having a substantially uniform color comprises providing a lens for use with the LED device, wherein the lens is shaped to have an outer surface divided into a top portion and a side portion with a circumferential boundary portion therebetween; and the top portion and the side portion each having a generally radially convex surface and the circumferential boundary portion having a generally radially concave surface.
A method for shaping an LED lens member to create a light pattern having a substantially uniform color comprises shaping an outer surface of the lens to:
   divide the outer surface into a top portion and a side portion with a circumferential boundary portion therebetween; and
   the top portion and the side portion each having a generally radially convex surface and the circumferential boundary portion having a generally radially concave surface. with small radius of curvature followed by a small radius convex curve to join top portion.
A method for using an LED device that has a color changing phosphor coated emitter surface to illuminate a surface with a light pattern having a substantially uniform color, the method comprising: providing a lens for use with the LED device, wherein the lens is shaped to refract light emitted from the LED device according to the following specifications:
   for light emitted within a normal to near normal angular range relative to the emitter surface, bend the light radially outward;
   for light emitted within a near normal to parallel angular range relative to the emitter surface, bend the light radially inward; and
   defining the near normal angle at each specific circumferential angle as a percentage of the length of a line whose locus comprises points at the intersection of the lens surface and a radian rotated from zero to 90 degrees relative to the emitter surface while fixed at the specific circumferential angle.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be separately referenced as 199a, 199b, 199c, etc. Or, related but modified elements may have the same number but are distinguished by primes. For example, 109, 109′, and 109″ are three different versions of an element 109 which are similar or related in some way but are separately referenced for the purpose of describing various modifications/embodiments of the parent element (109). Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1 is a three dimensional view of an LED lighting apparatus shown in the context of being mounted on a pole for lighting an area on the ground below;

FIG. 2 is an exploded three dimensional view of the LED lighting apparatus with reflectors, according to the present invention;

FIG. 3 is a three dimensional view of the housing for the LED lighting apparatus with reflectors with the control cover and the light cover removed, according to the present invention;

FIG. 4 is an exploded three dimensional view of the LED module assembly of the LED lighting apparatus with reflectors, according to the present invention;

FIGS. 4A-4B show plan views of a PCB embodiment wherein either a line of LEDs or an array of LEDs with uniform spacing can be attached and function by placing the LEDs in selected positions, according to the present invention;

FIG. 5 is a three dimensional top view of the assembled LED module assembly of the LED lighting apparatus with reflectors, according to the present invention;

FIGS. 5A-5F show plan views of a type II-IV LED module with reflectors mounted under a light cover of an LED lighting apparatus which is progressively disassembled to show parts relationships until the module itself is removed under a light cover of an LED lighting apparatus, according to the present invention;

FIGS. 5G-5I show plan views of a type V LED module which is progressively assembled under a light cover of an LED lighting apparatus, according to the present invention;

FIG. 6 is a three dimensional view of the LED module of FIG. 5 without the vertical reflector and without two of the secondary lenses of the LED lighting apparatus with reflectors, according to the present invention;

FIGS. 6A-6D show plan views of a type II-IV LED module in multiple stages of assembly to show parts relationships, according to the present invention;

FIGS. 6E-6G show individual embodiments of a module cover, a PCB reflector, and a horizontal reflector used to assemble a type II-IV LED module, according to the present invention;

FIG. 6H is a schematic sketch showing the general shape of the same three components in embodiments used to assemble a type V LED module, according to the present invention;

FIG. 7 is a cross-sectional, front side view along the line 7-7 of FIG. 9 of the LED lighting apparatus with reflectors, according to the present invention;

FIG. 7A is a magnified view of the circled portion of FIG. 7 showing the secondary lens mounted over the primary lens of an LED in the LED module of the LED lighting apparatus with reflectors, according to the present invention;

FIG. 7B is a bottom view of the secondary lens viewed in the direction indicated by arrows on the line 7B-7B of FIG. 7A, according to the present invention;

FIG. 8 is a cross sectional lateral side view along the line 8-8 of FIG. 9 of the LED lighting apparatus with reflectors, according to the present invention;

FIG. 9 is a three dimensional top front view of the LED module assembly mounted under the light cover portion of the LED lighting apparatus with reflectors, according to the present invention;

FIG. 10A is a magnified view of the circled portion of FIG. 8 marked 10A, showing exemplary rays of light emitted from an LED, passing through a secondary lens, and some rays reflecting from the vertical reflector behind the secondary lens of the LED lighting apparatus with reflectors, according to the present invention;

FIG. 10B is a view like that of FIG. 10A but taken along the line 10B-10B of FIG. 9, showing exemplary rays of light emitted from an LED, passing through a secondary lens, and some rays reflecting from the vertical reflector behind the secondary lens while some other rays reflect from the back light shield of the LED lighting apparatus with reflectors, according to the present invention;

FIG. 10C is a perspective view of two superimposed portions of LED modules having two different secondary lens types, showing potential differences in reflector setback SB1 between the two, according to the present invention;

FIGS. 11A-11B are a side elevation and a perspective view, respectively, of an LED assembly suitable for use with LED lighting apparatuses according to the present invention;

FIG. 11C is a side sectional view showing a secondary lens mounted over the primary lens of an LED in an assembled LED module, according to the present invention;

FIG. 11D is a plan view of an LED covered by a secondary lens according to the present invention, and the primary and secondary lenses are illustrated as being transparent and non-refracting;

FIG. 12A is a plan view of types II to V secondary lens lined up for comparison of general features, according to the present invention;

FIGS. 12B-12E are plan views showing the relative shape, area, and orientation of each IES pattern type next to an embodiment of a corresponding secondary lens, according to the present invention;

FIG. 12F is a conceptual schematic of a secondary lens positioned on a square LED emitter (curvature and sizes exaggerated) showing rays of emitted light traced through one quadrant, refracted at the lens surface and redirected to a rectangular light distribution pattern, according to the present invention;

FIGS. 12G1-12J1 are perspective views of simplified secondary lenses types II-V, respectively, the views being used to indicate the orientation of corresponding sectional views, according to the present invention;

FIGS. 12G2-12J2 are sectional views showing vertical profiles for secondary lenses types II-V, respectively, according to the present invention;

FIGS. 13A-13B are sectional views (shading omitted for clarity) of vertical profiles taken along the long axis and along the short axis, respectively, of a secondary lens having a J type inflection line, according to the present invention;

FIG. 13C is a plan view of the lens illustrated in FIGS. 13A-13B, the view showing inflection lines, according to the present invention;

FIGS. 13D-13E are sectional views (shading omitted for clarity) showing light mixing effects of a J type inflection, according to the present invention;

FIG. 13F is a plan view of a secondary lens with J type inflection, the view using topographical-like contour lines to illustrate surface shape changes related to the J type inflection, according to the present invention;

FIG. 13G is a sectional perspective view of a quadrant of the lens of FIG. 13F, the view using contour lines and a height indicating grid to illustrate surface shape changes, according to the present invention;

FIG. 13H is a partial plan view of the same quadrant showing relevant reference numbers, according to the present invention;

FIGS. 14A-14B are sectional views (shading omitted for clarity) showing a secondary lens with a hemispherical inner surface and a first embodiment of an aspheric inner surface, respectively, according to the present invention;

FIGS. 14C-14D show lighting patterns produced by the lenses of FIGS. 14A and 14B respectively;

FIGS. 14E-14F show plots of the lighting patterns of FIGS. 14C-14D taken along the indicated directions, according to the present invention;

FIGS. 14G-14H are sectional views (shading omitted for clarity) showing a secondary lens with a hemispherical inner surface and a second embodiment of an aspheric inner surface, respectively, according to the present invention;

FIGS. 15A-15F are copies of illustrations from other art discussed in the present disclosure for comparison, according to the present invention; and

FIGS. 16A-16C present test results of a prototype embodiment of the present disclosure, the prototype dimensions being given in 16A, followed by a flux distribution report and an isocandela plot; according to the present invention.

### DETAILED DESCRIPTION OF THE INVENTION

### Reference Number Key, Term Definitions

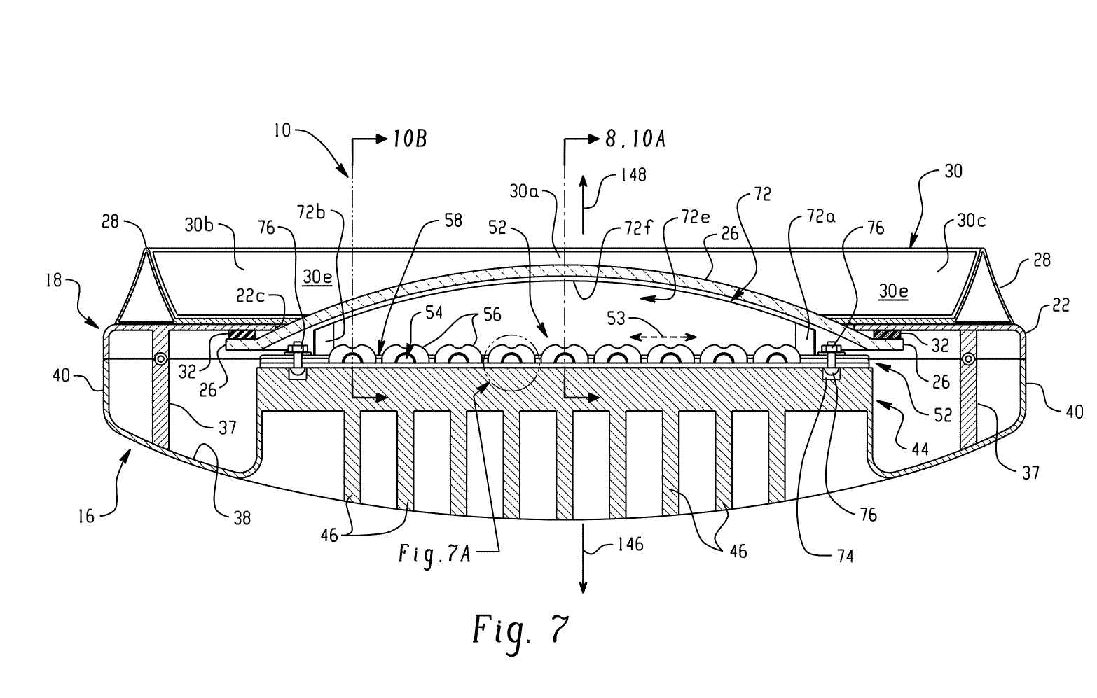

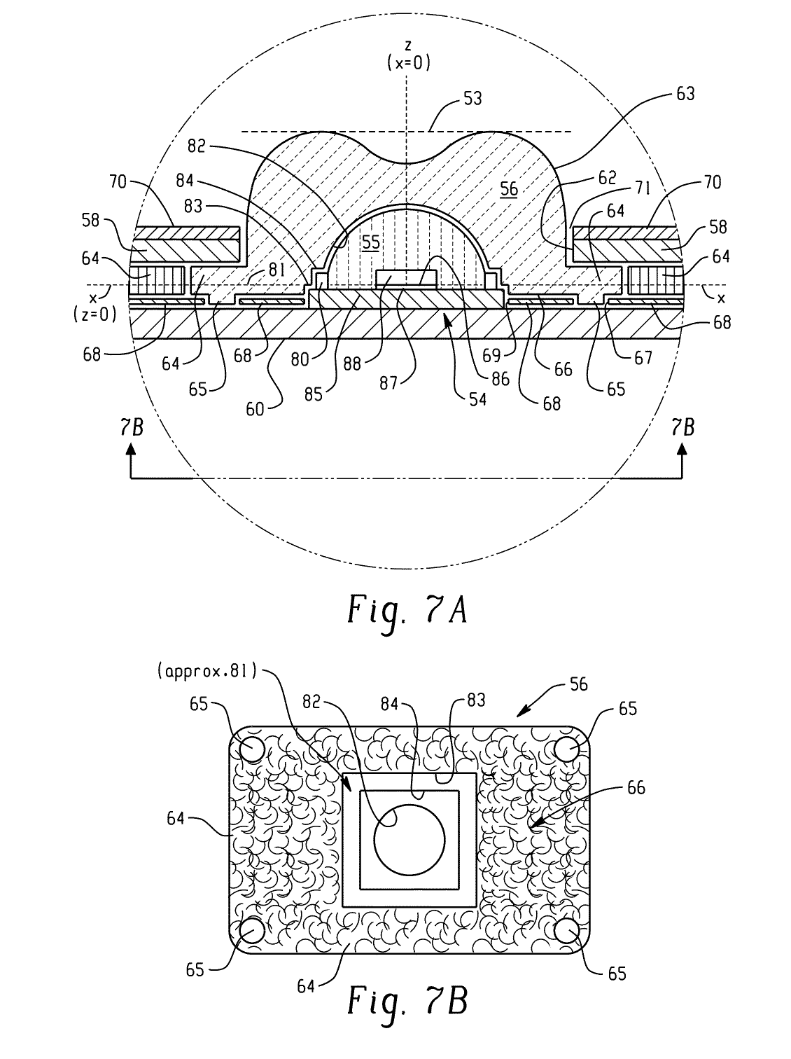

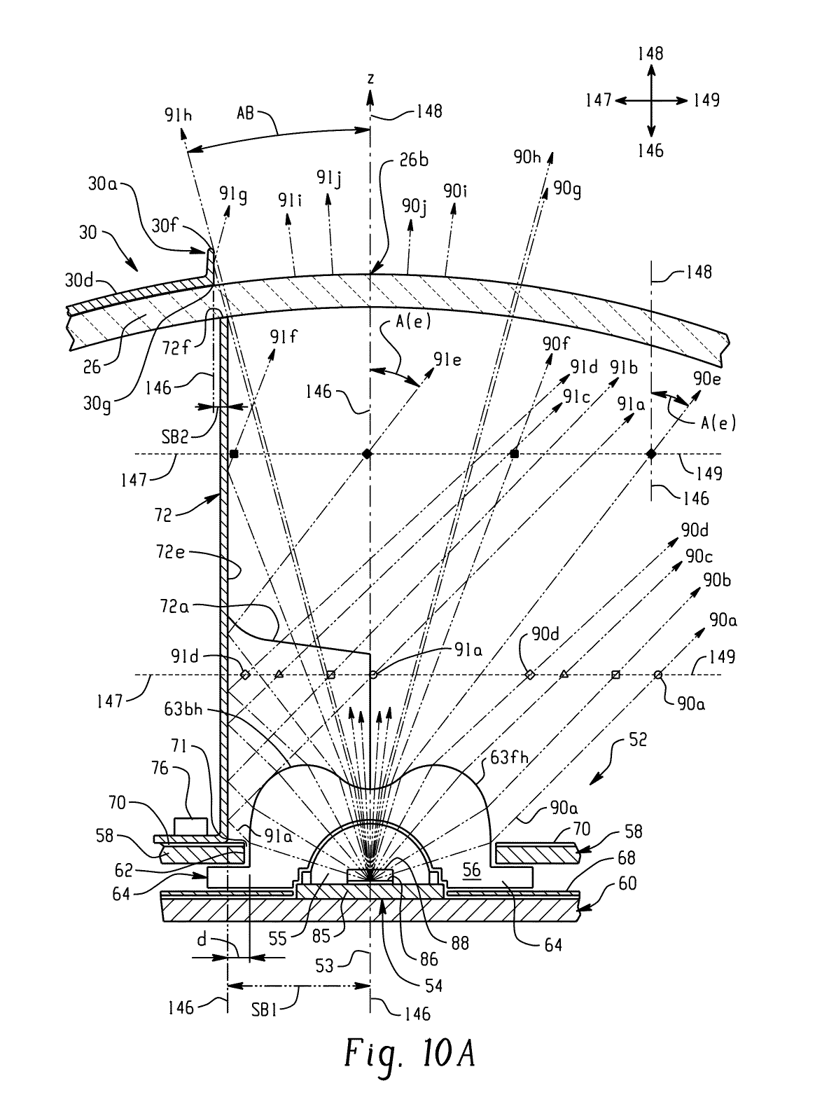

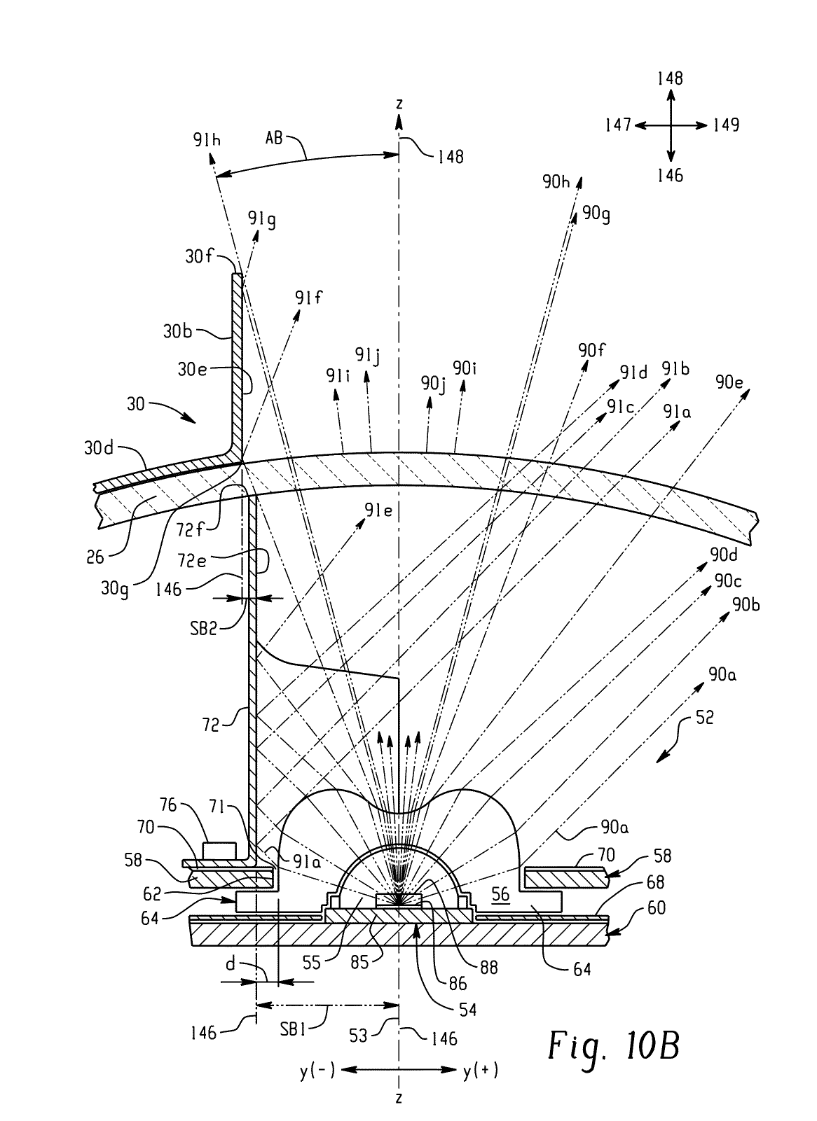

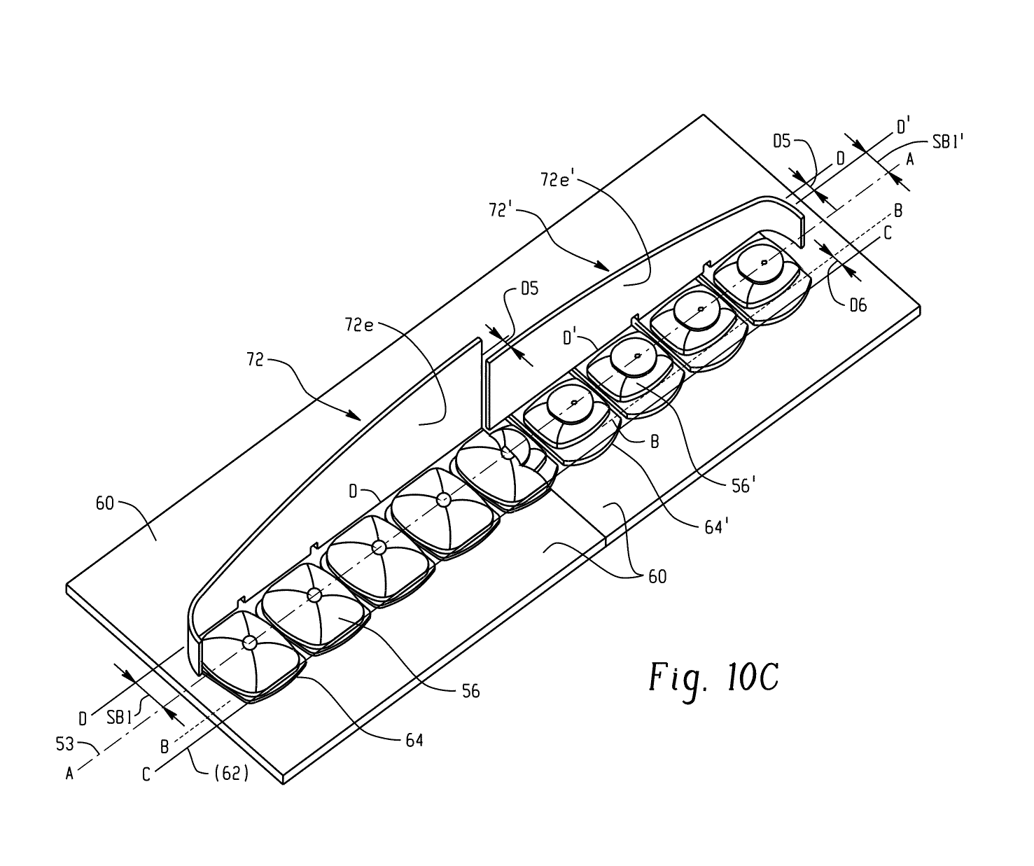

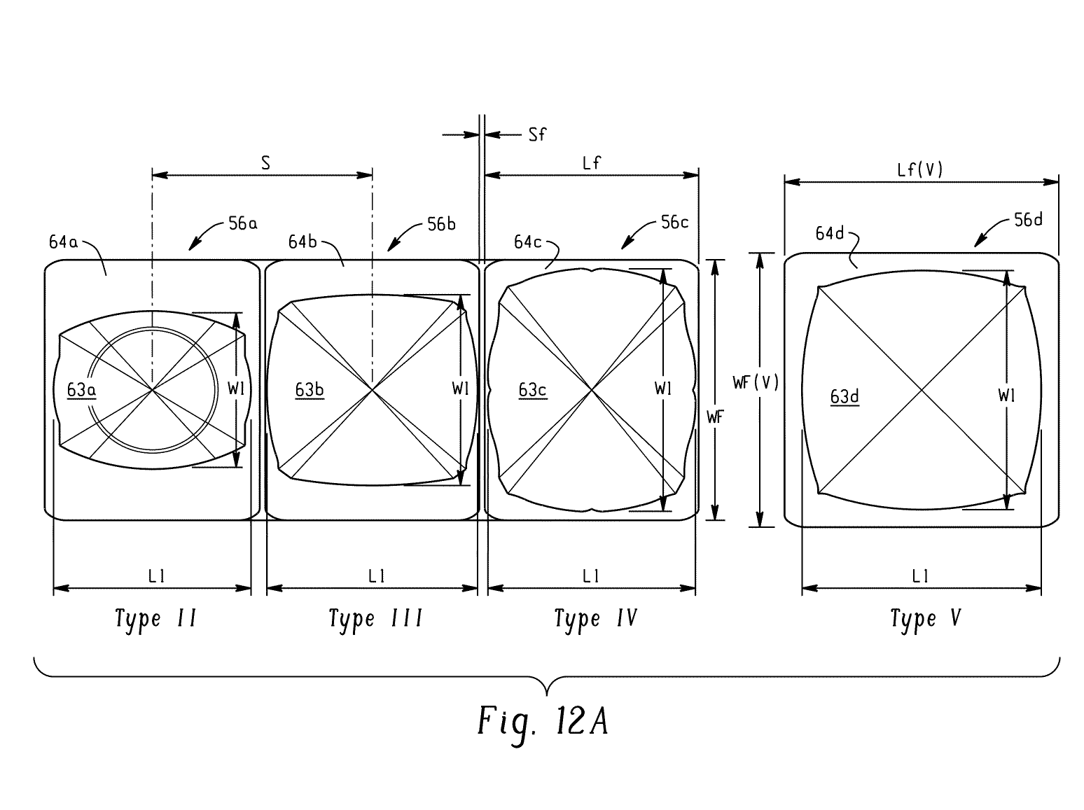

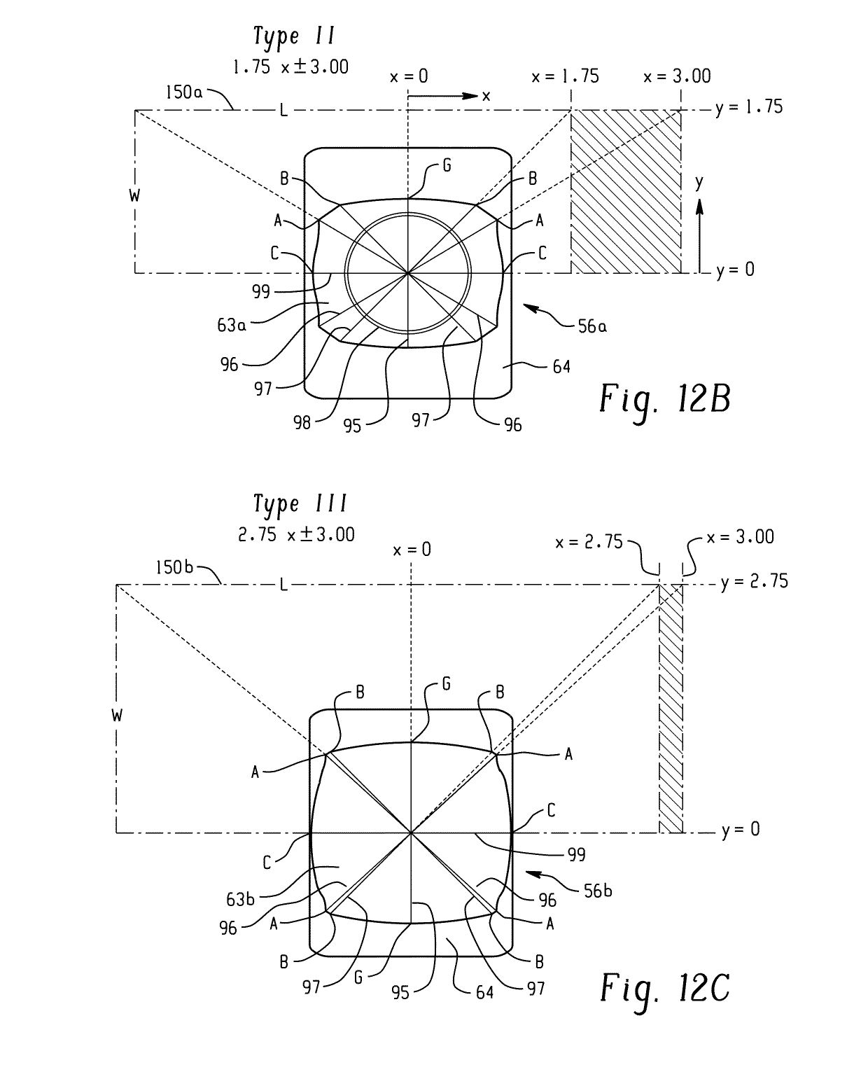

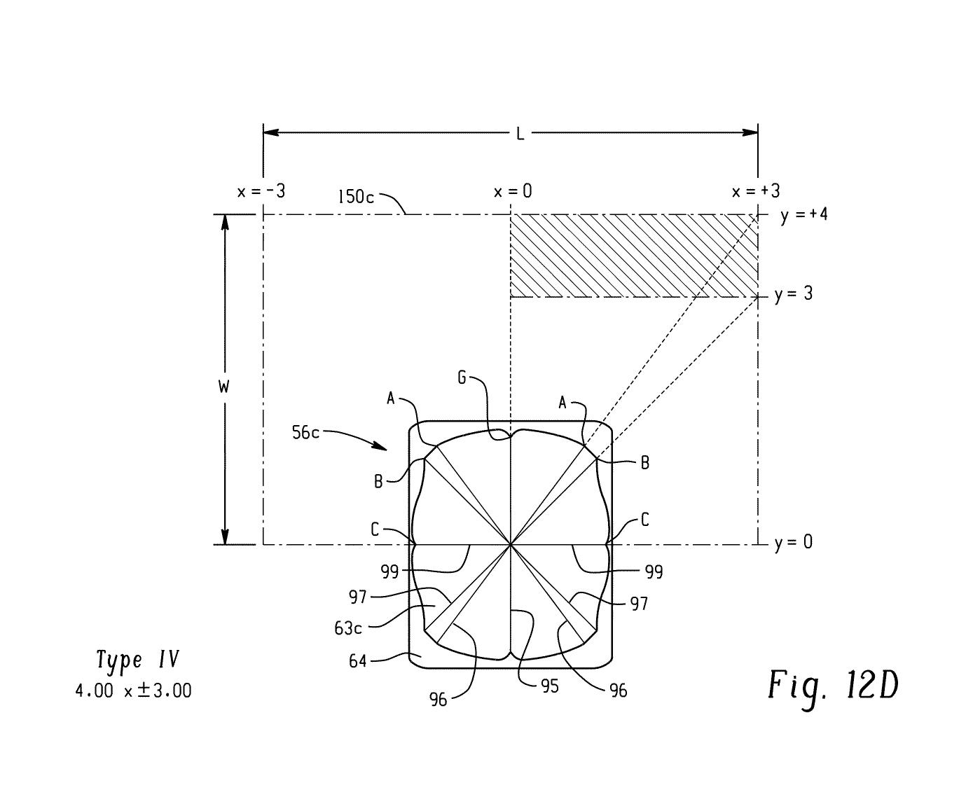

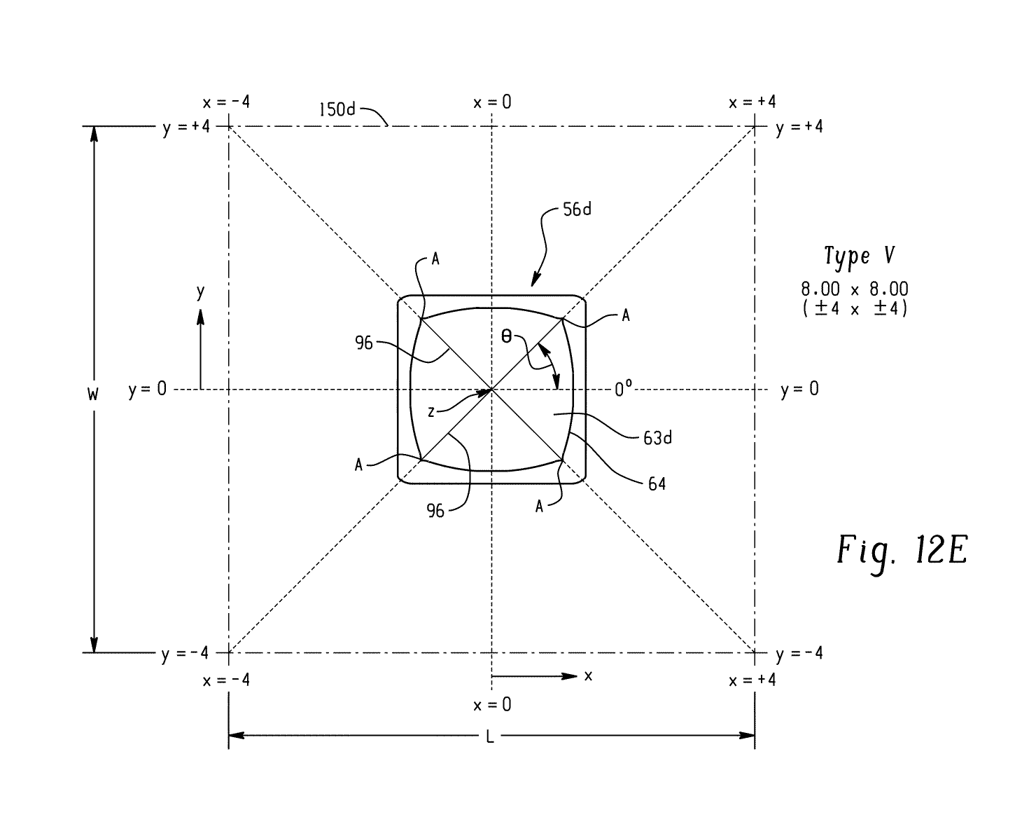

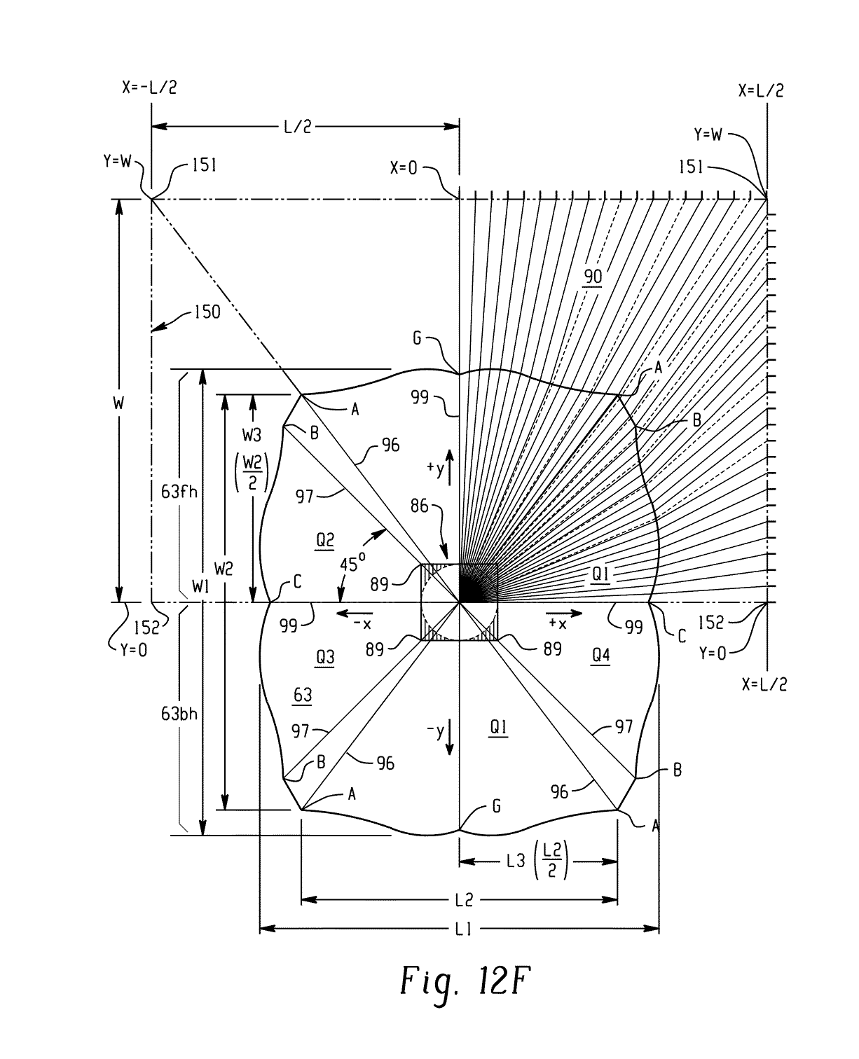

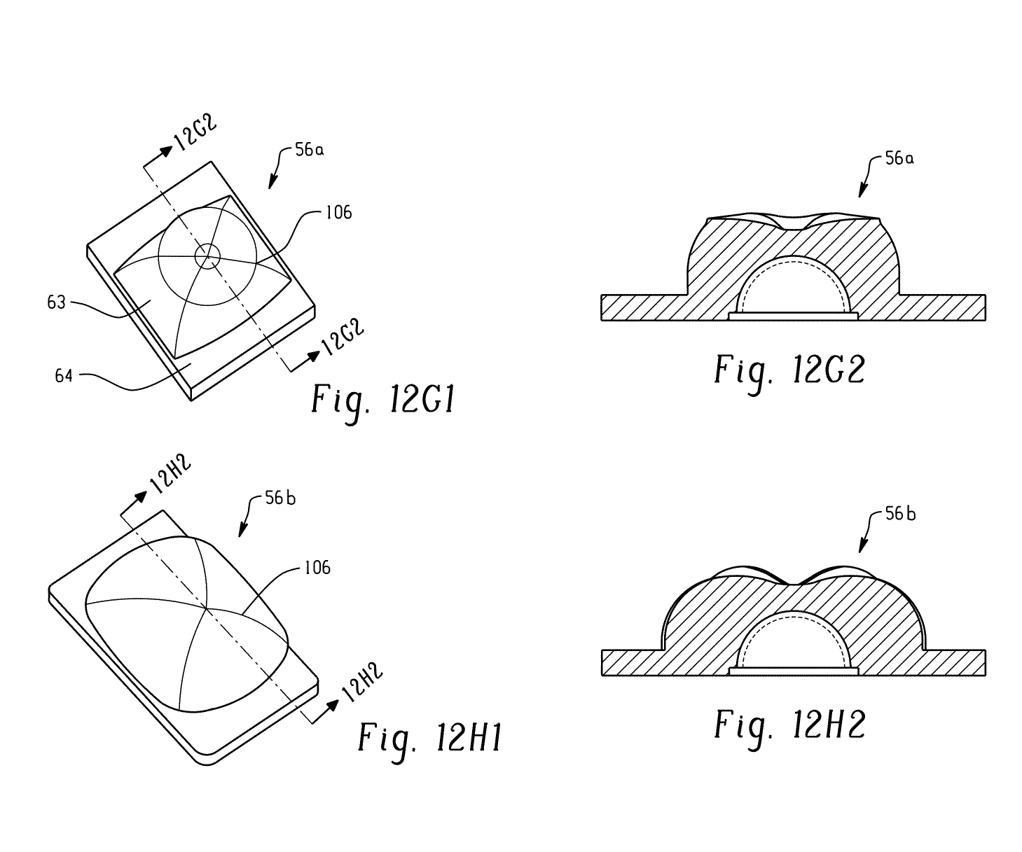

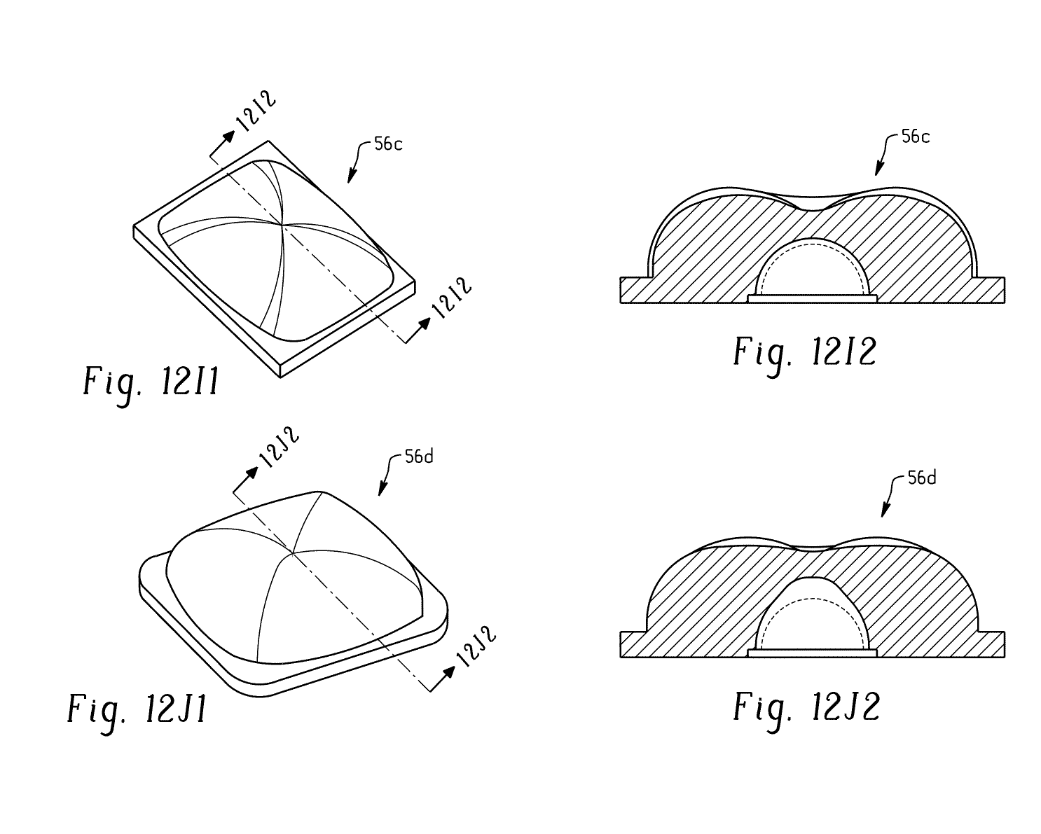

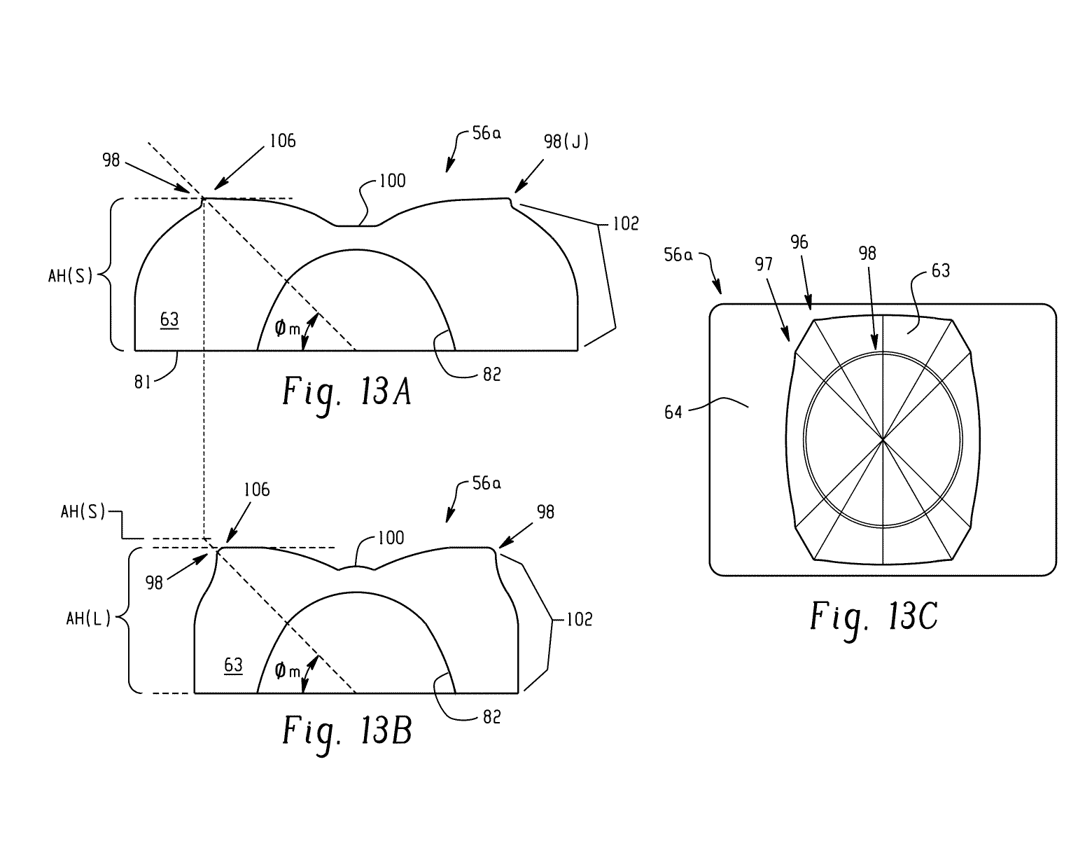

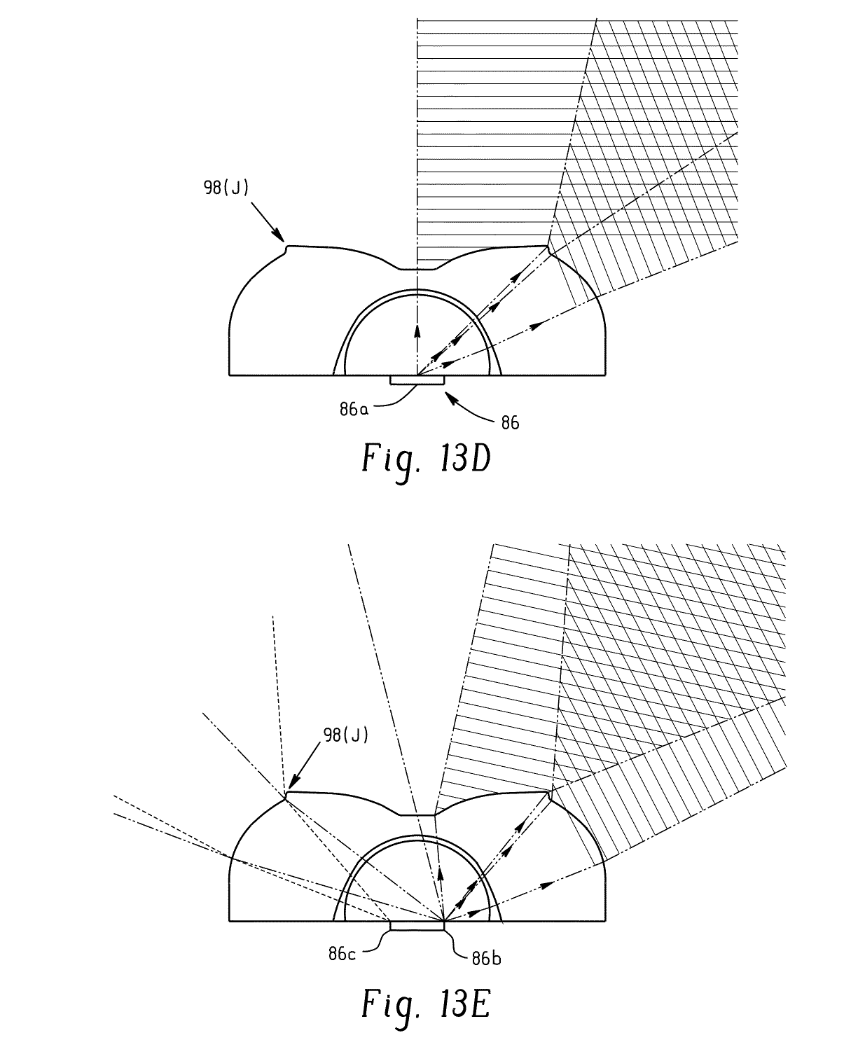

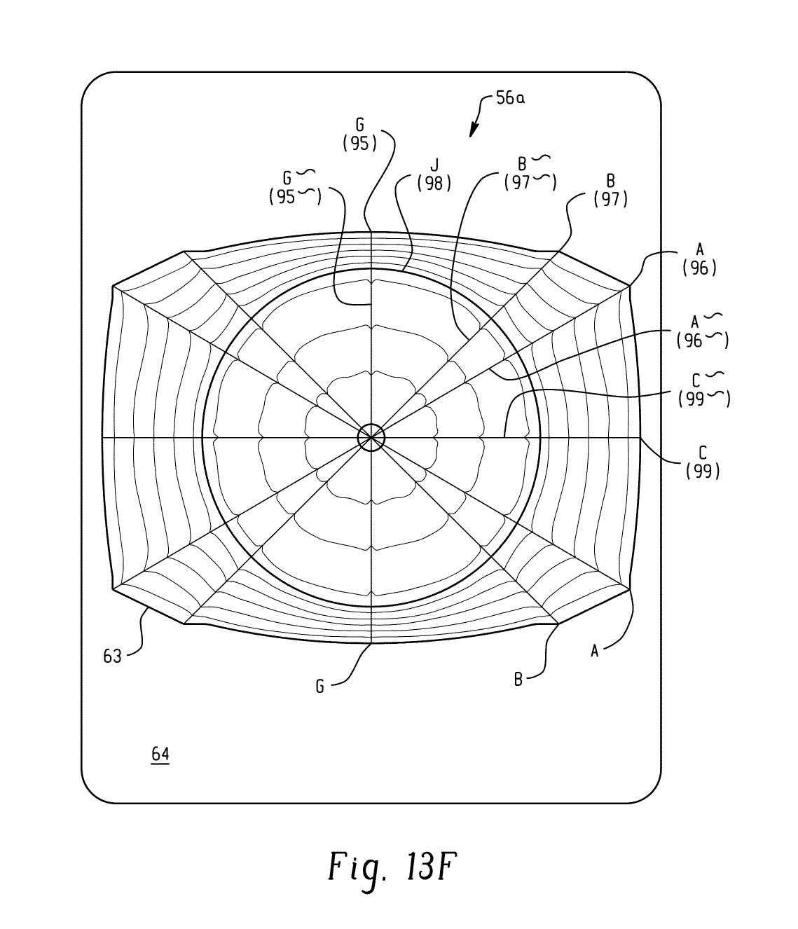

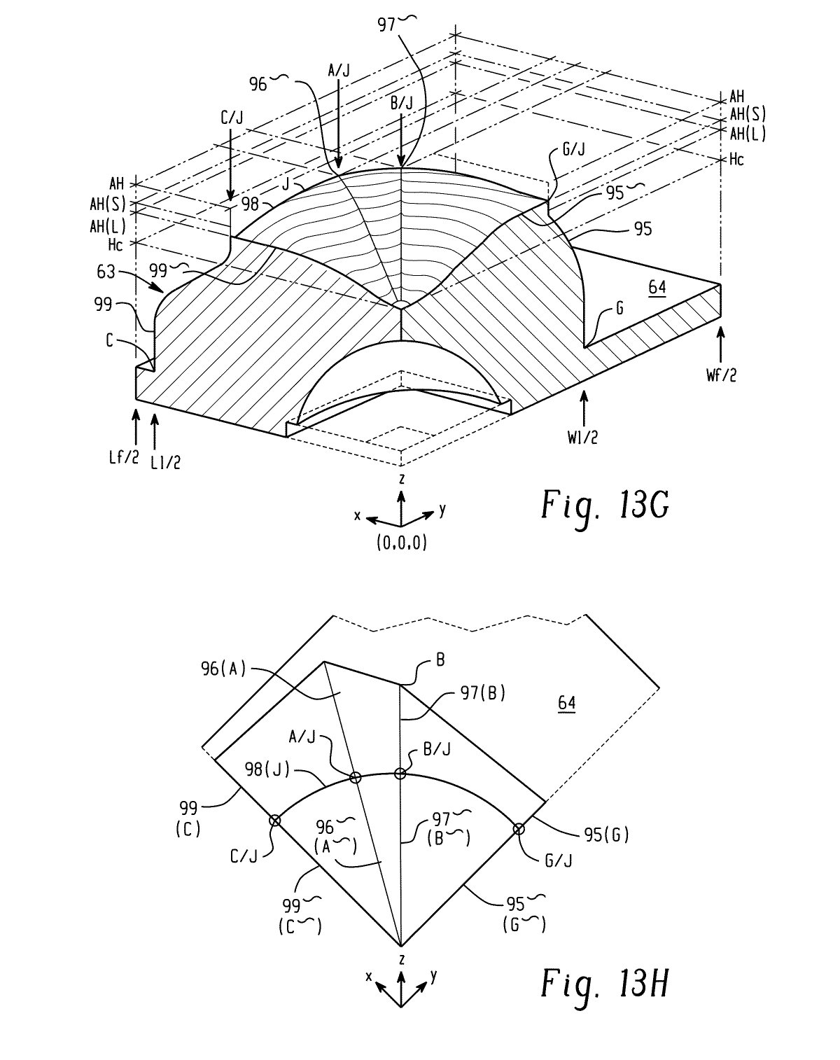

Note that some of the following references may not be used in the present application but will be used (illustrated and further described) in others of a set of co-pending related applications. The potentially unused references are included herein for consistency and overall understanding, and also because the series of related applications share significant portions of the detailed description and drawings.

| NUM. | ELEMENT |
|---|---|
| 10 | LED lighting apparatus (fixture, luminaire) |
| | Major Parts of LED Lighting Apparatus 10 |
| 12 | housing (in general) |
| 16 | upper portion of housing 12 (faces sky, i.e., upward direction 146) |
| 18 | lower portion of housing 12 (faces ground, i.e., downward direction 148) |
| 20 | controls cover part of lower housing 18 |
| 20a, b | a = front edge, b = back end (20b is also back of 10) |
| 21 | back hinges (a, b) |
| 22 | light cover part of lower housing 18 |
| 22a, b | a = front end, b = back edge (22a is also front of 10) |
| 22c | aperture/opening/hole in light cover where cover lens is mounted and light emitted |
| 24 | front hinges (a, b) |
| 26 | cover lens (for vandal and environmental protection) a.k.a. outer lens, cover glass, |
| | drop lens |
| 26a | convex section of a dome shaped cover lens |
| 26b | center point of cover lens (peak/apex of dome shape) |
| 26c | diameter line of cover lens = thru center point 26b. For types II-IV lighting, the |
| | diameter line shown is parallel to backlight shield 30, to vertical reflector 72, and co- |
| | planar with centerline A-A of single row 53 of secondary lenses 56 (and LEDs 54) |
| 28 | ring shield, uplight shield, or “baffle” - 28a = for types II-IV lighting; b = for type V |
| 30 | backlight shield (external on cover lens 26) Parts 30a-g except d form a vertical wall = |
| | secant across ring shield near center. (30d = generally horizontal portion of backlight |
| | shield that covers part of the ring shield opening behind the vertical wall portion of the |
| | backlight shield). As determined by context, a reference to the “backlight shield 30” |
| | usually means the vertical wall portion. |
| 30a | center (short) portion of the vertical wall |
| 30b, c | end (tall) portions of the vertical wall |
| 30d | back covering (roughly horizontal part of backlight shield) = opaque covering over |
| | cover lens in back of the vertical wall parts a, b, c of the backlight shield 30 |
| 30e | reflective surface on front of vertical wall of 30. May be specular or diffuse. |
| 30f, g | top edge (30f) and bottom edge (30g) of vertical wall of 30 |
| 32 | gasket for cover lens |
| 33 | clamp to hold cover lens against gasket and light cover of lower housing |
| 34 | control chamber (houses electrical/electronic controls for LEDs) |
| 36 | light chamber (sealed chamber for LED module) |
| 37 | enclosing wall of light chamber (gasketed) |
| 38 | inside floor |
| 40 | upstanding wall |
| 44 | module mounting platform |
| 46 | heat sink fins (on upper housing 16) |
| 48 | rear box in light chamber = interface between control chamber and LED module |
| 49 | top of rear box 48 - painted white as a diffuse reflector. |
| 50 | front box in light chamber |
| 51 | top of front box 50 - painted white as a diffuse reflector. |
| | LED Module Assembly (52) |
| 52 | LED module (assembly) |
| 52a, b | a = module with single row of LEDs (and vertical reflector) for types II-IV; |
| | b = module with 3 × 3 array of LEDs for type V |
| 53 | single row (of LEDs and secondary lenses). The centerline of this row's elements may |
| | be marked “A-A”. Used for types II-IV. |
| {54} & | 54 = LED device, or “LED” (an assembly including primary lens 55, etc., purchased as |
| 55 | a unitary item for attachment to traces on the PCB 60) |
| | 55 = Primary Lens {LED parts 55, 80, 85-88: see combined listing after 84 below} |
| {56} | secondary lens {Sec. Lens parts 63-66, 81-84: see combined listing after 78 below} |
| 58 | module cover (58a = for types II-IV sec lenses; b = for type V) |
| 59 | recess in back of mod cover to receive sec lens flanges 64 |
| 60 | printed circuit board (PCB) |
| 61 | traces on PCB = circuit wiring (a = active for single row = types II-IV, b = active for |
| | 3 × 3 array = type V) |
| 62 | opening for sec lens in mod cover (a = for types II-IV; b = for type V) |
| 67 | through-holes in PCB reflector 68 for leveling bosses 65 |
| 68 | PCB reflector: Horizontal reflector on PCB 60 under sec lens 56 (incl. flanges). Any |
| | kind of reflective surface works because made diffuse by 66. |
| 68a, b | 68a = for types II-IV sec lenses; b = for type V |
| 68r | reflective surface (specular or diffuse) |
| 69 | square LED holes in PCB reflector 68 (a = for types II-IV; b = for type V) |
| 70 | horizontal flat reflector (diffuse) on top of mod cover 58 e.g., sheet of white plastic |
| | with rough surface. Same ref no. used for reflector and its reflective surface. |
| 70a, b, c | a = for types II-IV, b = for type V, c = variant reflector shape that covers whole module |
| | top for types II-IV (a is shown as covering only the most significant part) |
| 71 | opening for sec lens in horizontal top reflector 70 |
| | (a = for types II-IV; b = for type V) |
| 72 | vertical reflector |
| 72a, b | end sections (wrapped around) |
| 72c, d | vertical edges of ends |
| 72e | reflective surface on front (specular) e.g., polished aluminum |
| 72f | top/upper edge (a vertically convex curve is illustrated) |
| 72g | bracket to position and attach reflector 72 onto module 52. |
| 74 | recesses into mod mounting platform 44 to accommodate module fasteners 76 |
| 76 | module assembly fasteners, e.g., nuts, machine screws, and through holes that are used |
| | to hold the LED module 52 together in an assembled unit |
| 78 | mounting fasteners: screws, through holes, and threaded holes for mounting the |
| | assembled LED module 52 to the mounting platform 44 |
| {80} | {See LED parts after 84 below} |
| | Secondary Lens (56) |
| 56 | secondary lens (a, b, c, d for types II-V) |
| 63 | body of sec lens 56, especially its refracting outer surface/shape (a, b, c, d for types II-V) |
| | {Note: also see Secondary Lens Surface Features after 91 below} |
| 63bh, | 63bh is the back half of secondary lens body . . . for types II-IV the rays (e.g., 91) |
| 63fh | emitted from this half are folded forward by the vertical reflector 72, thus overlaying |
| | the rays (e.g., 90) from the front half 63fh of the secondary lens body |
| Q1, Q2, | four 90-degree sectors of the body 63 bounded by the vertical x-z and y-z planes. |
| Q3, Q4 | Two adjacent quadrants form the back half 63bh, and the other two form 63fh. |
| 64 | flange of sec lens 56 (a, b, c, d for types II-V) |
| 65 | leveling bosses (typically four) on underside of sec reflector flanges. They pass |
| | through holes 67 in PCB reflector 68 to sit on the PCB. |
| 66 | underside of sec lens - is roughened to diffuse light passing through it and reflecting |
| | off PCB reflector 68 |
| 81 | base plane of sec lens (body and inner surface cavity) which is aligned (by way of 65) |
| | to be co-planar with the LED's emitter surface 86 (which also = hemisphere base of |
| | primary lens 55). Thus 81 is the local “horizontal” x-y plane at z = 0 for the LED |
| | lighting system source, i.e., the LED module assembly 52 including PCB, LED |
| | emitter, all lenses and reflectors. The base plane 81 also may be roughly coplanar with |
| | the vertical interface between recesses 83 and 84. |
| 82 | cavity/inner surface of sec. lens 56, fits over primary lens 55 of the LED |
| 83 | recess in sec lens to receive LED substrate 85 |
| 83a | straight side of recess to align with edge of substrate 85, however alignment to LED |
| | alignment pegs 80 may be preferred. |
| 84 | alignment recess in sec lens (fits around four LED alignment pegs 80, if present). May |
| | be stepped inward from recess 83 as shown (FIG. 7B). May be combined with 83 to |
| | make a single recess for substrate alignment. |
| 84a | straight side of recess to align with two LED alignment pegs 80. |
| {Note} | {also see Secondary Lens Surface Features after 91 below} |
| | LED Device/Assembly (54) |
| 54 | LED device, or just “LED” (an assembly, purchased as a unitary item for attachment to |
| | traces on the PCB 60) |
| 55 | primary lens of LED (hemispherical) |
| 80 | alignment pegs of LED, raised at 4 corners around LED primary lens (also aligned |
| | with corners of square LED emitter surface and LED substrate.) |
| 81, x-y | base plane of LED's emitter surface 86 (which also = hemisphere base of primary |
| base | lens 55). Thus 81 is the local “horizontal” x-y plane at z = 0 for the LED device 54. We |
| plane | align the secondary lens and reflectors to this, making 81 the base plane of the lighting |
| | system source, i.e., the LED module assembly 52. |
| 85 | LED substrate (thin square ceramic board. The LED device parts are all mounted on it, |
| | and metal contacts on bottom are for soldering to PCB traces) |
| 86 | LED emitting surface, “emitter”. Is square area “extended light source” (3 mm × 3 mm = |
| | 3 mm square). The base plane 81 of secondary lens is made to be co-planar with 86. |
| 86a, b . . . | points on the emitter surface 86 (FIGS. 13E-F) |
| 87 | LED “die” = chip with LED junctions/emitting surface covering most of it |
| 88 | phosphor to convert blue LED output to “white” light = yellowish coating on top of 86 |
| 89 | corners of LED emitter 86 |
| | Folded/Reflected Light Rays of Asymmetric Light Pattern (FIGS. 10A-10B) |
| 90 | light ray emitted from LED and secondary lens in “forward” direction 149 (toward |
| | front/street side 136) |
| 91 | light ray emitted from LED and secondary lens in “rearward” direction 147 (toward |
| | vertical reflector 72 on back/house side 138). |
| 90a . . . i, | individual rays at sequential elevation angles (as measured at sec lens surface), labeled |
| 91a . . . i | starting with “a” at the lowest elevation angle |
| AB | downward angle of unblocked “back” lighting = angle between straight downward |
| | direction 148 and farthest extent of backlit area (as limited by vertical minor 72 and |
| | backlight shield 30 in types II-IV fixtures) |
| A(e) | downward angle of ray leaving fixture through shield ring 28. The letter “e” in |
| | parentheses is example of letter identifying the particular ray. Angle is with respect to |
| | straight downward direction. |
| | Secondary Lens Surface (63) Features |
| A, B, | inflection types and/or locations on sec lens outside surface, where slope has abrupt |
| C, G, J | change = very tight curve or discontinuity = very high or infinite rate of slope change |
| | at a point surrounded by gentler curves. NOTE: the letter may indicate the location of |
| | that type of inflection even if the actual inflection is absent or not readily visible. |
| A~, B~ | inverted version of Inflections A, B, etc. (FIGS. 13G-H) This happens when |
| etc. | inflection lines cross over the J-inflection line 98. |
| 95-99 | line of same-type inflections A-J. The line passes through a series of adjacent same- |
| | type inflection points, and is orthogonal to the direction of the inflections. |
| | Inflection lines are radial or rotational. |
| radial | radius changes along the line, but azimuth angle stays constant. Inflections on it are |
| line of | horizontal/azimuthal/rotational slope changes where z-value/elevation angle doesn't |
| inflec. | change., i.e., a 2D curve in a horizontal plane. The radial lines are 95, 96, 97, and 99. |
| rotational | (non-radial) = line w/constantly changing azimuth angle. Inflections (J) on it are |
| line | vertical or elevational slope changes where azimuth angle stays constant, i.e., a 2D |
| of infl. | curve in a vertical plane. Line 98 of J inflections is only example in disclosure. |
| 96, A | “primary” radial line feature of the secondary lens' outside surface 63 (= a “ridge” that |
| | establishes “corners” for the lens) = radial line of A type inflections. |
| | Usually this is the only inflection type used on type V lenses. |
| 97, B | “secondary” radial line feature (The “triangle” or “wedge” feature is formed between |
| | this and primary line 96) = a radial line of B type inflections. |
| | If present, it only occurs on the longer lens side (as measured between corners A). |
| 98, J | oval top ridge feature (for color correction/blending) = rotational line of J type |
| | inflections. Most significant use is on high aspect ratio type II lighting. |
| 99, C | subtle mid-side radial line feature (usually like a groove) = radial line of C type |
| | inflections. Occurs on the lens side that determines pattern width W. |
| 95, G | subtle mid-side radial line feature (usually like a groove) = radial line of G type |
| | inflections. Occurs on the lens side that determines pattern length L. |
| 100 | top facet of a secondary lens adapted for color mixing by use of a ring 98 of J type |
| | inflections. Top facet is bounded inside the inflection ring 98. |
| 102 | side (or bottom) facet of secondary lens = outside of ring 98 of J type inflections. |
| 106 | apex of radial profile for a secondary lens' outside surface 63. |
| | (e.g., a ring-like top edge of “volcano” shape) |
| | Global Directions, Environment, Dimensions, Symbols, Etc. |
| X, Y, Z | 3D orthogonal (rectangular) coordinates = Global frame of reference - |
| | Relative to ground plane and location of LED lighting apparatus 10. The ground |
| | surface, idealized as planar, is the horizontal X-Y plane on which the lighting pattern |
| | 150 is specified. By convention herein, the lengthwise direction L of the pattern is |
| | made the X-axis direction, so that the widthwise pattern direction W is the Y-axis. The |
| | Z-axis is normal to the ground plane and therefor equivalent to the “straight up” or |
| | “straight down” directions (146 and 148 respectively). |
| x, y, z | 3D orthogonal (rectangular) coordinates = Local frame of reference - |
| | Relative to LED device, including its primary lens. The LED emitter surface = base |
| | plane 81 of primary lens = x-y plane at z = 0. |
| | The z axis is vertical through the center (origin x = y = 0) of emitter 86 and LED device |
| | 54 as a whole. Is a rotational/center/vertical axis of primary lens 55. |
| | By convention in this disclosure the x-axis is defined to be parallel to the line (row) 53 |
| | of LEDs. Also the 4 sides of the square emitter 86 are aligned with the x and y axes. |
| | When relating the illuminance pattern 150 created by the LED lighting apparatus on |
| | the ground, the x, y, and z-axes of the LED's local frame are considered to be aligned |
| | with the corresponding X, Y, and Z-axes of the global frame (unless stated otherwise). |
| r, θ | polar (2D) coordinates = Local frame of reference (relative to LED) |
| | r = radial distance within horizontal r-θ plane centered at origin x = y = 0 |
| | θ (theta) = azimuth angle of rotation about origin, typically increasing in CCW |
| | direction from 0 degrees usually assigned to the (positive) x-axis or “3 o'clock”. |
| | cylindrical 3D coordinates add z coordinate for height of r-θ plane on center z-axis |
| ρ, θ, φ | spherical (3D) coordinates = Local frame of reference (relative to LED) |
| | Rho (ρ) = radius in any 3D direction from origin at x = y = z = 0, Theta (θ) = azimuth |
| | angle, Phi (φ) = elevation angle upward from zero at base plane/equator 81. |
| 122 | pole supporting a lighting fixture/apparatus/luminaire 10 (e.g., a utility pole) |
| 124 | mounting arm for holding fixture 10 mounted on a pole 122 |
| PH | pole height (to base plane 81 of LED module 52 in fixture 10 mounted on a pole 122) |
| 136 | front, preferential side (“street side”) = location relative to center of LEDs in type II-IV |
| | LED lighting apparatus 10. Sometimes stated as if it is relative to the pole 122, but this |
| | ignores the length of the mounting arm 124, and should be understood to most |
| | accurately mean “in front of the LED light source center”. |
| | In two dimensions on the ground, the line through the “center” is the nearest |
| | lengthwise edge of a lighting pattern (see 150) |
| 138 | back, non preferred side (“house side”) = relative location, opposite of front 136 |
| 146-9 | Orthogonal directions away from LED light source using a 3D global frame of |
| | reference relative to the ground plane of the illuminance pattern 150 which contains |
| | the pattern's X and Y coordinates. The global vertical axis Z, is usually assumed to be |
| | positioned to pass through the center of the line of LEDs mounted in a fixture 10 that's |
| | mounted on pole 122. |
| | By convention, when a single direction is given, that references the most meaningful |
| | component of a 3D vector. The context of the reference determines the remaining |
| | vector components. Example: reference to a “forward directed ray” may be a reference |
| | to a ray directed forward as opposed to backward. In addition the ray is probably also |
| | headed downward. It will also have a sideways directional component (longitudinally |
| | along the street) but whether to right or left doesn't matter when the illumination |
| | pattern is symmetric to left and right of fixture. |
| 146 | Direction upward (uplight, none allowed) |
| 147 | Direction backward (backlight, limited to a specified small amount of light output) |
| 148 | Direction downward (generally assumed to be included when referring to light rays |
| | directed “forward” or “backward”). “Straight Downward 148” means purely vertical, |
| | i.e., normal to ground plane of light pattern. Also, according to our designs, is parallel |
| | to z-axis and normal to the LED base plane 81 in LED module local frame of |
| | reference. |
| 149 | Direction forward, laterally/widthwise across the street (NOTE: NOT “OUTWARD” |
| | because that term is used more generically to mean generally “away” from the LED(s) |
| | or module, or center of an LED or lens, or out from the outer lens of the fixture) |
| 150 | Illuminance Pattern, Target Area, Intensity/Light Distribution (pattern), and similar. |
| | = Intended illuminated area on the ground (idealized as planar and rectangular). Unless |
| | stated otherwise, for Type II-IV patterns it means the street side (forward) area, |
| | ignoring backlight area on house side. Specified boundaries = length L by width W. |
| 151 | front, forward-most, or widthwise far corners of pattern 150 (a “corner” is where a |
| | side having length L meets side having width W, idealized as a right angle). The line |
| | 151-151 between them is the lengthwise pattern boundary on the far side of the “street” |
| 152 | back, backward-most, or near corners of pattern 150. The line 152-152 between them |
| | is the lengthwise pattern boundary on the near side of the “street” and is usually |
| | considered the dividing line between street/front side 136 and house/back side 138. |
| L | length of light distribution/pattern, longitudinally/lengthwise along street |
| W | width of light distribution/pattern, laterally across street |
| L1, W1 | length and width of secondary lens that corresponds to L, W respectively. Note that |
| | this means that a row of LEDs/lenses extends lengthwise relative to dimensions of the |
| | lens, even though the individual lenses may be “wider” than they are “long”. |
| L2, W2 | length and width of sec lens body 63 as measured between corners at outermost point |
| | of A-inflection lines 96 (FIG. 12F) |
| Lf, Wf | length, width of sec lens flanges 64 that correspond to L, L1 and W, W1 respectively. |
| | For types II-IV lenses the flanges are standardized to a single overall size. The flanges |
| | all have a “width” Wf greater than its “length” Lf (which is along length of row 53). |
| S | LED (and sec. lens) spacing (types II-IV = 25 mm ideal) This set a maximum value for |
| | flange length Lf |
| Sf | small space between flanges = tolerance allowance to assure lenses are positioned by |
| | LED, not adjacent lenses. (spacing isn't as important as lens-to-LED alignment) |
| A-A | line along centers of LEDs (and sec. lenses) in single row 53 for types II-IV |
| B-B | In FIG. 10C, line along outside edges of type II secondary lenses. Marks extent of lens |
| | width W for type II lens, which is the most narrow of the types II-IV lenses. |
| C-C | In FIG. 10C, line along outside edges of type IV secondary lenses. Marks extent of lens |
| | width W for type IV lens, which is widest of the types II-IV lenses. Thus it is used to |
| | determine width of module cover 58 lens openings 62. |
| D-D | line along reflective surface 72e parallel to top surface of module (or D′-D′ with a |
| | different sec. lens) |
| SB1 | setback of 72e from centerline 53 of sec lenses (SB1′ with different sec lenses) |
| SB2 | setback of 30e from 72e (FIG. 10B) |
| D5 | difference of SB1 vs. SB1′ |
| D6 | distance between lines B-B and C-C = half difference between lens widths W1 of 56 |
| | vs. 56′. Is related to D5 and may be approximately equal, depending upon shape of lens |
| | side. |
| d | separation between side of lens and inside surface of reflector 72e |

In the detailed description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, both reference numerals and legends (labels, text descriptions) may be used to identify elements. If legends are provided, they are intended merely as an aid to the reader, and should not in any way be interpreted as limiting.

The present disclosure most generally concerns an LED lighting apparatus designed for improved efficiency in illuminating large areas (e.g., streets and parking lots) with predefined patterns of light intensity such as the IES defined Types II, III, IV, and V illumination. The operative definition of efficiency herein includes utilization of total light energy output by the LED light source within the lighting apparatus. Utilization is reported as a percentage of the total output that falls within the predefined boundaries of the relevant type of lighting pattern, wherein any portion of the light that does not fall within the boundaries is counted as not utilized, i.e., is “wasted”.

More specifically, the present invention is directed to an LED lighting apparatus with reflectors for illuminating areas with a predefined pattern of light intensity toward a preferential side of the apparatus, particularly when it is mounted on a utility pole and positioned to point a light emitting portion (light source) generally downward toward the ground. The present invention is particularly concerned with IES Types II, III, and IV lighting, e.g., street lighting for streets having different widths to be illuminated by an apparatus located at one side of the street.

As referenced herein, the LED lighting apparatus comprises an assembly of an LED light source within a housing, which may also be known as a fixture or luminaire. In accordance with common practice, the entire LED lighting apparatus may also be referred to as the “fixture” or the “luminaire”, meaning the housing, with or without the LED light source, as can be determined from context.

The LED apparatus of an embodiment designed to produce Types II-IV illuminance patterns 150 incorporates a single row of LEDs, each covered by a secondary lens, all assembled as a module. A vertical reflector is disposed adjacent to the row of LEDs so that the front surface of the vertical reflector acts to help direct the light from the LEDs in the direction downward away from the LEDs and forward from the front surface of the vertical reflector.

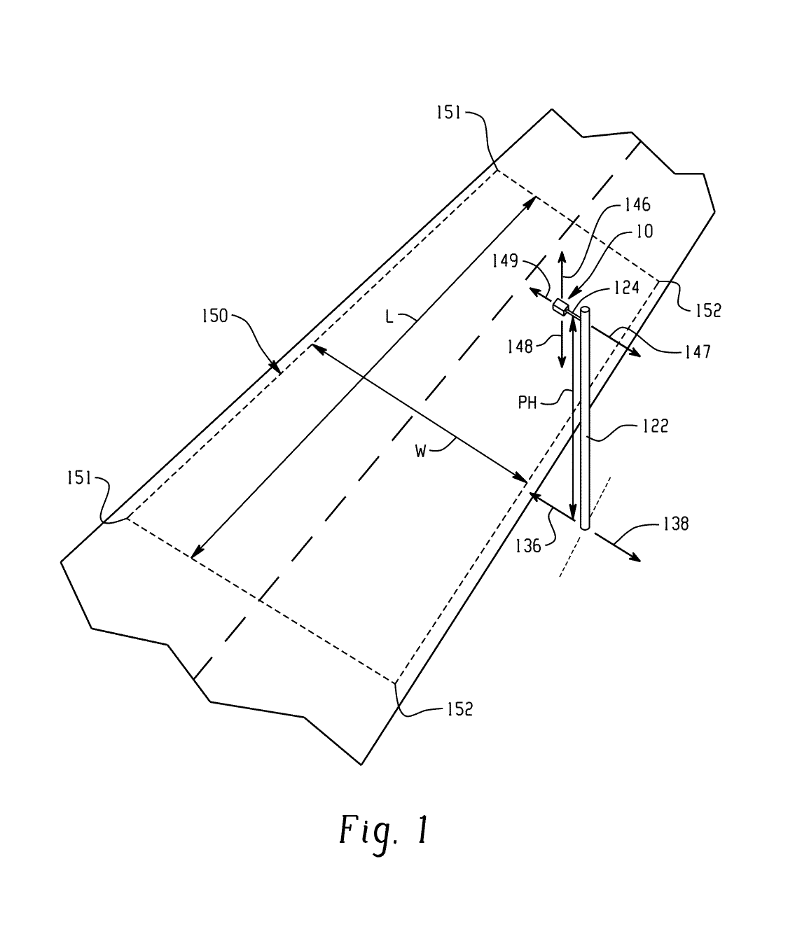

Referring to FIG. 1, there is illustrated an LED lighting apparatus with reflectors (e.g., apparatus 10 of the present disclosure) mounted on a utility pole 122 at a pole height PH for illumination toward a “front” preferential side (“street side”) 136 in a downward direction 148 and a forward direction 149 (laterally across the width of the street). Especially for (IES) types II, III, and IV lighting (types II-IV), a common application is street lighting as illustrated in FIG. 1. Thus the preferential side 136 is the “street side” of the pole 122, and the LED lighting apparatus (fixture) (e.g., fixture 10) is mounted on the preferential side and oriented such that illumination in the forward direction 149 is directed laterally across the longitudinally extending street. A non-preferred, or “back” side 138 of the fixture 10 and pole 122 is also known as the “house side”, and the amount of “back illumination” is preferably minimized to avoid wasting light output relative to street lighting (type II-IV). More than a specified range and amount of backlight may be considered “nuisance” light. The hereindisclosed LED lighting apparatus (fixture) 10 allows only a bare minimum amount of back illumination and substantially no “up light” (in the upward or skyward direction 146). Although not illustrated in this Figure, it will be known by one of ordinary skill in the related arts that type V illumination is for other types of lighting applications wherein the desired illuminance pattern extends in substantially all lateral and longitudinal directions on the ground under the lighting apparatus, i.e., without a “preferential side”.

The LED Lighting Apparatus in General

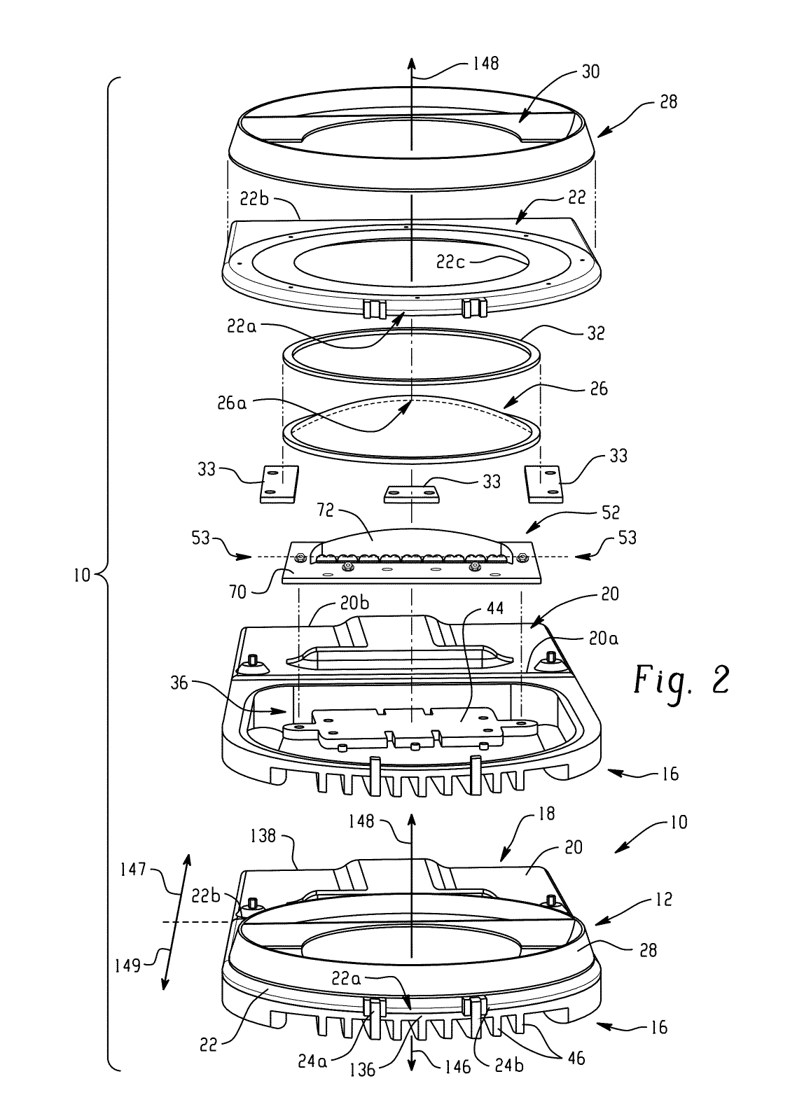

FIG. 2 is an exploded plus an assembled three dimensional front and “bottom” view of the (inverted) LED lighting apparatus with reflectors 10, according to the present invention, wherein a back portion is not exploded, but remains closed by a controls cover 20 extending from a back end 20b to a front edge 20a thereof. In the front, a light cover 22 extends from a front end 22a to a back edge 22b which laps with the front edge 20a of the controls cover 20 when the apparatus 10 is fully assembled and closed.

Even though this is actually an inverted or upside-down view (downward direction 148 is shown as an upward pointing arrow), the majority of this disclosure will be related to similar views because most of the elements being discussed are best seen this way. In effect, the disclosure will use a local coordinate system that is inverted from the global coordinates shown in FIG. 1, and is somewhat centered on the LED light source (e.g., LED module 52) in the fixture 10. The correlation between coordinate systems should be apparent in light of the following guidelines. The global “downward” direction 148 is the direction that light emitted by the LED light sources takes as it proceeds away from the light source and out through a cover lens 26 of the fixture 10. Thus any view apparently looking “down” at the LEDs and/or the cover lens 26 and/or the bottom or lower portion 18 of the fixture 10 will use the local coordinates wherein the “downward” direction 148 equates to terms such as “up”, above, away, out of, and the like. Finally, the forward direction 149 will mean toward the “front” or front end 22a of the LED lighting apparatus 10, and correspondingly, the back or backward direction 147 will mean toward the back end 20b of the fixture 10. Similarly, relative locations such as “in front of” and “behind” are correspondingly associated with the forward direction 149 and the backward direction 147, respectively.

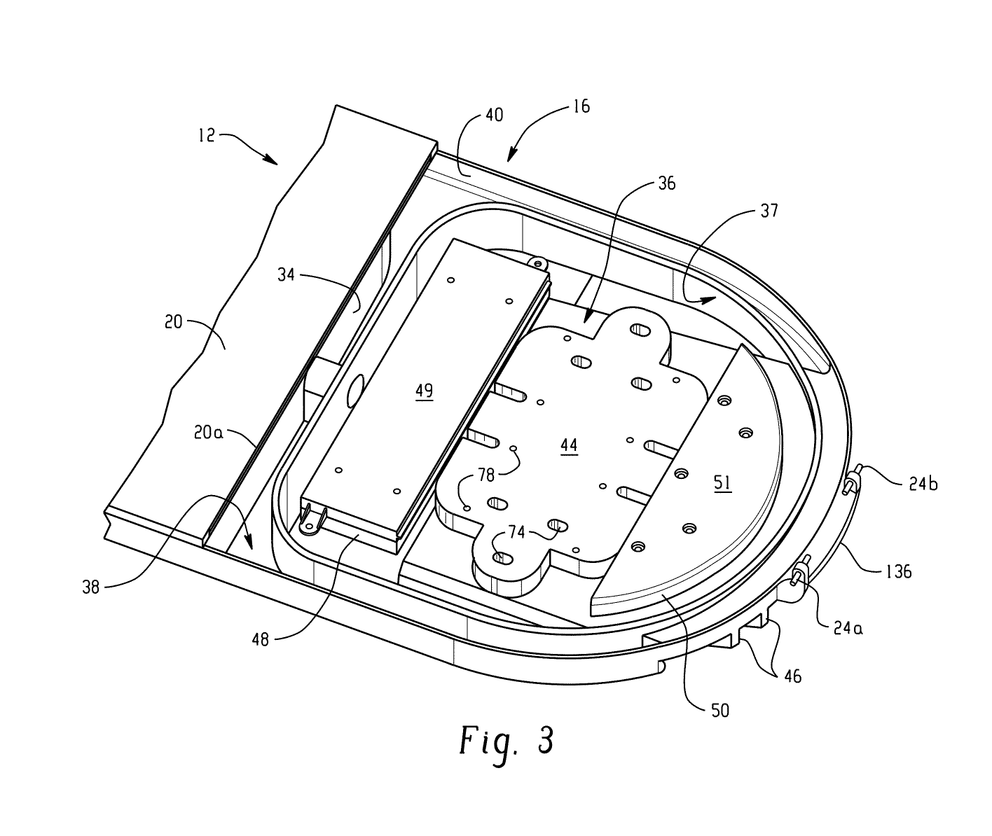

As shown in FIGS. 2 and 3, the LED lighting apparatus 10 includes a housing 12 with external cooling fins 46 provided on an external surface of an upper portion 16 of the housing 12. A lower portion 18 of the LED lighting apparatus 10 includes a control cover 20 that covers electronics used to supply power to the LEDs and components for connection to the pole 122 to which the LED lighting apparatus 10 is attached (FIG. 1). The control cover 20 may be hingedly mounted to the housing 12 by hinges (not shown) at the back end 20b to provide easy access to the power electronics and on-site installation mechanical and electrical connections.

The lower portion 18 of the LED lighting apparatus 10 includes a hinged light cover 22 that is secured at a front side (or end) 22a to the housing 12 by hinges 24a and 24b. The opposite side, back edge 22b of the hinged light cover 22 is aligned with and abuts the front edge 20a of the control cover 20.

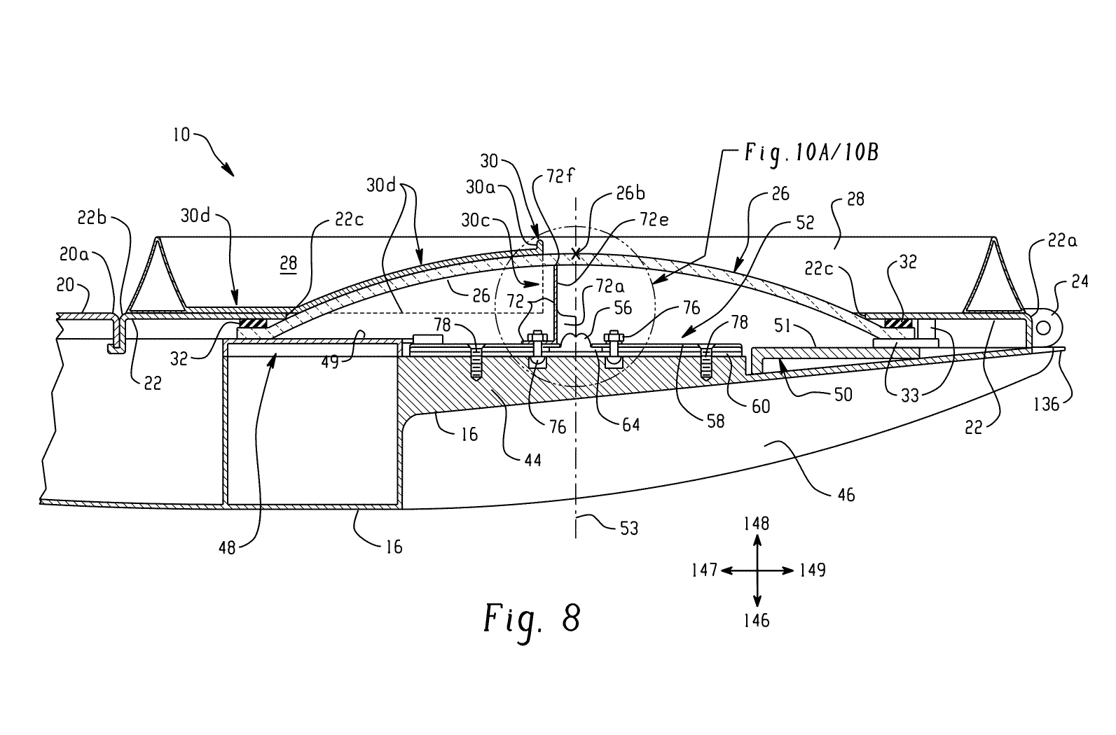

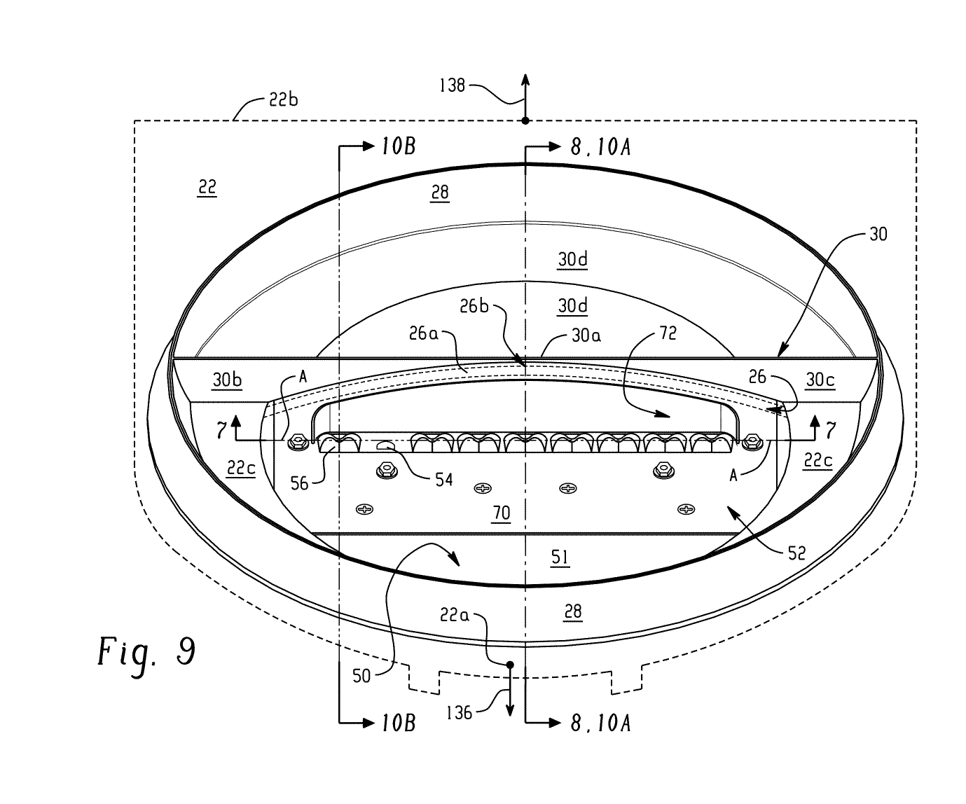

Referring again to FIG. 2, the hinged light cover 22 has an outer, or cover lens 26 (a.k.a. “drop lens” or “cover glass”) constructed of any suitable transparent or translucent material such as glass or plastic. In the illustrated embodiment, the cover lens 26 has an outward extending convex dome shape with a centered apex (26b, see FIG. 8), and is clamped 33 under an aperture portion 22c (opening) of the light cover 22 and provided with a gasket 32 to create a watertight seal. A ring shield 28, or “uplight shield” is mounted to the light cover 22 by suitable means such as screws (not shown). A back light shield 30 is mounted over the cover lens 26 and a vertical portion 30a, 30b, 30c extends laterally across the ring shield 28. As best seen in FIG. 9, a center section 30a of back light shield 30 has a concave shape and is sized so that the center section 30a can rest upon a convex section 26a of the cover lens 26. Two end sections 30b and 30c of the vertical part of back light shield 30 extend from the center section 30a to the ring shield 28. As shown in FIG. 8 the back light shield 30 is also aligned with a vertical reflector 72 and with a row 53 of LEDs with lenses 56, both of which are on an LED module 52 that is mounted inside the housing 12. It will be seen that the back light shield 30 works with the vertical reflector 72 to direct the LED light forward (direction 149) from the module 52 disposed under (inside) the cover lens 26 and between the backlight shield 30 and a forward section of the ring shield 28 which is closer to the hinges 24 at the front end 22a of the light cover 22. A back covering portion 30d of the backlight shield 30 provides an opaque light blocking member over the area between the vertical portions of the backlight shield 30a, 30b, 30c and a rear portion of the ring shield 28 which is closer to the back edge 22b of the light cover 22.

Referring to FIG. 3, there is illustrated a three dimensional view inside of the (inverted) upper portion 16 of the housing 12 with the hinged light cover 22 removed to reveal the light chamber 36 disposed on the inside floor surface 38 of the housing 12. An upstanding wall 40 is formed about the perimeter of the floor surface 38 and provides an outside wall with support for the hinged control cover 20 and the hinged light cover 22. The control chamber 34 is a separate chamber under the control cover 20. A light chamber wall 37 surrounds the light chamber 36 and extends high enough to seal against the hinged light cover 22. A weathertight seal may be provided by positioning a gasket in a groove (e.g., as shown in FIG. 7) around the top of the light chamber wall 37.

Within the light chamber 36 a module mounting platform 44 is disposed on the floor surface 38 (e.g., 38 and 44 molded or cast as a unitary object that also includes external heat sink fins 46). Adjacent either long side of the mounting platform 44 is disposed a rear box 48 and a forward box 50, which have covers with top surfaces 49 and 51, respectively.

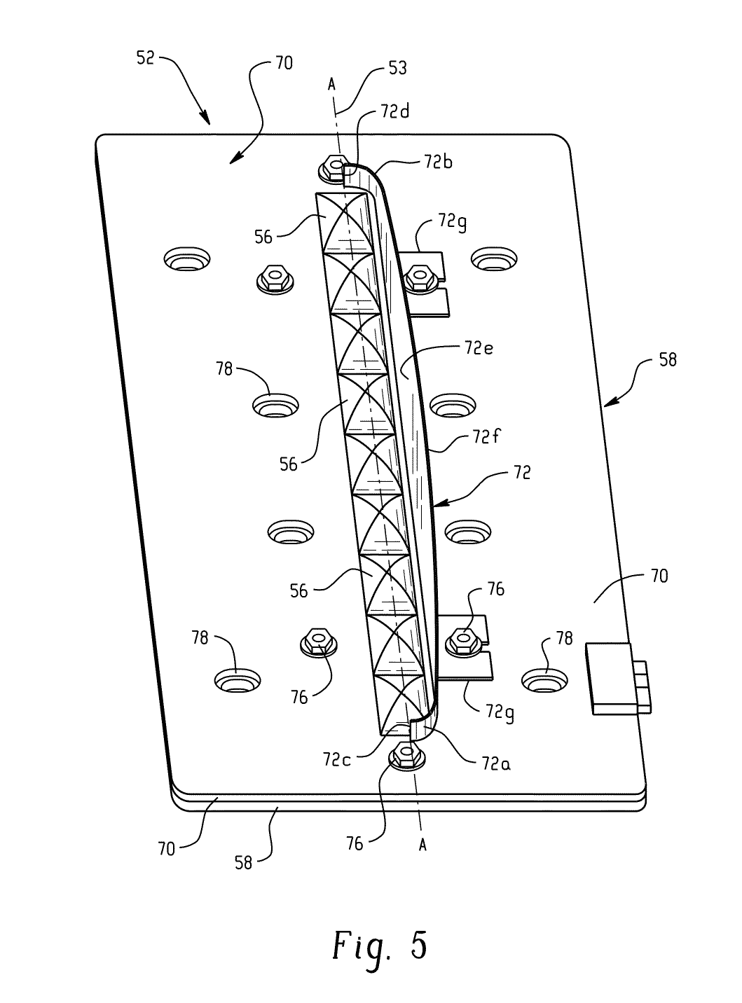

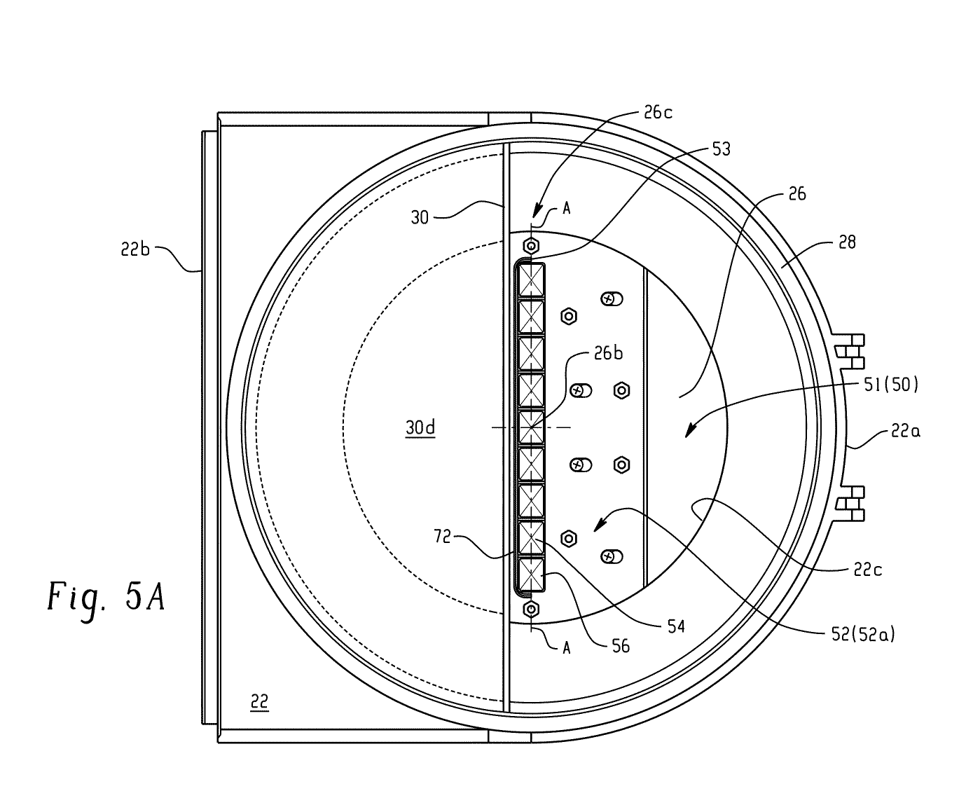

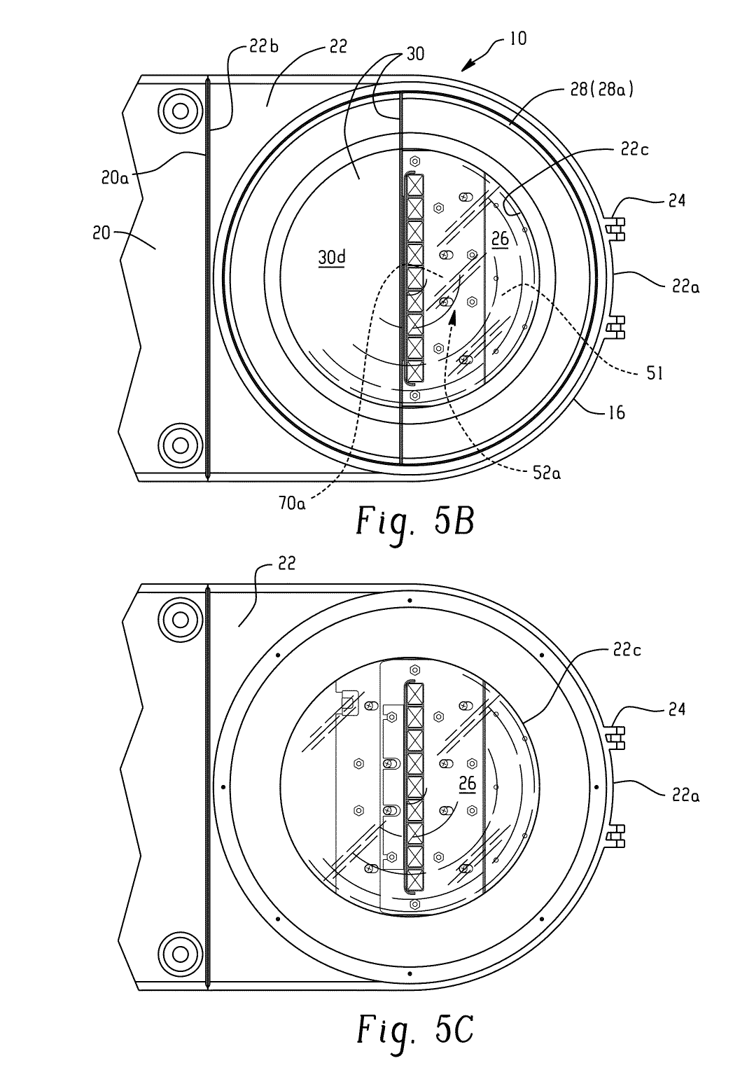

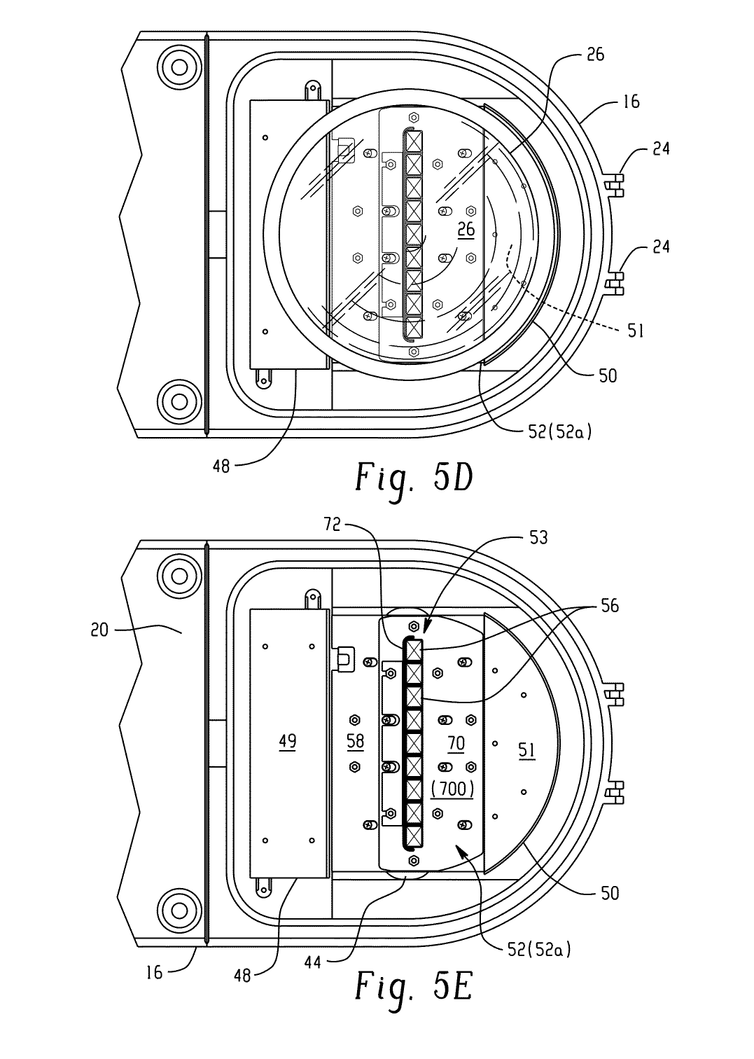

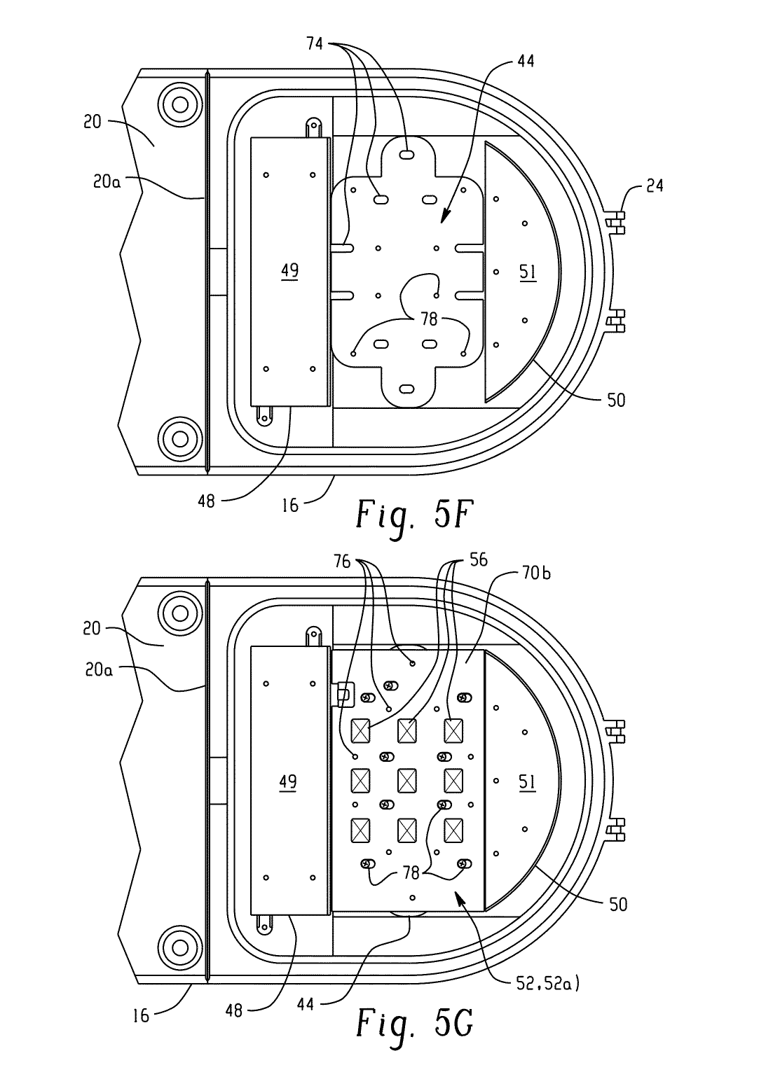

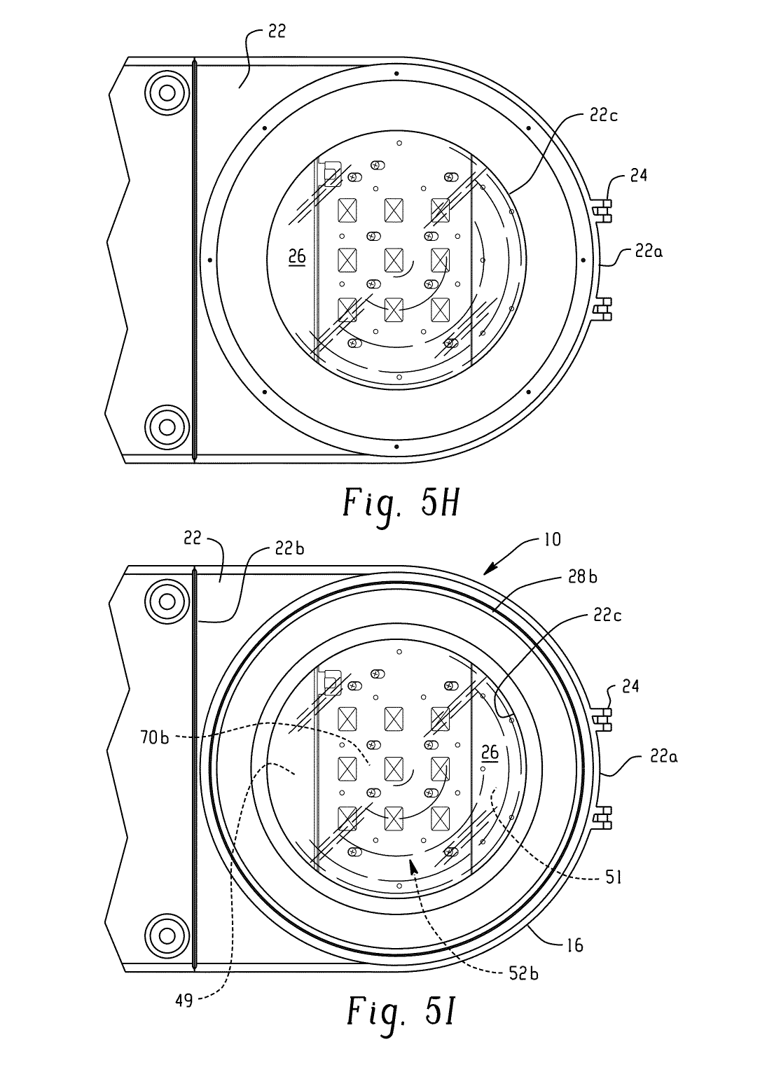

The LED module 52 (see FIGS. 2 and 5) is mounted to the module mounting platform 44 between the rear box 48 and the forward box 50 using fasteners 78 that screw into threaded holes 78 in the platform 44. As shown in FIG. 8, these fasteners 78 accurately position the LED module 52 such that the vertical minor 72 is properly aligned and positioned relative to the backlight shield 30, and also position the line of LEDs 53 directly under the cover lens apex 26b thereby centering the LED light with the cover lens 26. Since the external heat sink fins 46 are integrated with the platform 44, they work together to conduct heat away from the LED module 52 and disperse it outside.

LED Module Assembly

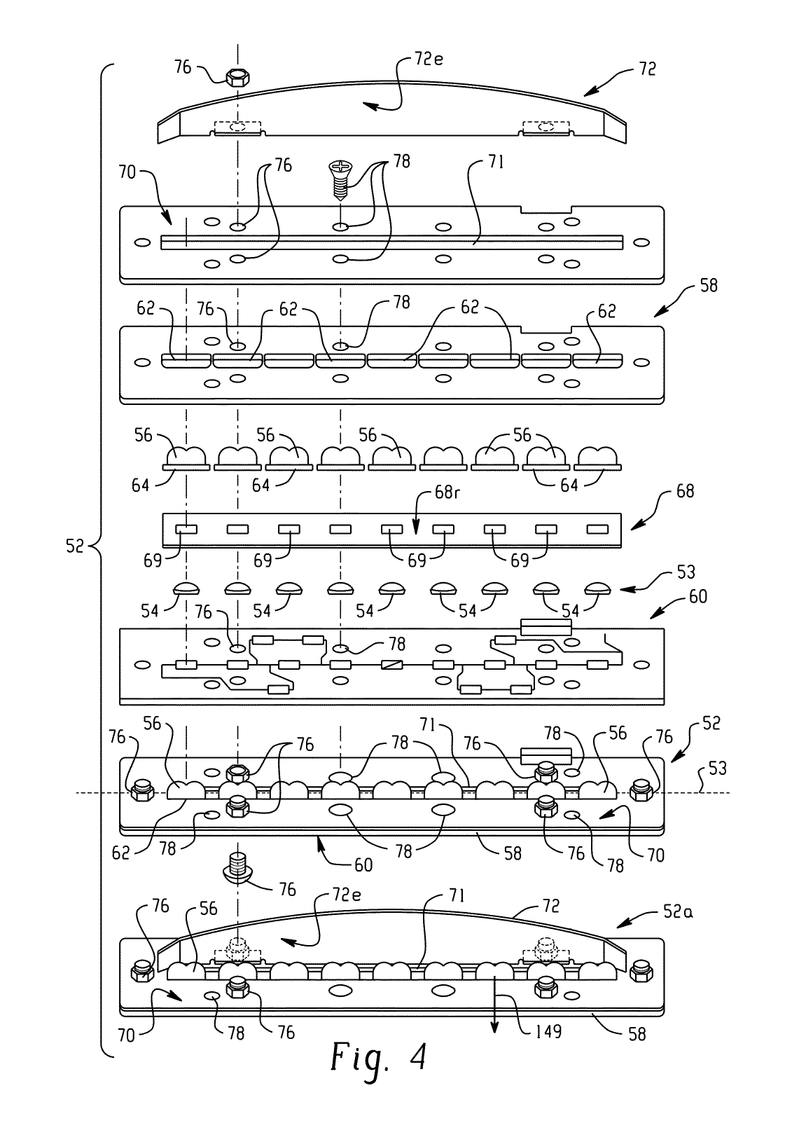

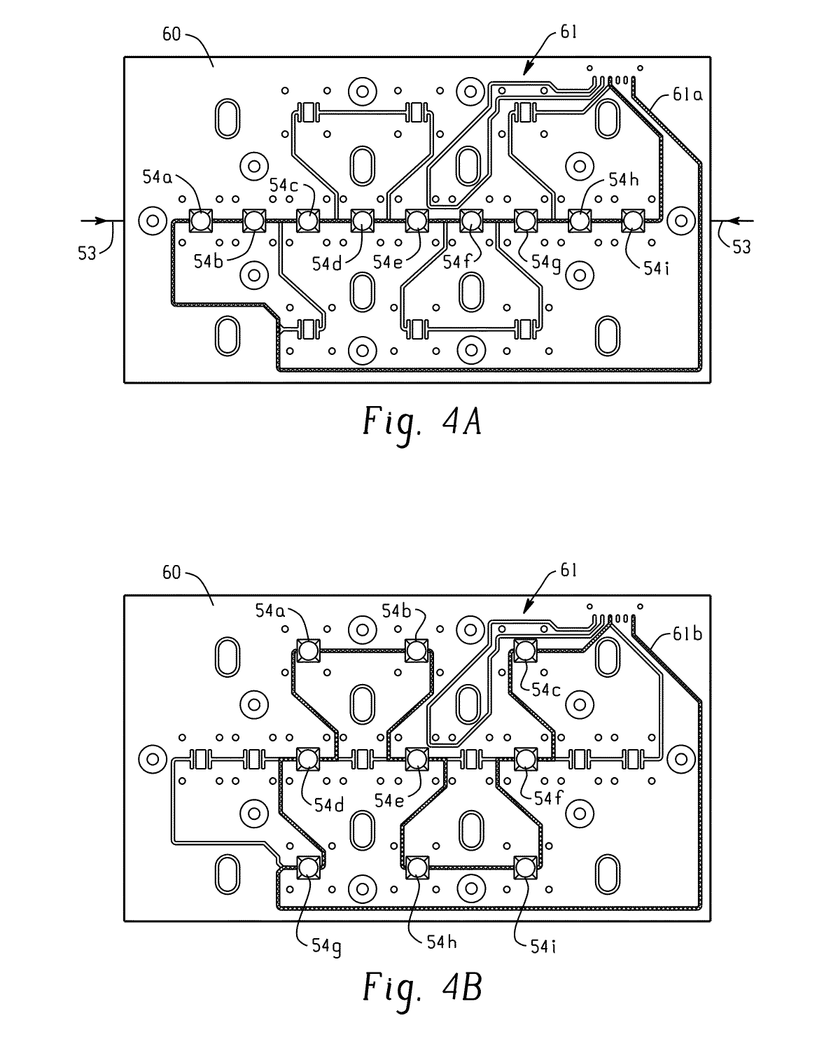

Referring to FIGS. 4, 5 and 6, a plurality of LED devices 54 (LEDs) are aligned in a single row 53 across the length of the LED module 52. The LEDs 54 are mounted on a printed circuit board (PCB) 60 which is disposed under a module cover 58. Each of the LEDs 54 is covered by a secondary lens 56 that projects outward through an opening 62 in the module cover 58. A PCB reflector 68 provides a reflective surface 68r disposed between the printed circuit board 60 and the secondary lenses 56, and has a plurality of openings 69, each of which is sized and positioned to fit around each of the LEDs 54. The reflective surface 68r is preferably a diffuse reflector, but can be specular given another aspect of the module described further hereinbelow. (In an embodiment, the PCB reflector 68 is a thin plastic sheet that is made relatively inexpensive by using material that reflects specularly.) A flange 64 extending around the bottom of each of the secondary lenses 56 is overlapped by the module cover 58 to secure the secondary lenses 56 between the printed circuit board 60 and the module cover 58, by pressing the flanges 64 against the PCB 60, thereby holding each secondary lens 56 in position over a one of the LEDs 54.

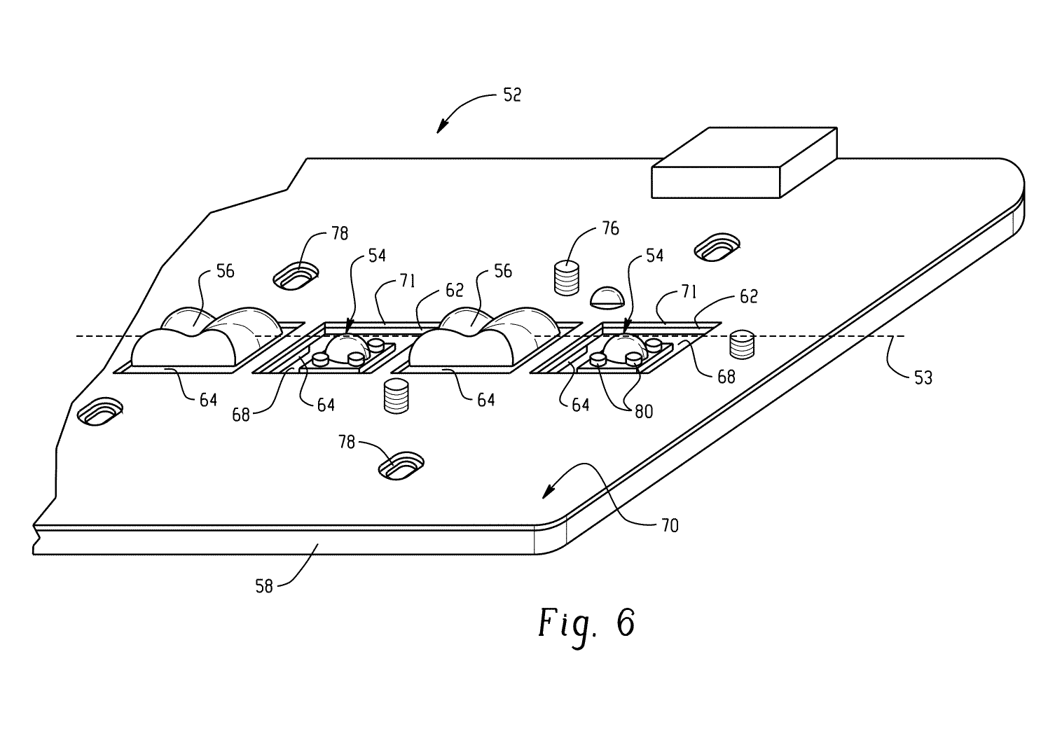

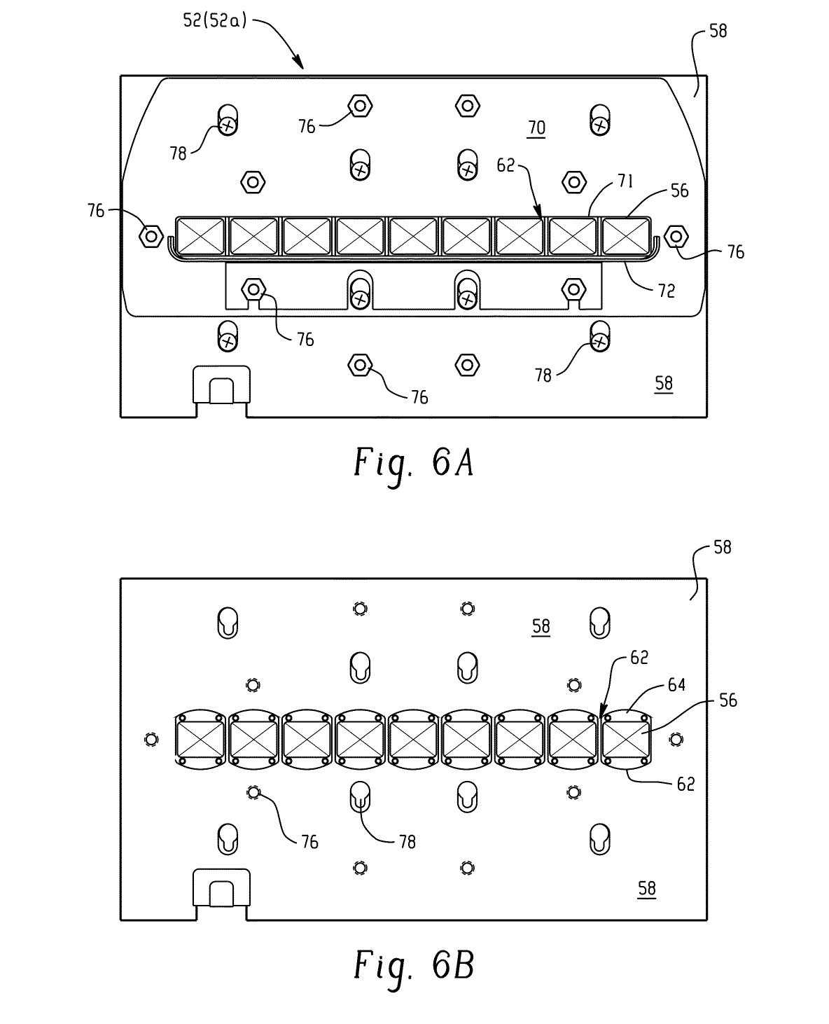

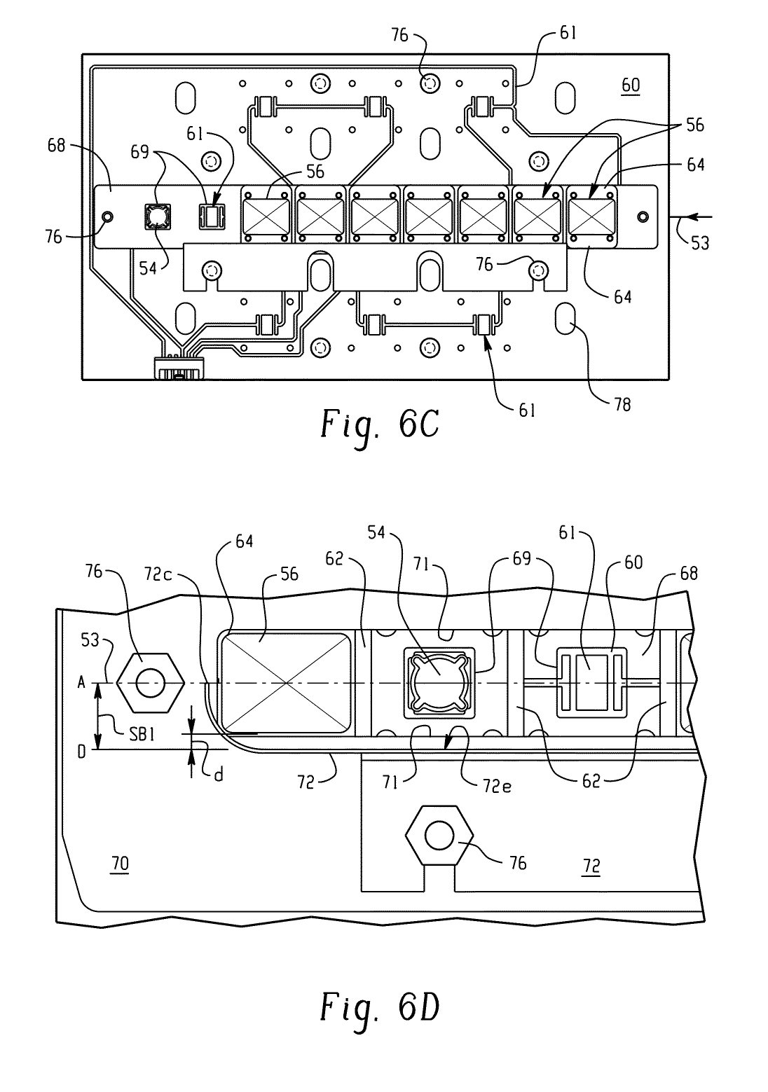

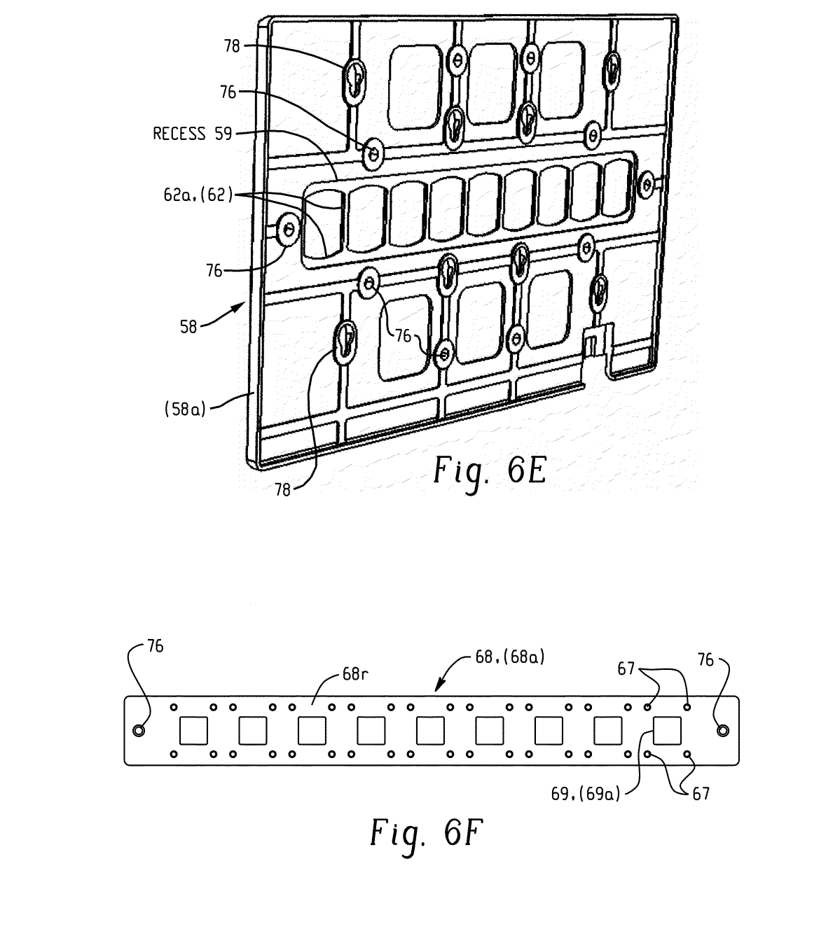

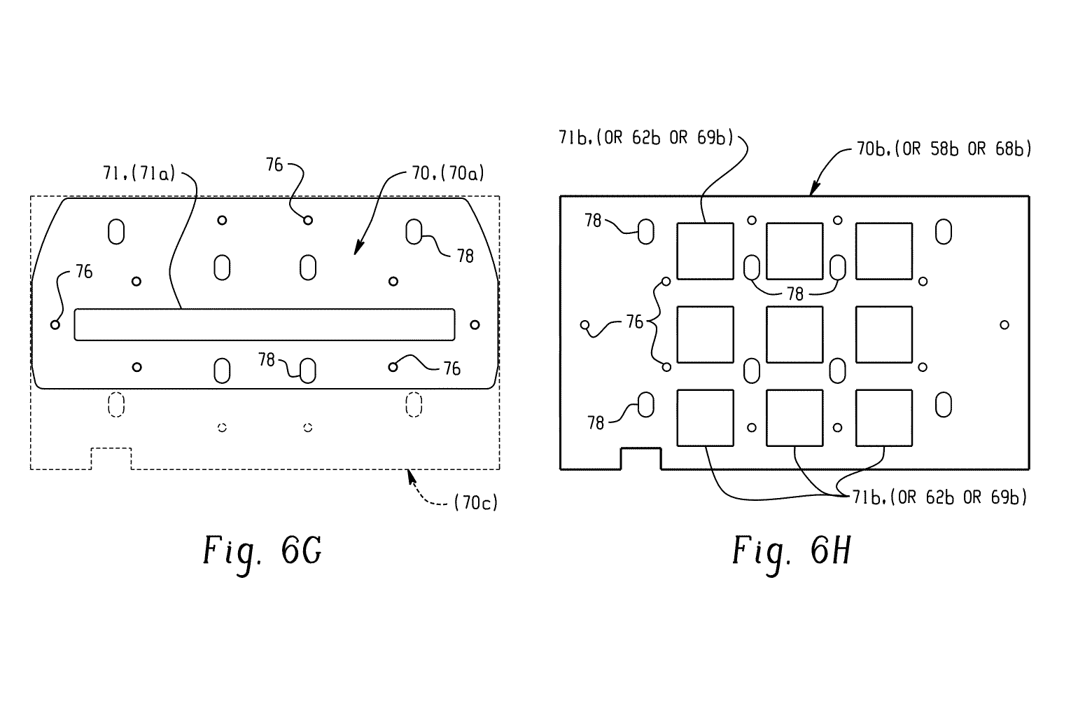

A horizontal reflector 70 is disposed across at least a portion of the top of the module 52, preferably over all of the top that is exposed to light that can be reflected out of the apparatus 10 in which it is mounted. One or more openings 71 in the horizontal reflector 70 allow the secondary lenses 56 to protrude up through the reflector 70. In FIG. 4 an embodiment of the reflector 70 is shown having a single, slot-like opening 71, and FIG. 6 illustrates an embodiment having a plurality of openings 71, one per LED 54.

Referring also to FIGS. 5, 7 and 8, module assembly fasteners 76 (e.g., machine screw and nut in a through-hole) are spaced around the module 52 and used to hold all of the layers and parts together in a single unit, i.e., an LED module assembly 52. When a vertical reflector 72 is included, it is attached as shown in FIG. 5 wherein a bracket (mounting tab) 72g that extends at a right angle from the reflector 72 is held in place by one of the module assembly fasteners 76.

When the assembled LED module 52 is mounted on the mounting platform 44 in the fixture housing 12, recessed areas 76 accommodate the fasteners 76 where they protrude below. The module 52 is removably affixed to the platform 44 by a set of mounting fasteners 78 in through-holes 78 spaced around the module 52. Referring especially to the embodiment illustrated in FIGS. 5 and 8, the fasteners 78 are screws that pass through “keyholes” to screw into threaded holes 78 in the mounting platform 44. Use of keyhole-shaped through holes 78 allows installation/removal of the module 52 by loosening the screws 78 without needing to remove them.

LEDs and Positioning of Module Elements

Referring particularly to FIGS. 6 and 7A, component parts of the LED device 54, such as Model SST-90 from Luminous Devices Inc. (Billerica, Mass.), are illustrated in a detailed view of one that is mounted in an assembled LED module. In a vertical cross-section view passing through the center of the LED 54, an embodiment of the LED 54 is shown as a pre-assembled device that includes a square ceramic substrate 85 as the structural base of the assembly. A square LED “die” 87 is affixed on the substrate 85 and is mostly covered by an “extended area” (3 mm square) emitter (LED emitting surface) 86. For “white light” LEDs the emitter surface 86 is coated with a phosphor layer 88 that converts blue LED emissions to “white” light as it passes through the phosphor 88. Finally the phosphor coated LED die is embedded in a hemispherical “primary lens” 55 that is formed on the substrate 85. The illustrated embodiment of the LED 54 also provides raised round “alignment pegs” 80 around the primary lens 55 to define four “corners” 89 for the LED package 54. The alignment pegs 80 are positioned on corner-to-corner diagonal lines equidistant from the center of the LED, where the corners (89, not shown) are the aligned physical corners of the emitter surface 86 and of the substrate 85. In other words, moving radially outward from the origin/center of the LED emitter 86, the four corners of the square emitter 86 are aligned with the four alignment pegs 80 (if present), and with the four corners of the square substrate 85, thereby nesting them all around a common center point at the x-y-z zero point (the origin), with parallel sides of the squares.

For reference in drawings such as FIGS. 7A, 10A and 10B, a (local) rectangular coordinate system framework is established as shown in FIG. 7A. This coordinate system is relative to an LED, generally in the context shown wherein the LED is mounted in an assembled LED module 52. The x-y plane is defined as being co-planar with the surface of the LED emitter 86 and is also designated as the LED base plane 81. The x-y origin is defined to be in the base plane 81 at the geometric center of the emitter 86 and therefor is also the center of the elements of the LED device, including the primary lens 55 which is a hemisphere with its equatorial plane (base) co-planar with the base plane 81. As a result, any light ray emitted from the center of the LED emitter 86 will be a radius line of the primary lens 55, therefor impinging on the surface of the primary lens 55 at a 90 degree angle of incidence, and therefor will not be refracted away from radial as it passes through the surface. The vertical z-axis is orthogonal to x and y, and therefor is perpendicular to the base plane 81 and has its zero value at the x-y-z origin at the center of the LED emitter 86. By convention in this disclosure, as shown in FIG. 7A the x-axis is defined as being parallel to the line 53 that forms the lengthwise centerline of the straight row of LEDs 54 mounted on the PCB 60. This convention further links coordinate systems in that the row 53 of LEDs (and thus the x-axis) is aligned with the “lengthwise” direction (shown by length dimension line L) of the lighting pattern 150 emitted by the LED module 52 and established on the ground plane as shown in FIG. 1 for a properly positioned LED lighting apparatus 10 that contains the module 52 mounted therein as shown in FIG. 7. So dimensions associated with the x-axis are called “length”, and correspondingly, dimensions associated with the y-axis (not illustrated but understood to be orthogonal) are called “width”. Furthermore, the straight downward direction 148 is generally assumed to be parallel to the z-axis (i.e., a properly positioned apparatus 10 that orients the x-y base plane 81 parallel to the ground plane), and distances in that direction increase from z equals zero at the origin (or LED base plane 81). Given this, then y value increases (positive values) for distance from the origin in the forward direction 149, and decreases from zero (negative values) in the backward direction 147.

Referring to FIGS. 7A and 7B, details of the LED module 52 as it is assembled around an LED 54 are illustrated. The LED substrate 85 (affixed to the PCB 60) is surrounded by the PCB reflector 68 which has a square opening 69 (labeled in FIG. 4) that closely fits around the substrate 85 and lies on top of the PCB 60, loosely held there by the underside 66 of the secondary lens 56, which is raised above the PCB surface by leveling bosses 65 which preferably pass through holes 67 in the PCB reflector 68 as shown to allow direct contact of the leveling bosses 65 with the surface of the PCB 60, thereby providing the most accurate leveling. The leveling bosses 65 are thus used to align a center axis of symmetry for the secondary lens 56 with the center z-axis of the LED primary lens 55, thereby also establishing a perpendicular base plane for the secondary lens 56 that is parallel to the LED base plane 81. In addition the leveling bosses 65 position all of the secondary lenses 56 at a consistent level/height relative to the PCB 60, and thus relative to the LED emitter surface 86, thereby making the base planes of the secondary lenses 56 co-planar with the LED base plane 81.

The secondary lens 56 has a flange portion 64 and a body portion 63 distinguished by the optically designed shape/contour of its surface (also referenced as 63). The flange 64 is held down against the PCB 60 by the module cover 58 which has an opening 62 sized to accommodate the width and length of the secondary lens 56 (further discussed with reference to FIG. 10C). The ends of flanges 64 for adjacent lenses are partially shown to the right and left of the view. It may be noted that the length of the flange (measured side to side along the x-axis) is determined by the LED 54 spacing along the row 53, which in turn is dictated by the optical design for the secondary lenses 56. Since each secondary lens 56 is individually positioned by its associated LED 55, the side-to-side length of the flanges 64 must be less than the nominal LED spacing in order to avoid having a lens 56 interfere with the alignment of an adjacent lens 56. The horizontal reflector 70 also has an opening 71 for the secondary lens 56, and the opening 71 may be sized and shaped differently than the opening 62 as described elsewhere herein.

Reflectors

The LED module 52 is designed to flexibly accommodate both types II-IV and type V lighting. First we will discuss designs for the forward-directed lighting patterns of types II-IV (offset to a preferential side).

For example, the assembled module 52 illustrated at the bottom of FIG. 4 is a type II-IV variety of module 52a which includes a vertical reflector 72 that reflects LED light forward (direction 149) rather than allowing light to pass back behind it. Therefor, the horizontal reflector 70 need only cover the portion of the module 52 that is forward 149 from the vertical reflector 72. The horizontal reflector 70 is a diffuse reflector, and can be of any suitable material such as a reflective adhesive tape, a sheet of reflective material (e.g., textured aluminum foil), a white plastic sheet with a rough surface, a painted module cover surface, or any other suitable diffusely reflective material. A sheet of material may be used for best efficiency because it can overlap parts of the module that aren't covered by the module cover 58. For example, FIGS. 4 and 5 show a horizontal reflector 70 that abuts sides of the secondary lens 56 for a close fit, while FIG. 10C shows why a universal module cover 58 may not be able to cover all of the flange 64 for some types of lenses 56. It is simpler and less expensive to stock a single module cover 58 plus a plurality of horizontal reflectors 70 to enable manufacture of all types II-IV module assemblies 52.

An example of a suitable material for the horizontal reflector 70 is used in an embodiment wherein a PET plastic sheet having a “micro cellular” structure makes a good diffuse reflector due to open cells that create many pores in the white surface, which is thus roughened.

FIGS. 3 and 9 show that the front box 50 in the light chamber 36 is also exposed to light that can be reflected back inward by the cover lens 26, therefore it is also given a diffusely reflective surface 51. For example, a suitable paint (e.g., matte white) may be used to form the horizontal surface reflector 51.

Furthermore, for LED lighting apparatuses 10 that may not have a shield (e.g., backlight shield 30) covering part of the cover lens 26, or if a vertical reflector 72 is not being used, then additional reflective surfaces may be desirable according to the presently disclosed design principles. For example, a type V LED lighting apparatus 10 will not have a vertical minor 72 or a backlight shield 30, so that the entire light cover opening 22c will be used. In such a fixture, then, the horizontal reflector 70 covers the entire top of the LED module 52, and the rear box 48 (see FIG. 3) is given a diffusely reflective top 49 like that of the top 51 of front box 50.

In general, all of the horizontal reflectors 70, 68, 51 and 49 are designed to diffusely reflect because the stray light that they handle most likely comes from Fresnel reflections (in cover lens 26 or secondary lens 56), or possibly reflection from various inside surfaces of the light chamber 36. Most likely such reflected light “rays” will be directed at a low angle toward enclosed side portions of the light chamber 36 or under the module cover 58, so specular reflection off of a horizontal reflector would lead to trapping such light rays, thereby wasting their light. A diffuse reflection, however, will redirect the light rays to a variety of directions that are much less affected by the incident angle, resulting in a much higher percentage of the reflected light being passed back out through the cover lens 26 in the opening 22c of the light chamber 36.

Referring to FIGS. 5 and 7, there is illustrated an elongated vertical reflector 72 which is disposed adjacent and parallel to the line 53 (marked A-A) of secondary lenses 56 (on LEDs 54) and has an upper edge 72f contoured to the shape of the cover lens 26 as shown in FIG. 7. In the embodiment having a cover lens 26 with a concave inner shape, the upper edge 72f of the reflector 72 has a corresponding convex shape that follows the inside surface of the cover lens 26. As shown in FIGS. 5 and 10A, the vertical reflector 72 may be spaced a distance “d” of between 0 to 6 mm, and preferably between 0.25 mm to 1.0 mm from the closest surface of the secondary lenses 56. The vertical reflector 72 can be constructed of any rigid, heat resistant material such as for example, steel, aluminum, copper, plastic, etc., which is provided with a specular reflective front surface 72e facing the line 53 of secondary lenses 56. For example, a high reflectance polished aluminum “mirror” may be used. End sections 72a and 72b of the reflector 72 are curved towards the line 53 of secondary lenses 56 at each end of the row 53 and wrap around the row-end lenses 56 to a vertical end edge 72c, 72d at about the centerline A-A which is through the center of the line or row 53 of secondary lenses 56 and LEDs 54.

The reflective front surface 72e of the vertical reflector 72 is disposed adjacent to the row 53 of LEDs 54 to reflect backlight from the LEDs towards the forward 149 and downward 148 directions away from the LEDs, i.e., downward 148 towards the cover lens 26 and forward 149 from the front surface 72e of the vertical reflector 72. Furthermore, it can be seen that the curved end sections 72a and 72b will help to appropriately redirect light emitted at low angles from the ends of the line 53 of LEDs 54. The action of the vertical reflector 72 will be discussed in detail hereinbelow with particular reference to FIGS. 10A and 10B.

Some light from the LEDs 54 may be refracted and/or reflected back toward the LED module 52 (e.g., Fresnel reflection by the cover lens 26), therefor the horizontal flat diffuse reflector 70 across the top of the module cover 58 works in combination with the vertical reflector 72 to direct as much as possible of the light from the LEDs 54 into the desired downward direction 148 away from the LEDs 54 and horizontal reflector 70, and into the forward direction 149 away from the front surface 72e of the vertical reflector, i.e., toward the preferred side (front 136) of the LED apparatus 10.

As seen in FIGS. 6 and 7A, the printed circuit board (PCB) 60 is disposed under the module cover 58 (e.g., within a surrounding sidewall, not detailed). A row 53 of a plurality of openings 62 are formed through module cover 58 to receive secondary lenses 56. The flange 64 extending around the bottom of each of the secondary lenses 56 is overlapped by the module cover 58 beyond the opening 62 and thereby secured in place. The horizontal reflector 70 has a corresponding plurality of openings 71 that may match the dimensions of the openings 62 (as in FIG. 6), or may be sized to closely surround the sides of each secondary lens 56 as shown and described hereinabove with reference to FIG. 4.

A horizontal PCB reflector 68 is placed between the secondary lenses 56 and the PCB 60 to reflect any light that bounces downward (e.g., by Fresnel reflections in the primary lens 55 and/or the secondary lens 56). The PCB reflector 68 should be a diffuse reflector, but a non-diffuse reflective material may be thinner and less expensive, therefore the underside surface 66 of the secondary lens 56 is roughened (see FIG. 7B) so that light passing through the underside 66 to and from the reflector 68 will be diffused. A textured bottom surface 66 may be achieved, for example, by etching it; or for example, by bead blasting a mold insert used to mold the lens 56. As an example of an inexpensive material for use in the PCB reflector 68 a polyester reflective film may be used.

Referring again to FIG. 7, there is illustrated a cross sectional view along line 7-7 of FIG. 9. The row 53 of LEDs 54 is shown mounted to the printed circuit board 60 and covered by a secondary lens 56. As shown in FIG. 7A, each secondary lens 56 is held in place by the module cover 58 to make an assembled LED module 52 (see FIG. 4) which is held together by fasteners 76. Then the LED module 52 is mounted to the module mounting platform 44 using screws 78 into threaded holes 78 in the platform 44 as shown in FIG. 8. The mounting platform 44 conducts heat from the LED module 52 to the heat sink fins 46 which, for optimal thermal conductivity are positioned immediately above corresponding ones of the LEDs 54. (Note: the word “above” in the present context refers to the global upward direction 146, which is illustrated here in a fixture 10 that is shown inverted.)

Vertical Reflector Details

FIG. 7 also shows the vertical reflector 72 as being disposed behind the row 53 of LEDs 54 with its upper edge 72f disposed under the cover lens 26 and having a shape that follows the inner curve of the lens 26 and is spaced equidistant therefrom, preferably as close as possible given normal manufacturing tolerances, plus allowance for thermal expansion. For example it is within the terms of the present embodiment to space the upper edge 72f of the vertical reflector a distance of between 0 mm to about 3 mm and preferably about 1 mm to about 2 mm from the surface of the inner curve of the cover lens 26. In another embodiment, the height of the vertical reflector 72 is a large fraction of the space between the mounted module (e.g., surface of horizontal reflector 70) and the inner curve of the lens 26, for example 96 to 99%, preferably about 97 to 98%.

Referring to FIGS. 8 and 10A-10B, the vertical reflector 72 is disposed in parallel alignment with the backlight shield 30, and either directly under it or preferably forward of it a distance labeled shield setback SB2. With this structural arrangement, most light from the row 53 of LEDs 54 is directed downward 148 and forward 149 (toward the front end 22a, street side 136 of the LED apparatus 10). Except for a limited portion of the emitted light that passes over a top edge 30f of the backlight shield 30, the backward-directed light 91 from the LEDs 54 is re-directed forward 149 (and downward 148) by a reflective surface 72e of the vertical reflector 72 inside the cover lens 26, and by a reflective surface 30e of the backlight shield 30 outside of the cover lens 26.

As shown in FIGS. 8 and 9, an extra covering 30d, preferably opaque to prevent any stray light from the LEDs 54 from going in the backward direction 147, is disposed over the cover lens 26 to block the opening 22c of the light cover 22 behind (147) the backlight shield 30. For convenience in assembly, the extra covering 30d may be integral with the vertical parts (30a, 30b, and 30c) of the backlight shield 30, and most preferably also integral with the ring/uplight shield 28.

Referring to FIGS. 10A and 10B, there is illustrated a variety of light “rays” 90, 91 emitted by the emitter 86 of the LED 54, then passing through the color correction phosphor 88, the primary lens 55 and the secondary lens 56 to its surface 63 where the ray is refracted according to the shape of the secondary lens surface 63. FIG. 10A is a cross-section view taken along the line 10A shown in FIGS. 7 and 9, and shows the vertical reflector 72 behind the LED 54 at the reflector's greatest height (to top edge 72f) as allowed by the cover lens 26. FIG. 10B is a similar view taken along the line 10B in FIGS. 7 and 9, and shows the vertical reflector 72 at its lowest height, again as allowed by the cover lens 26. Both FIGS. 10A and 10B are essentially a magnified portion of the fully assembled LED lighting apparatus 10 as indicated by the dashed-line circle in FIG. 8 (platform 44 and screw 76 details omitted).

The light beams/rays 90, 91 are individually referenced using lower case letter suffixes, starting at “a” (90a, 91a) for the lowest elevation angle and increasing with elevation angle to “j” (90j, 91j being emitted at close to a 90 degree elevation angle). The rays 90 which are emitted in the forward direction 149 are refracted at the “front half” surface 63fh of the secondary lens 56 but generally continue in the forward direction 149. The rays 91 which are emitted in the backward direction 147 are refracted at the “back half” surface 63bh of the secondary lens 56 and continue toward the vertical reflector 72, where most of the rays 91 reflect off of the reflective surface 72e (a specular reflection) to be re-directed in the forward direction 149.

Because of the geometry, including a limited overall height to the top 30f of the backlight shield and a setback distance SB1+SB2 (for the top edge 30f), plus a reflector 72 height to top edge 72f that is limited by the cover lens 26, some of the backward directed light rays 91 escape without reflection. First considering the vertical reflector 72, FIG. 10A shows that ray 91g just passes over the top edge 72f in the backward direction 147 where light is to be minimized. Ideally the vertical reflector 72 is adjusted to an optimum setback distance SB1 which is determined by tracing the path of a ray 91a which emerges from the secondary lens 56 just above the openings 71 and 62 in the horizontal reflector 70 and the module cover 58, respectively. The reflector 72 is moved toward the lens 56 and stopped just before the reflected portion of the ray 91a would be intercepted by the lens 56. At this point the reflector 72 can be locked in place (e.g., by tightening the screws 76). The separation “d” between the reflector surface 72e and the side of the secondary lens 56 can also be used to define the reflector setback distance. Although this measurement is more intuitive, it is more difficult to accurately determine due to the curved shape of the lens. Using a reflector setback distance SB1 determined as described should maximize the amount of light that will be reflected in a forward direction 149 (for a given reflector height). For example, ray 91g which just barely passes over the top edge 72f is at a relatively high elevation angle, and it can be seen that moving the reflector 72 to the left (increasing the setback SB1) will allow progressively more light at lower elevation angles to escape, thereby lowering the efficiency of lighting the forward-located (preferential side 136) lighting pattern 150 by effectively “losing” more light to the back-light which falls on the house side 138 of the light source 10.

It can be seen that, like increasing setback distance SB1, reducing the height (to 72f) of the vertical reflector 72 has the same effect in terms of decreasing the portion of LED light output that is reflected. Since the cover lens 26 is curved, the height of the reflector 72f behind an LED 54 is necessarily lower for LEDs that are located further from the center of the line 53 of LEDs. Our design compensates for this by adding a second vertical reflector (reflective surface 30e of backlight shield 30) above the cover lens 26 and shaping it to effectively maintain a constant reflector height (to 30f) for all of the LEDs 54. Referring to FIG. 7, the vertical wall portions 30a-30c of the backlight shield 30 are shown as portion 30a near the center where it is the shortest height to its top edge 30f; and the tall portions on either side are 30a and 30b. FIG. 10A shows that the short portion 30a adds a little bit to the combined reflector height up to 30f, so that it catches and reflects rays like 91g that pass over the vertical reflector top 72f. Because it's not much higher, the ray 91h that just barely passes over the shield top 30f is only slightly higher angled. Since the edge 30f is at a constant height the back angle AB of ray 91h is the angle for all of the light that escapes the fixture 10 as “backlight”.

It should be noted that generally speaking, a backlight shield on a street lighting fixture is not a new concept. They may be given a diffusely reflecting, or even a non-reflecting surface, because the main concern is to shield the back, house side 138 from excessive light levels. Especially in fixtures having a large spread-out light source such as an HID lamp, a specular reflection outside the fixture should be avoided due to glare and hot spots that would occur in many different directions depending upon a light beam's source location (the large source is not controlled by close-in lenses, so it comes out at many different angles).

In our new design the backlight shield concept has been adapted to take advantage of the better-controlled light source (the light hitting our shield 30 is all coming from a very narrow line at a known angle predetermined by the lens design.) Thus glare is much less of a concern for our design. The scope of our invention includes both diffuse and specular reflective surfaces 30e on the vertical wall portions of the backlight shield 30. A specular reflection is illustrated and described herein, however it can be seen that a diffuse reflector 30e would produce similar effects but would spread out the reflected rays somewhat, thereby diffusing (defocusing) their contributions to different spots in the lighting pattern 150. Notably, the diffusely reflected rays will not significantly go outside of the pattern boundaries because they are still limited by the top edge 30f of the backlight shield 30 and of the shield ring 28 (which also may have a specular or diffusely reflective surface).

FIG. 10B (a cross-section taken on the line 10B in FIG. 7) illustrates our compensation method applied to light emitted by one of the LEDs 54 located at the end portion 72b of the vertical reflector where it is at its shortest height to 72f. The corresponding backlight shield end portion 30b is at its tallest height to 30f (the shield vertical height being measured between the fixed height, straight top edge 30f and the curved lowest edge 30g located at the top of the cover lens 26). We see that the ray 91f, which reflected off the reflector 72 in FIG. 10A, now passes over the top edge 72f and must be reflected instead by the backlight shield 30, which has been positioned to catch that ray at its bottom edge 30g. As in FIG. 10A, we still see ray 91g being reflected near the top edge 30f while 91h is the first ray to pass over it. All rays at a lower elevation angle than 91f are reflected from the reflector 72 same as anywhere else along the line 53 of LEDs.

It can also be seen that, unlike ray 91f in FIG. 10B, the ray 91g, which in FIG. 10A also just passes the top 72f of reflector 72, does not hit the bottom corner 30g of shield 30. This is because ray 91g is at a higher elevation angle than ray 91f. If the shield 30 was moved to the right (decreasing the shield setback distance SB2) enough to cause ray 91g to hit the bottom corner 30g of the shield 30, then ray 91f would dive underneath the cover portion 30d of the backlight shield and be completely lost, trapped in the covered part of the fixture. That would also happen for all light rays 91 that have elevation angles between those of 91f and 91g. This is why the optimum shield setback distance SB2 is determined where the reflector 72 is at its lowest height as in FIG. 10B.

As a practical matter, the shield setback SB2 may be set to approximate the ideal by using a single distance for all lens variations II-IV, for example using an average value or the maximum value.

With this structural arrangement, most light from the row 53 of LEDs 54 is directed downward 148 and forward 149 (toward the front end 22a, street side 136 of the LED apparatus 10). The light that remains backward directed is “backlight” within a back angle AB, the amount of which is controlled by the combined height of reflector 72 and backlight shield 30 to the shield's top edge 30f. The back angle AB is thus controlled to restrict the area of backlighting to be within the pattern boundaries of the designed-for illumination type (II, III, or IV).

FIG. 10C uses superimposed views of modules with two different secondary lens 56 types to illustrate the point that, if the reflector setback SB1 is determined by the method described above (minimizing the distance d from the side of the secondary lens 56), then SB1 will vary in accordance with the secondary lens 56 being used. Otherwise, the LED module 52 is the same for all types II-IV. For example the lens 56 on left side of FIG. 10C extends laterally to a line C-C which is much farther out than the line B-B established by the lateral extent of lenses 56′. Using the optimum setback for each lens will therefor place the left reflector 72 at the setback distance SB1 from centerline A-A (row 53) to the reflector surface 72e at the line D-D; whereas the right-hand reflector 72′ is at the setback distance SB1′ from centerline A-A (row 53) to the reflector surface 72e′ at the line D′-D′. They are at locations spaced a distance D5 apart, which is probably close to equal the difference D6 between the lens sides.

In addition, since the backlight shield setback SB2 is relative to the reflector 72 position at a setback SB1, there may be correspondingly different backlight shields 30 used.

Although the reflector setback SB1 optimum distance may be different for different lenses 56, the vertical reflector 72 can be given a single fixed location SB1 for the sake of manufacturing convenience and efficiency (e.g., by locating a through-hole instead of an adjustment slot in the bracket 72g which is held by module assembly fastener 76 (compare FIG. 4 to FIG. 5). This would mean that, aside from changing the secondary lenses 56, only one set of parts, including vertical reflector 72 and backlight shield 30, and only one part positioning setting, could be used for any of the type II-IV LED lighting apparatus' 10 (although it may be desirable to use different horizontal reflectors 70 as described hereinabove).

For example, to accomplish this, the fixed reflector setback SB1 may be an average of the setback SB1 values determined for a range of lens types; and there may be a single shield 30 which has been optimized to provide the most benefit to the most-used secondary lens 56 types.

Other criteria may be used for determining the setback distances SB1 and SB2. For example, the vertical reflector 72 may be positioned/shaped/angled to produce a particular pattern of light intensity 150 on the ground plane below.

Secondary Lens Design for Reflector Optics

Type II-IV distributions require most of the light to be projected on the front side 136 of the LED lighting apparatus 10 on a pole 122. The present design uses a back reflector to reflect nearly half of the emitted LED light forward. As detailed above, the position of our back reflector (72 and 30) is optimized to maximize reflection of near vertical rays (e.g., 91a-91g) but not too close as to have rays reflect back into the secondary lens (e.g., ray 91a which just meets this criterion).

By adding a vertical back reflector 72 (and 30) to an LED and secondary lens, we are able to make the present LED lighting apparatus embodiment 10, which produces a desired asymmetric light distribution pattern 150, while using symmetrical freeform secondary lens shapes 63 which are much less complicated than asymmetric freeform lenses. In particular, the lens 63 has two-axis orthogonal symmetry, meaning that any quadrant is perpendicularly reflected across the x-z and also the y-z planes of the orthogonal x-y-z coordinate system. (This kind of symmetry is a subset of 180 degree rotational symmetry about the z-axis.) As a result of this symmetry, which is matched by the symmetry of the (square) extended area LED light source, our lens shape is repeated in every x-y quadrant and therefor the entire secondary lens is designed by copying the design process performed for all of the light from the source that passes through just one quarter (one quadrant) of the lens' surface 63. (Every quadrant is repeated in an adjacent quadrant by being reflected across the x-z plane or y-z plane that lies between them. This also means that diagonally-opposed quadrants are “repeated” by simply rotating 180 degrees around the z-axis.)

Prior art typically uses an array of asymmetrical lenses to direct most of the light forward, and/or may add a short shield or reflector behind or around each LED to assist. It must be short to avoid blocking light from other LEDs in their array. Our back (vertical) reflector 72 is much taller so that it can re-direct light forward by reflection instead of by asymmetric refraction. An asymmetrical distribution could also be formed with multiple rows of LEDs with symmetrical lenses, but the tall mirror (back reflector) from one row would block light from an adjacent row unless the rows were widely spaced apart, yielding a larger fixture.

Referring again to FIG. 10A, we can see how this is accomplished.

The center z-axis of the LED 54 (and secondary lens 56) is shown in the center of the drawing, and as described hereinabove (see FIG. 7A and description) we have defined the local rectangular coordinate system such that the base plane at z=0 is coplanar with the LED emitter 86 and the origin (0, 0, 0) is at the center of it. The x-axis (not labeled in this figure) is co-linear (describes the same line) with the line 53 of LEDs which is defined to be parallel to the vertically extending planes of the reflective surfaces 72e and 30e. If we align the z-axis with the straight-downward direction 148, then it will equate to an orthogonal Z-axis of the ground plane of the illuminance pattern 150, wherein we define the X-axis in the ground plane (or pattern 150) as extending lengthwise of the pattern and the Y-axis thereof as extending widthwise of the pattern. Finally, by convention we align the LED x-axis with the pattern X-axis, and the LED y-axis with the pattern Y-axis. This means that the y-axis is parallel to the (widthwise) backward-forward line 147-149, and we define the y distances from the origin in the LED to increase positively in the forward direction 149, and decrease negatively in the backward direction 147.

The forward directed rays 90a-90f proceed from the front half surface 63fh in various elevation angle directions as determined by the shape (surface contour) of the secondary lens body 63 and will strike the ground plane at the same angles to form an illuminance pattern 150 determined by the density of rays 90 striking each unit area. The pattern along a single widthwise line is illustrated on the two 147-149 widthwise lines where the density in one dimension shows as relative spacing of the points where the rays intersect the lines. Ray 90a intersects the lower line at point 90a indicated by a circle. The ray 90b intersection is a square, 90c a triangle, and 90d a diamond. On the upper line rays 90e and 90f intersect at a filled diamond and a filled square, respectively. The horizontal spacing of these intersection points as illustrated is non-uniform and therefore represents a non-uniform distribution of light intensity (illuminance, brightness) in the pattern along that line. (This pattern of intensity distribution is according to the arbitrary lens shape 63 used in the drawing to illustrate general concepts. A properly shaped secondary lens 56 will most likely produce a uniform distribution.)

The rearward directed rays 91a-91f proceed from the back half lens surface 63bh in various elevation angle directions as determined by the shape (surface contour) of the secondary lens body 63, are reflected by the specular reflective surface 72e to the same elevation angle but headed in the forward direction 149, and will strike the ground plane at the same angles with an illuminance pattern determined by the density of rays 91 striking each unit area. The pattern along a single line is illustrated on the two 147-149 widthwise lines where the density shows as relative spacing of the points where the rays intersect the lines. Ray 91a intersects the lower line at point 91a indicated by a circle. The ray 91b intersection is a square, 91c a triangle, and 91d a diamond. On the upper line rays 91e and 91f intersect at a filled diamond and a filled square, respectively.

Since the drawing illustrates rays leaving the center point of the emitter 86 at the same elevation angles for the front half rays 90 and back half rays 91, and further given that the lens 56 is shown as being orthogonally symmetric (i.e., a minor image) across the central x-z plane, then simple trigonometry dictates that each of the rearward directed rays 91a-91f leaving the surface 63bh will likewise be minor images of the corresponding forward directed rays 90a-90f, until the rays 91 hit the reflector surface 72e. Furthermore, assuming a perfect specular surface reflection at 72e, then the rays 91a-91f after reflection will be forward-directed and parallel to their corresponding forward-directed rays 90a-90f. This fact is illustrated by the horizontal intersection points wherein it can be seen that each 90 ray intersection is the same distance forward from its corresponding reflected 91 ray intersection (distance between circles=distance between squares=distance between triangles=etc. to . . . =distance between filled squares.) The trigonometry also dictates that this constant front ray 90-to-reflected-back-ray 91 horizontal spacing is equal to twice the reflector setback distance SB1. This means that whatever widthwise illuminance pattern is created on the ground plane X-Y by the front rays 90 emanating from the lens front half surface 63fh, will be replicated by the reflected back rays 91 emanating from the lens back half surface 63bh but shifted widthwise backward (147) on the ground by a distance of two times the reflector setback SB1. Since the magnitude of the setback SB1 is around 20 mm compared to a typical pattern width W of at least 17,500 mm (pole height PH=10 meters), the overlapping shift of the two equal light intensity patterns will be imperceptible, and will even help by slightly smoothing out intensity changes in the combined light distribution pattern 150.

It can be seen that the same principles apply to the effect on the pattern 150 due to row 53 of lengthwise (x) spaced-apart LEDs with secondary lenses 56. For example, a row of nine lenses spaced 25 mm on center will have one centered pattern extending +/−(L/2) distance from a lengthwise pattern center X=0, overlapped by 4 duplicated patterns in each +/−lengthwise (X) direction, and each overlapping pattern will be shifted 25 mm on the ground relative to the pattern that it overlaps. The cumulative effect is that the overall combined illuminance pattern 150 will be extended in length by 4×25=100 mm on each lengthwise end to make the pattern length=L+2×100 mm. Given that the Type II-IV patterns are all specified to have 6 PH length, then for a 10 m pole height PH, the overall pattern length will in effect be uniformly stretched from 60,000 mm to 60,200 mm long. Again the effect will not be perceptible other than a small amount of smoothing of light intensity transitions.

Finally, since the back half body shape 63bh and front half body shape 63fh of the secondary lenses 56 are orthogonally symmetric across the x-z plane (i.e., front to back), then whatever shape the lens front surface 63fh is given as it wraps around (into the page) from the y-z plane (of the paper), will be mirrored for the lens back surface 63bh. Furthermore, since we also make our secondary lens 56 orthogonally symmetric across the y-z plane (e.g., into, versus out-of the plane of the page) then if we designate the x direction into the page as “to the right”, then the “left” half of the lens surface 63 will be a lengthwise mirror image of the right half. Due to our symmetry then, a “front side” ray 90 having any azimuth angle in the “front” 180 degree range will have a corresponding back-to-front mirrored and forward-reflected “back-side” ray 91 that is parallel and offset widthwise by a fixed distance of twice the reflector setback distance SB1. Since the rays 90 and reflected-91 are parallel, their horizontal separation distance will be constant for any plane normal to the z-axis, regardless of z-value distance (i.e., height above the ground), even though the length L and width W of the pattern 150 on the ground increases as the height increases. In other words, comparing ray 90e to ray 90f we can easily see that they radiate at different forward angles A (noting that the angle A(e) is illustrated and angle A(f) for ray 90f is obviously a smaller angle). This means that the two rays are diverging as can be seen by comparing the separation of their intersections with the lower horizontal line 147-149 versus the separation of their intersections with the upper horizontal line.

Consider a rectangular target portion of a Type II-IV lighting pattern 150 (see FIG. 1), which has a horizontal rectangular target area of width W and length L (measured along an X-axis and a Y-axis, respectively, of the pattern), wherein the target is offset entirely in the positive Y (widthwise) direction from a vertical Z-axis of the pattern that extends in the straight upward direction 146 (straight downward direction 148) from the center of a light source (e.g., LED 54 with secondary lens 56) in the lighting apparatus 10 mounted on a pole 122. For prior art lighting apparatus that does not use a vertical reflector (such as our reflector 72), the LED lens must be orthogonally asymmetric across the x-Z plane at y=zero. For example, if the LED z-axis is directed straight downward 148, then the lens front half body 63fh may direct the front rays 90 to desired locations in the offset pattern target area, but the back half body 63bh must be shaped radically different in order to refract even a portion of the LED's back rays 91 to a forward direction 149. Alternatively, the base plane 81 of the LED(s) can be tilted relative to the pattern Z-axis in order to direct its z-axis forward into the target area 150. In this case, if a front-back symmetric lens is used, then the distance traveled from LED to the target (rho in polar coordinates) by each forward directed front ray 90 will be greater than that of a corresponding back ray 91. Because of this asymmetric widthwise variation of distances (rho), the front rays 90 will be more spread apart along the target Y direction than their corresponding back rays 91, thereby creating a non-uniform light intensity distribution pattern 150 wherein the intensity is greatest at the near edge 152-152 (e.g., Y=−W/2), and least at the far edge 151-151 (e.g., Y=+W/2). To correct this, the rear half of the lens must be given a different shape 63bh than for the front half 63fh, again making the secondary lens orthogonally asymmetric front to back (across the x-z plane) even though it could be orthogonally symmetric lengthwise (across the y-z plane).

So it can be seen that our LED light source module 52 which includes a vertical back reflector 72 enables us to use a single row of one or more LEDs 54 covered by secondary lenses 56, each of which has two-axis (x and y) orthogonal symmetry and a center vertical axis z which is aimed straight downward 148 to the widthwise back edge 152-152 of an illuminance pattern 150; and even though the pattern is specified to be offset to a preferential side (front 136) of the lens covered LED(s) 54 in the light source module 52, we attain a high degree of uniformity in illuminance (light intensity, brightness) throughout the offset pattern area.

Conclusions Regarding Reflector Use

According to the present embodiment, a benefit is achieved from a single row 53 of LEDs 54. It is enabled by the unique design of the free form optics of the secondary lenses 56 to allow tight spacing and the use of the single back reflector 72 (and 30) separate from the lens 56 but still placed relatively close to the lens for efficiently redirecting the backlight forward.

Another benefit of the present embodiment of a single row of LEDs 54, as compared to LEDs in multiple rows, is that it allows for a more compact fixture 10 because multiple rows would need to be spaced quite far apart to assure that one row's reflector did not impede the light path of another row.

In an embodiment, the benefit of additional efficiency is provided by extending the vertical plane of the single back reflector 72 outside of the cover lens 26, using a backlight shield 30 having a reflective vertical front surface 30e. The cover lens thickness is compensated by setting back the backlight shield 30 relative to the back reflector 72. Thus even a simple but strong convex domed cover lens 26 can be accommodated and still provide a straight-line edge at a fixed back angle AB for a controlled amount of backlight on the ground toward the house side 138 of fixture 10. As shown in FIG. 7, the backlight shield 30 has a concave section which fits over the convex cover lens 26. The center 30a of the backlight shield has the least height to the top edge 30f and a progressively higher portion in sections 30b and 30c to either side. This shape corresponds to the vertical reflector 72 where the convex upper edge 72f is the highest at the center and decreases toward the end sections 72a, 72b. Thus the shorter parts of the vertical reflector 72 are continued by the correspondingly taller end portions 30b and 30c of the backlight shield 30.

Type II-IV distributions require most of the light to be projected on the front side 136 of the LED lighting apparatus 10 on a pole 122. The present design uses a back reflector to reflect nearly half of the emitted LED light forward. The position of this back reflector is chosen to maximize reflection of near vertical rays, but not too close as to have rays reflect back into the secondary lens (see ray 91a which just meets this criterion).

By adding a vertical back reflector 72 (and 30) to an LED and secondary lens, we are able to make the present LED lighting apparatus embodiment 10, which produces a specified offset light distribution pattern 150 with a high degree of illuminance uniformity, while using symmetrical freeform secondary lens shapes 63 which are much less complicated than asymmetric freeform lenses. In an optimized embodiment, the lens 63 has two-axis orthogonal symmetry, meaning that any lens quadrant is perpendicularly reflected across both the x-z and the y-z planes of the orthogonal x-y-z coordinate system. As a result, our lens shape is repeated in every x-y quadrant and only needs to be designed for the light passing through one quarter of the lens' surface 63.

Prior art typically uses an array of asymmetrical lenses to direct most of the light forward, and/or may add a short shield or reflector behind or around each individual LED to assist. It must be short to avoid blocking light from other LEDs in their array, whereas our back (vertical) reflector 72 used with symmetric lenses 56 can be (and is) much taller so that it can re-direct light forward while minimizing back light and lost light.

Optical Design of Lenses

The above description has been mainly concerned with LED apparatus 10 embodiments having an LED module 52 with a single row 53 of LEDs 54. As mentioned, this is optimized for providing light distributions according to IES Types II-IV (2, 3, and 4). The Type V embodiment(s) of the apparatus 10 and LED module 52 are disclosed in more detail in the following description.

There are several papers describing creating free form lenses for LED illumination optics, but they are all based on calculations that treat the LED emitter primarily as a point source, and furthermore the design calculations are simplified by striving to create generally round (circle or oval) light distributions (illuminance patterns 150). Their designs may be adjusted to try for a more uniform distribution of light intensity within the overall pattern.

In contrast, the secondary lens 56 designs disclosed herein are based on calculations that use light emitted from the entire two dimensional emitting surface 86 of a high power, and therefor large LED (e.g., 3 mm square), i.e., an “extended source”. Among other advantages, this design method produces more efficient and effective lenses, thereby enabling production of lenses small enough so that only one row 53 is necessary to create the desired illuminance pattern.

Our calculations are made possible by the shape of the secondary lens 56 (profile of its refracting outer surface 63) that exhibits “two-fold (180 degree) rotational symmetry about a z-axis”. This means that a circumferential profile (taken at a constant z-value/height while varying azimuth angle) will repeat the radius value every 180 degrees around (two-fold). This is true for each z-value, therefore a vertical profile (a line at constant azimuth angle and varying height) will also repeat. Although this is like a “mirror image” of each single point perpendicularly across the z-axis line, or even a mirror of each vertical profile, it is not necessarily the same as a “mirror image” perpendicularly across a plane including the z-axis. That is a different kind of symmetry, i.e., “orthogonal symmetry”. The 3-D surface 63 of our secondary lens 56 exhibits both two-fold rotational symmetry and two-axis orthogonal symmetry about the z axis (i.e., mirrored across two orthogonal planes containing the z axis: the x-z plane and the y-z plane). In fact, having two-axis orthogonal symmetry means that a shape will also have two-fold rotational symmetry.

The two-axis orthogonal symmetry of our lenses is uniquely advantageous because it means that the secondary lens 56 has four quadrants (or 90 degree sectors) bounded by the two orthogonal planes, and the quadrants replicate each other in a symmetric, and thus simple known way. Each quadrant (e.g., Q1 of quadrants sequentially labeled Q1, Q2, Q3, Q4) is exactly the same as the 180 degree diagonally opposite quadrant (e.g., Q3), and is a minor image across the plane separating it from the adjacent two quadrants (e.g., Q2 and Q4). Or a more useful consideration is that any “first” point on a quadrant's surface is a duplicate of a “second” point on any of the other quadrants' surfaces 63 providing that the second point is located the same number of azimuth degrees from the same boundary plane (x-z or y-z) as the first point. By “duplicate” I mean having the same elevation angle and distance (spherical radius) from the origin. Furthermore, the surface contour for “movement” in any direction away from the first point is duplicated for the same movement relative to the duplicate point. This in turn means that any line (e.g., a light ray) passing from a first source point through the surface at the first surface point will have the same angle of approach to the point (measured with respect to the surrounding surface) as a ray passing from a second source point through the surface at the second surface point, providing that the second source point is located the same number of azimuth degrees from the same boundary plane (x-z or y-z) as the first source point (and is also constrained to the same elevation angle and radius). Since the square LED emitter surface exhibits the same symmetries as the lens body/surface 63, given alignment to the same x-y-z axes centered on the same origin, then ray tracing done from all points of the emitter surface through a matrix of first points covering the outer surface of one of the quadrants will provide all of the information needed to determine the entire illuminance pattern produced by the full lens. (Because the rays passing through the three “duplicate second points” in the remaining three quadrants will pass through in the same way relative to the surface point.)

Background Regarding Illuminance Patterns

The IES types II-IV patterns are asymmetrical relative to the center of the lens 56 and LED 54, i.e., mostly on the street side 136, but ignoring the permitted backlighting, the pattern 150 is a symmetrical rectangle, albeit offset to one side.

Referring to FIG. 1, the IES Types of illuminance patterns 150 for a luminaire (lighting apparatus) on a pole 122 are listed below, dimensioned in units of pole height PH, wherein forward/backward directions 149/147 respectively are relative to standing with back to the pole 122. (Note: by convention, the term “pole height” is used for the measurement unit “PH”, even though the distance that it represents is actually understood to be the perpendicular height above ground of the light source within the fixture.) The pattern dimensions are listed as L×W (length by width). First number is extent (length L, e.g., along a street) from left end to right end (L equals 2 times the +/− number shown). The second number is extent perpendicular to the length (width W, e.g., laterally across the street), measured from the farthest front 136 edge (farthest in forward direction 149) to the back 136 edge (farthest in backward direction 147, which may be placed behind the pole, depending upon the lighting purpose). Plus/minus are relative to center of pattern 150. For types II-IV the pole 122 is generally at the center of the length L, and near the back edge of the width W. Type V is used for large area lighting (e.g., parking lot), generally with the pole being approximately at the center of the pattern, i.e., at center (zero) of +/−L/2 and of +/−W/2. Even more generally, given that a pole may not be used (e.g., ceiling mount), the center of the type V lighting pattern is ideally defined as being directly below the center of the light source (LEDs 54) in the lighting apparatus 10, which is therefore aimed straight downward 148, normal to the ground plane and thus to the illuminance pattern 150.

IES Illuminance Pattern Definitions (L×W Dimensions):
II=(+/−3)×1.75=6:1.75=most rectangular pattern˜2 lane wide road with pole on one side.—the most sales are for this
III=(+/−3)×2.75=6:2.75=extends farther forward˜more than two lanes
IV=(+/−3)×4.00=6:4.00=extends farthest forward (to go across the most lanes)
V=(+/−4)×(+/−4)=8:8=square pattern, goes back as well as forward, covers much greater surface area (2.67 times as much as type IV)˜parking lots—second most sales

The type V distribution is much more extensive in area (L×W) and also is not limited to a forward 149 direction, rather it is generally expected to extend the same distance (W/2) backward 147 as forward 149, therefor the luminaire 10 does not need a backlight shield 30, a vertical reflector 72, or asymmetric lens optics. For a variety of reasons, including efficiency and cost reductions in many different areas of production, distribution, marketing, sales, and performance; we have designed our LED lighting apparatus 10 for universal application to a widest possible range of lighting levels and luminance types (especially in the range of type II to type V), and such that a minimum number of parts and other changes are sufficient to switch from production of one luminaire embodiment 10 to any other one of the luminaire embodiments 10.

Referring to FIGS. 12A and 12C, it may be noticed that, for the type II-IV secondary lenses 56 made according to the present invention, the shaped part of the secondary lenses 56, i.e., the lens bodies 63, have overall length-to-width ratios (L1:W1) that roughly correspond to a ratio of (L:2W) in terms of the illuminance pattern dimensions. This is equivalent to L/W=L1/(½W1), i.e., half the lens width W1 lights the whole width W of the target pattern. Also referring to FIG. 12F, the half-lens-width factor is due to our use of a vertical reflector (72 and 30—see FIGS. 10A-10B) to “fold” the width-wise lens output such that the light output from the “back” half 63bh of the lens is doubled over on top of output from the “front” half 63fh, to make a pattern 150 that is only half as wide as the theoretical output pattern of the entire lens. This means that our type IV secondary lens body 63 has a width W1 that is greater than its length L1, even though the pattern has a width W that is less than its length L. Similarly, the type III lens body 63 is almost square, even though the lighting pattern is obviously rectangular.

Overall Design Process for Secondary Lenses

Design Assumptions and Parameter Boundaries (Design Constraints)

A typical prior art LED lighting apparatus 10 has used a large number of LEDs arrayed within the fixture in order to supply enough light to cover large areas as in type II-V lighting. Given a distributed light source such as this, groups of, or even individual, LEDs are aimed and/or focused in different directions such that an individual LED is expected to light only a portion of the overall lighting pattern. In this way, the shape of the pattern can be controlled by the aim of individual small beams of light, for instance filling in corners of the rectangular pattern by directing proportionally more LEDs toward the corners versus towards the nearby edges of the pattern.

For the present invention, a newer approach is taken by using recently available very high output LEDs 54 such that a small number of them is sufficient to produce the desired lighting levels (total lumens) and intensity (light/surface area), given other changes in design that are disclosed herein. For example, present design specs can be met with only 4 to 9 LEDs 54 in a fixture 10 according to the present disclosure. This makes smaller and less expensive apparatuses 10 possible. Given this, the present design calls for a compact array of LEDs 54, each one having a secondary lens 56 that will direct the individual LED's light output to fill the entire L×W area 150 as defined by the IES type. Thus the lighting level in the entire area 150 can be adjusted by varying the number of LEDs that are turned on, or the number populated in the LED module 52, without significantly changing the overall shape of the lighting distribution pattern 150. Also, if an individual LED 54 fails in use, the overall light level will decrease proportionally, but the uniformity of illuminance (light intensity) throughout the pattern will not change (no “holes” or sudden dark spots). This also gives more design and manufacturing flexibility because the overall lighting level can also be changed by selecting different power LEDs. It is even possible to achieve a desired lighting level or other performance characteristic by selecting a suitable combination of different LED types. For example, heat sinking may be made easier by using lower power LEDs in the center of an array of higher powered ones. For example, color effects may be achieved by selecting a suitable combination of different color LEDs, which will produce a uniform color mixture in the illuminance pattern because each LED (color) provides its output to the entire lighted area 150.

This sets a self-imposed constraint (boundary condition) on the secondary lens 56 design, such that each lens 56 must be able to direct its corresponding LED's light in a way that fills the entire shape and area of the illuminance pattern 150 as uniformly as possible (uniform light intensity). Thus there is a specific secondary lens design (embodiment) for each of the pattern types (see FIGS. 12A-12C). FIG. 12C shows the relative shape, area, and orientation of each IES pattern type next to an embodiment of the corresponding secondary lens 56. To distinguish the different embodiments of the secondary lens design collectively referenced as “lens 56”, the letters a-d may be added to the reference number as follows: secondary lens 56a references the type II lens embodiment; 56b for type III; 56c for type IV; and 56d for type V.

Our secondary lens 56 design objectives, assumptions, conventions and constraints can be summarized as follows:
1. Light source is a commercially available LED device 54 having an extended area (e.g., 3 mm square) planar emitting surface 86,
2. that is covered by a phosphor coating 88 for color determination (e.g., converting blue LED emission to “white” light), and
3. both 86, 88 are immersed in a hemispherical primary lens 55, preferably with a standardized radius (e.g., 4 mm) and refraction index (e.g., 1.5 for silicone) and having a center (rotational) axis z with the z=0 origin located at the center of the emitting surface and extending perpendicularly therefrom (putting the emitting surface and the hemisphere base in the same x-y plane, i.e., base plane 81).
4. The secondary lens will have:
   a. a cavity (inner surface 82) suitable for allowing the secondary lens to substantially surround the primary lens, preferably close fitting with a minimum air gap therebetween (e.g., a hemispherical cavity with radius slightly greater than the primary lens), although the cavity shape may be changed for design purposes,
   b. means (80, 84, 84a, 65) for accurately positioning the secondary lens relative to the squared sides of the emitter 86 (e.g., alignment pegs 80, recess 84, straight sides 84a); and relative to the primary lens 55, coaxially aligning the center axis z of each (alignment pegs 80, recess 84), and making the two lens' x-y bases co-planar, i.e., having the same base plane 81 about a common origin at x=y=z=0 (e.g., using leveling bosses 65),
   c. a suitable refractive index preferably different than the primary lens, and
   d. a freeform outer surface shape.
5. Freeform shape is designed to:
   a. re-direct the light output of each LED 54 into a Type II-V* rectangular “target” pattern 150 under IES standard conditions**, where the relative distance PH is suitable for street and large area lighting, i.e., PH is at least 200 times greater than any dimension of the secondary lens***
   b. achieve a high luminance uniformity throughout the target area; and
   c. achieve a high system efficiency (ratio of total lighting power that is input into the target area, divided by the total lighting power output of the LED(s) in all directions)

Notes:
*Types II-V rectangular target patterns respectively have an L:W aspect ratio of 6:1.75, of 6:2.75, of 6:4.00, and of 8:8 (in units of PH)
**The LED's central axis z is directed at the center of the pattern length L, and somewhere along the width W. (z from center of line or array of LEDs).
   for type V, which is a square pattern centered about the z-axis (straight-down from center of LED array) the z axis is directed normal to the pattern 150 (straight down) and intersecting at the L by W center.
   for types II-IV, the z-axis is directed normal to the pattern 150 at the closest edge of the pattern width W, i.e., at width=0 and length=L/2. Since the closest edge of the pattern 150 is generally located approximately at the street edge (or curb) and the LEDs in the fixture 10 are on an arm 124 that extends forward (149) from a pole 122 that is set back (147) from the edge, the z-axis is substantially oriented straight downward (148) to the pattern edge on the ground, which is therefor at a relative distance of z=1 PH unit away from the light source (i.e., LED emitter surface 86) We can do this with a symmetrical lens because of our novel minor optics design (i.e., vertical reflector 72 etc.)

Note that prior art had to aim the module z axis outward into the pattern in order to use the backward directed light. They also made asym lenses and added little minors right at the LEDs, but those don't work as well.
*** A typical pole height PH being 10 meters (10,000 mm), and a secondary lens smaller than 50 mm in length or width calculates to PH being at least 200 times the max lens dimension (10 k=200×50).

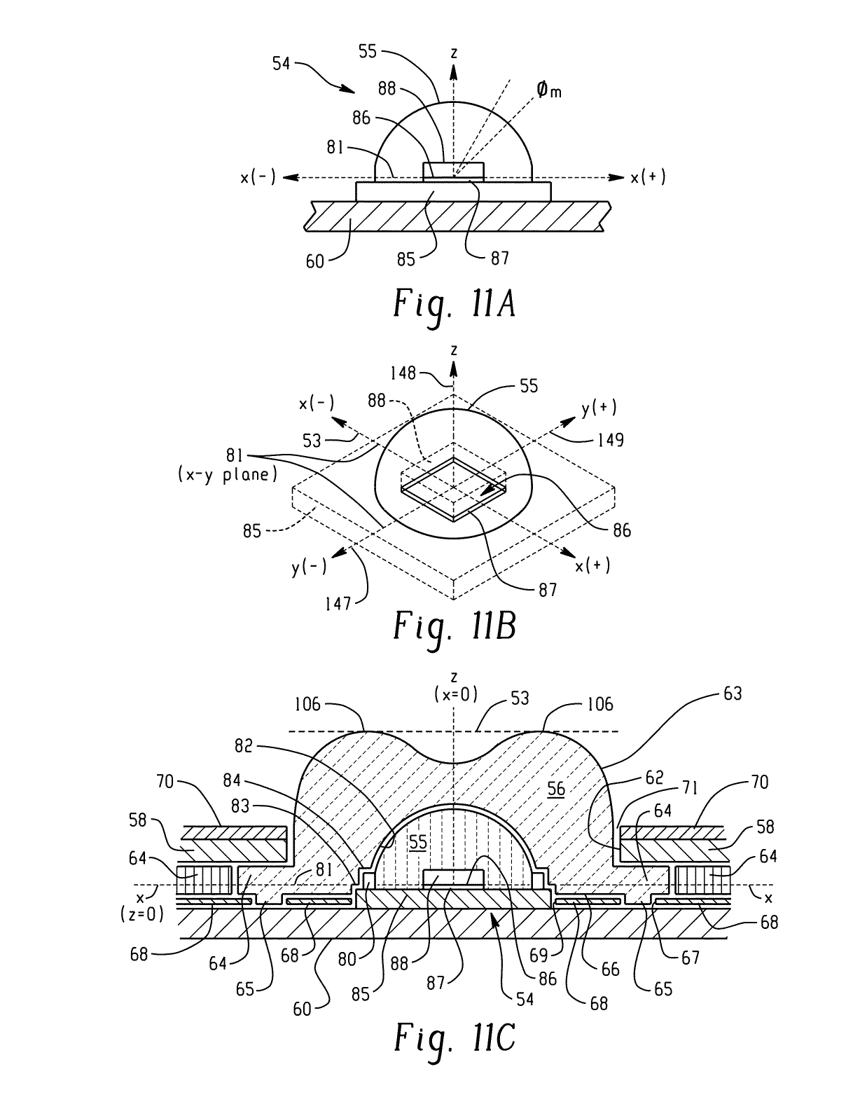

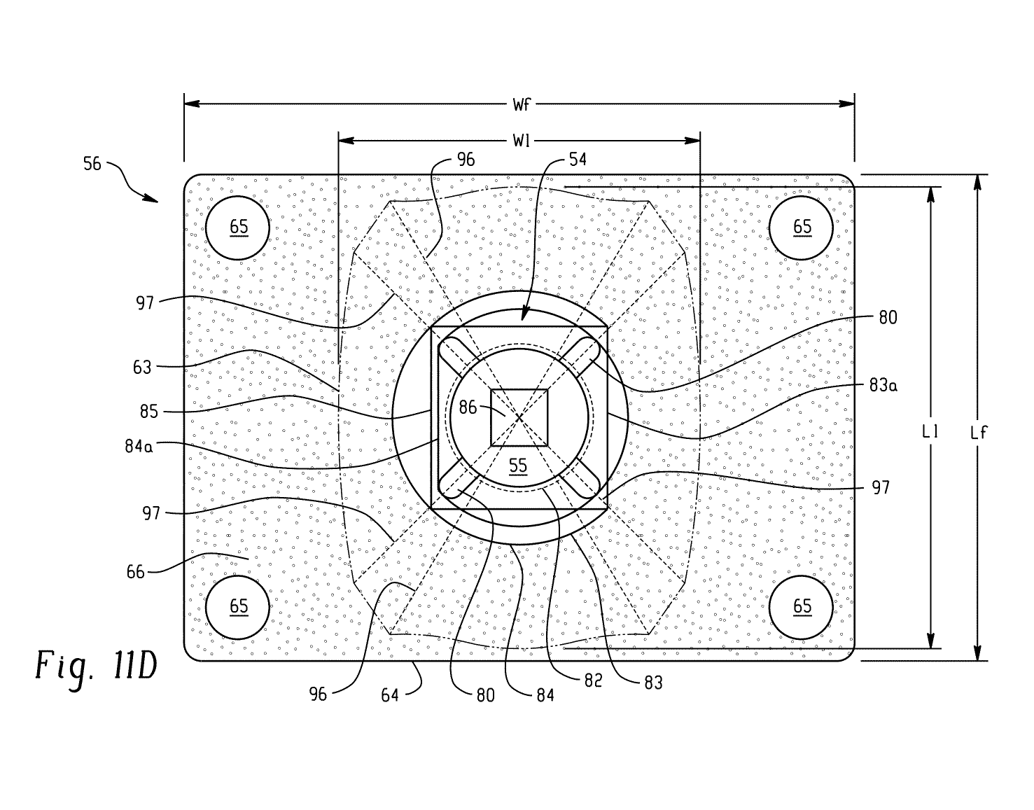

Either here or elsewhere in this disclosure, the means for achieving the stated objective(s) will be made clear by the description. The LED 54 is shown in detail along with the lens 56 alignment and positioning means in FIGS. 7, 7A-7C, 11A, and 11B.

It must be noted that even with an azimuthally symmetric primary lens shape (the hemisphere is the same at any angle of rotation around the z axis), the 3 mm square noncircular extended area emitter will produce a light output that varies with azimuth angle rather than being constant as from a point source, and also that varies with elevation angle much differently than light from a point source (which is constant versus elevation angle) or even light from a relatively smaller emitting surface such as the 1 mm square emitter used in recently published theoretical work (discussed below). Therefor, compared to theoretical calculated “test” results of a lens that was designed assuming a small or single-point light source, actual physical test measurements with a 3 mm square emitter LED will show a decreased efficiency in gathering LED light into the target pattern 150 and also decreased illuminance uniformity over the area of the target pattern. (The term efficiency is used loosely here to mean the ratio of total light energy received within the target area 150 divided by the total light energy of the LED device 54 that is output in all directions from the primary lens of the LED.)

Because of this, an objective of the hereindisclosed lens design method(s) is to adjust the secondary lens 56 shape in a way that reduces, if not eliminates, the losses in efficiency and uniformity caused by ignoring the noncircular extended area LED light source. Also, the shape determination procedure must be practical (not requiring an inordinate amount of work and a supercomputer); the resulting lens must be manufacturable at reasonable cost, and assembly of the module with LED and properly positioned lens must be achievable by manual labor or uncomplicated manufacturing equipment, preferably suitable for large to relatively small production runs at low cost.

Accurately Positioning the Secondary Lens

The FIGS. 7A-7C and 11A-11B illustrate the simple but effective means for accurately positioning the secondary lens 56. The LED device 54 comes preassembled on a square planar ceramic substrate 85 with solder pads on the back so that it can be solidly affixed by soldering to the PCB 60. The emitter surface 86 on the die 87 is mounted in parallel alignment with the plane of the substrate 85, and thus to the PCB 60. The primary lens is formed over and around the phosphor 88 covered emitter 86 such that its base (at equator of hemisphere) is coplanar with the x-y plane of the emitter, and also such that the z axis meets the conditions stated above.

FIG. 7C is a plan view of an LED 54 covered by a secondary lens 56. The primary and secondary lenses are illustrated as being transparent, revealing the secondary lens' roughened underside 66 which is represented by a diagonal mesh shading pattern. Although not in cross section, the various parts of the LED 54 are distinguished from each other by contrasting types of shading. Even the “air space” between the secondary lens inside surface 82 and the primary lens 55 periphery is shaded.

In the present embodiment of the preassembled LED device 54 the primary lens 55 is surrounded by a dam that has rounded lobes (alignment pegs 80) diagonally adjacent to the corners 89 of the emitter surface 86 (and die 87). They are uniformly rounded and equidistant from the respective corners so that a straightedge placed against any two of them will be aligned with a side of the square emitter 86. The secondary lens 56 has an alignment recess 84 cut into its underside. It can be circular with a radius around the z axis that closely fits around the outside of all four alignment pegs 80 (as seen at the bottom and top of FIG. 7C) and that will make the primary and secondary lens z-axes be co-linear, providing that the bases are co-planar (i.e., orthogonal to the z axis). The latter is assured by making the recess 84 deep enough to provide a little clearance above the peg top surfaces to allow secondary lens leveling to be done exclusively by the leveling bosses 65 that will rest directly on the PCB (passing through holes 67 in the PCB reflector 68) such that the secondary lens and primary lens x-y plane bases will be co-planar at z=0.

Next, to “clock” the secondary lens x-y (L-W) directions to match the LED'S x-y directions, at least one portion of the circular recess 84 can be interrupted by a chord making a straight side 84a to align against two of the pegs 80. Optionally the entire recess can be square as shown in FIG. 7B, but that may be more difficult to shape and/or mold. Finally the height/thickness of the substrate 85 may be accommodated by a second larger diameter recess 83, also optionally with at least one straight side 83a. Again we leave some clearance depth in the recess, and optionally extra diameter so that the lens orientation relies on only one component of the LED, the alignment pegs 80. In another embodiment of the LED 54 there may not be alignment pegs 80, in which case the same method of alignment can be practiced using other features of the LED device 54 assembly that are intentionally aligned with the emitter surface 86, such as the square substrate 85. In this example, the second recess 83 will be shaped and dimensioned to align the secondary lens 56 with at least one side edge of the substrate 85, e.g., using a precisely positioned straight side 83a.

Other lens design decisions are distinct to two categories of secondary lens types:

For Types II-IV:

Rather than using a multi-row array of LEDs, each with an individual secondary lens and/or shields or reflectors, our approach is to minimize luminaire/fixture 10 size and bulk by designing an LED module 52 with a single row 53 of closely spaced LEDs 54, each with a secondary lens 56 designed to work with a single vertical reflector 72 (and 30) that is close, and parallel, to the back (rearward 147) side of the row 53 of secondary lenses 56. We determined that acceptable lighting could be provided by using a single row 53 of nine or less commercially available LEDs 54. The design objectives for type II-IV illumination are as follows:
The row 53 of LEDs is aligned with the illuminance pattern length L which extends along the street line, therefor the LED and lens spacing will determine a minimum fixture width (orthogonal to the mounting arm 124 and the pole 122 as seen in FIG. 1).
We spaced the LEDs 25 mm OC and used that as a constraint on lens design for types II-IV. This is believed to be a reasonable minimum spacing S given that the lens “length” L is limited by the spacing S.
Each LED/secondary lens combination should produce the entire illuminance pattern 150 according to the specified IES type. Thus they will mostly overlap each other with only about 25 mm offset one to another (see FIGS. 10A-10B and associated description hereinabove), thereby adding to each of the other LED light outputs while smoothing out intensity variations (improving uniformity).
The vertical minor 72 will be parallel to, and on the back side 138 of the line 53 of LEDs. It will be specular and will fold over a backward-directed portion of the LED light output to reflect it forward 149, to approximately double the light intensity within the width W of the specified illuminance pattern, however the width W is half the size of the width that would normally be illuminated by the secondary lens 56 without a reflector.
The center Z-axis of the row 53 of LEDs is directed substantially straight down 148, normal to the lighting pattern 150, and intersects it at the nearest widthwise edge and the lengthwise center (of the rectangular street side 136 target area part of the specified lighting pattern 150), i.e., at x=L/2, y=0 point of width W, and Z=PH.
(this can be accomplished using an orthogonally symmetric secondary lens because of the minor reflection—see FIGS. 10A-10B and associated description hereinabove).
The row 53 of LEDs is best if centered under the cover lens 26 (e.g., centered below the apex 26b of a domed cover lens 26) and should be within the housing opening 22c and surrounding uplight shield ring 28.
Uplight 28 and backlight 30 shields can be used to control marginal effects, especially the amount of backlighting (on house side 138 of fixture)—see FIGS. 10A-10B and associated description hereinabove.
Other efficiency improving aspects of the lens and reflector(s) are described elsewhere.
The secondary lens 56 design will take into account the effects of these considerations.

For Type V:

This will not need a vertical minor or backlight shield, therefor the LEDs 54 and secondary lenses 56 can be laid out in a 2D grid-array, such as 3 rows by 3 columns=9 LEDs. This allows use of a larger lens 56 over LEDs that are spaced further apart. This is desirable because the type V secondary lens must spread the light over the greatest area. Design objectives for type V include:
The array should be centered under the cover lens 26 (e.g., centered below the apex 26b of a domed cover lens 26) and should be within the housing opening 22c and surrounding uplight shield ring 28.
As much as possible use the same parts as are used for the other types. This means that the LED module should be based on a constant size/shape form factor so that it can be mounted in the apparatus 10 on the same mounting platform 44 with no major part changes. The PCB should have traces laid out in a way that either a single line of LEDs at 25 mm spacing or a 3×3 array of LEDs with uniform spacing can be attached and function with minimal switching or other modifications needed. FIGS. 4A and 4B show how this is accomplished simply by placing the LEDs in the desired positions. By using every-other LED position in the single row we end up with a spacing S of 50 mm which becomes the constraint (upper limit) for type V secondary lens size.
FIGS. 6A-6D show stages of assembly of the module parts used by the single row version (types II-IV, reference number instance, or embodiment “a”). FIGS. 6E-6G show the components used: the module cover 58a, the PCB reflector 68a, and the horizontal reflector 70a to assemble with the universal PCB 60 when it is populated for a type II-IV LED module 52 (52a). FIG. 6H is a schematic sketch showing the general shape of all three components 58b, 68b, 70b to assemble with the universal PCB 60 when it is populated to make a type V module 52 (52b). The openings 69b are spaced apart the same as the other two parts represented, but the opening 69b is a smaller size to fit closely around the LED 54, compared to the openings 62b, 71b that would be sized to fit closely around the type V secondary lens 56 (over its flanges 64).
FIG. 5A shows the II-IV module 52a under the light cover 22. The row 53 of LEDs 54 covered by secondary lenses 56 has a center line A-A that is aligned with a diameter line 26c of cover lens 26, thus passing through the cover lens center point 26b (i.e., apex of convex dome shape). Diameter line 26c is parallel to backlight shield 30. The opening 22c of the light cover 22 is partly blocked by a back covering 30d that covers the back portion of cover lens 26 (back of the vertical part 30a,b,c of the backlight shield 30). FIGS. 5B-5E show how the parts go together in a way that can be easily switched for use with a type V LED module 52b as shown in FIGS. 5F-5I. The opening 22c is expanded to full circle by removing the backlight shield 30 including the back covering portion 30d. Although they could be separate, preferably these parts 30 are attached to the uplight shield ring 28 to make an external shield 28a for type II-IV lighting. This is screwed in place from within, therefor it is a simple matter to replace it with an uplight shield 28b for type V lighting. It may be a different height than the shield 28a in order to adjust the horizontal spread of the light. Since the module has the same form factor and means 78 (screws and threaded holes) for attaching to the platform 44, and since the type V LED array is symmetric about the line 53 of II-IV LEDs (see FIGS. 4A-4B), therefore the type V array of LEDs is centered under the peak of the cover lens 26 and within the opening 22c and the uplight shield 28b.
cover lens is less deep (flatter) to avoid extending above ring shield
Since there is no vertical reflector to accommodate in the type V embodiment of the luminaire 10 (10b) the cover lens 26 can be a different shape (26b). For example, given a shorter uplight shield 28b, the type V cover lens 26b can be less convex, or even flat, in order to avoid causing glare.

Other work

Regarding secondary lens design for use with LEDs, it may be noted that some papers published recently by researchers at several Chinese universities disclose calculation methods and resulting theoretical calculated freeform lens shapes for LED light sources. Their work is directed toward using the LED light that, by itself, projects a circular spot (luminance pattern) on a perpendicular plane, and transforming it by lens refraction into a rectangular luminance pattern (target).

In 2008 Yi Ding, et al. published their work on such a lens, with an objective of producing very high uniformity of luminance (light intensity) over the entire target rectangle. They used a simplified transfer function derived from theory and solved simultaneous first order partial differential equations by numerical means. They then “tested” the calculated lens shape by using simulation software. Some very significant parameter differences and system simplifications make their results of limited usefulness for the current application.

By comparison to our list of objectives and constraints, Yi Ding, et al:
1. treated the LED light source as a single point for their lens shape calculations
2. no phosphor coating
3. generally same type of primary lens, but smaller: ˜2.5 or 3 mm radius hemisphere
4. secondary lens:
   a. cavity is not suitable for surrounding the LED. It has a hemispherical inner surface with radius 50 mm centered at z=−45 mm
   b. doesn't consider practical means of accurately positioning sec. lens
   c. refractive index?
   d. has freeform shape
5. The freeform shape:
   a. directs light into a rectangle 80 mm×60 mm at a distance z of only 30 mm, making PH=30 mm [symbol] rectangle is 2.67:2 ratio in PH units, which compared to type IV rectangle of 6:4 PH is a similar ratio, but only 1/4.5=22% of the area; furthermore PH=30 mm=extremely close, and totally out of proportion relative to the size of the LED primary and secondary lenses—Their secondary lens is 40×36×10 mm, greater than their pole height and half of the pattern length! (An embodiment of our type IV lens is 25×22×7 mm, about 60% of their size, for a pole height of 10,000 mm.)
   b. Luminance uniformity 90%
   c. Efficiency 95%

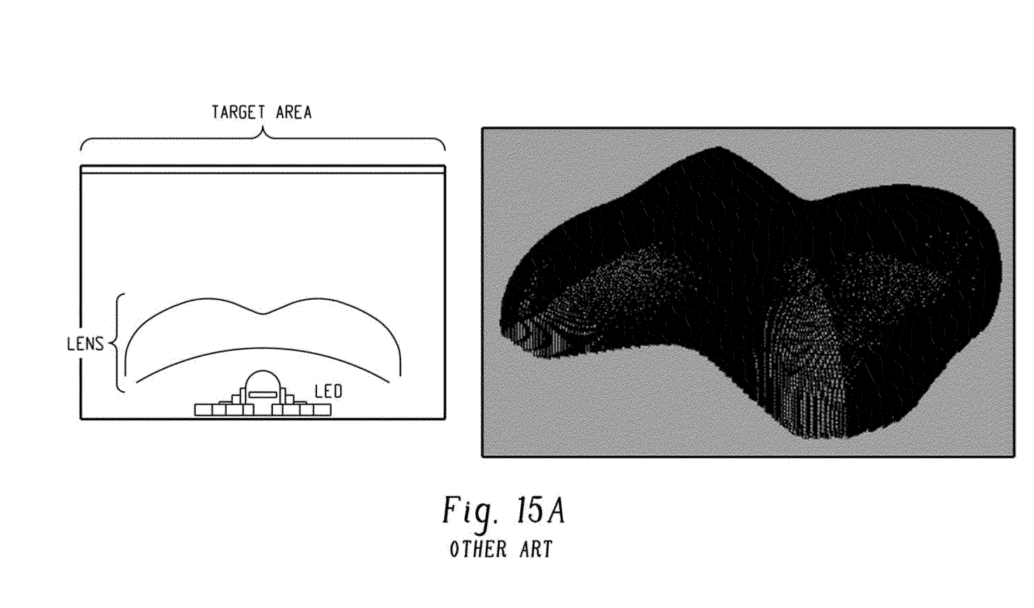

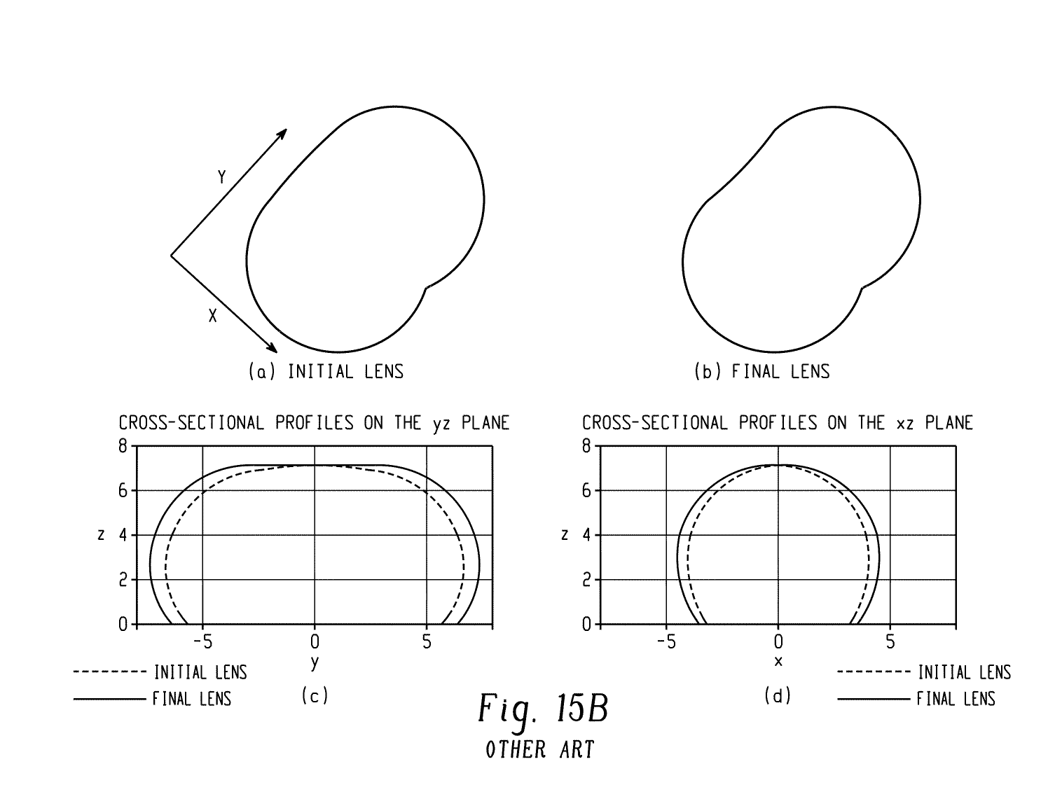

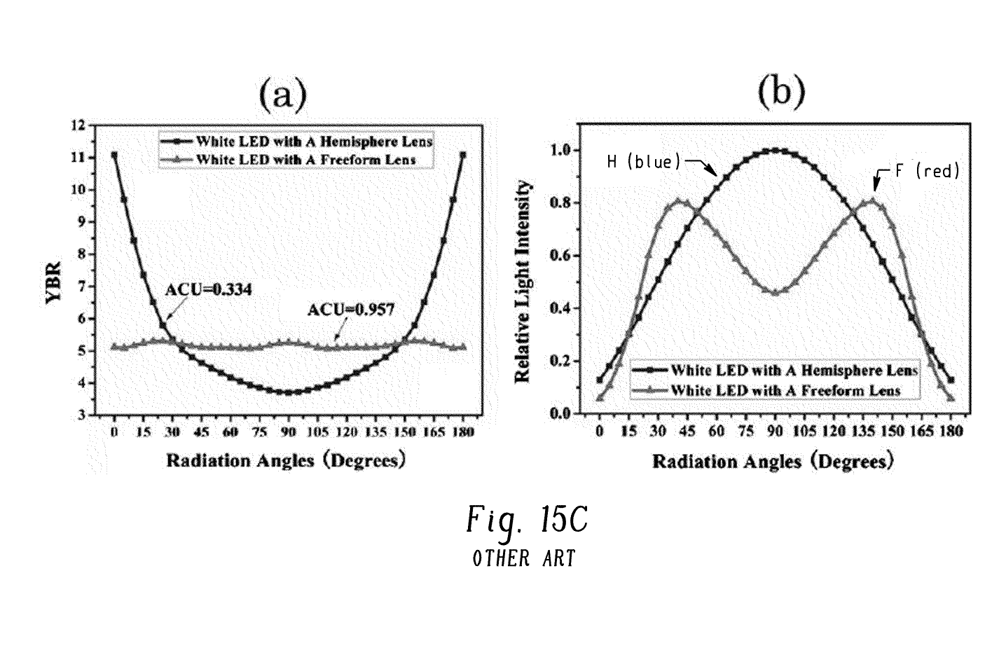

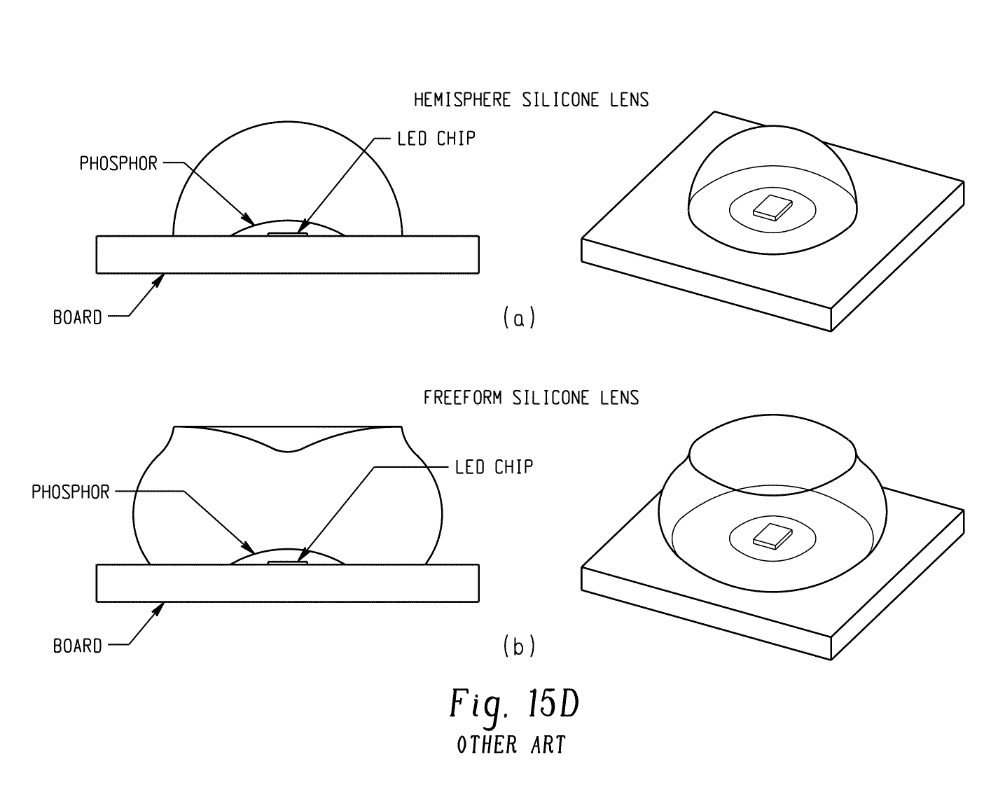

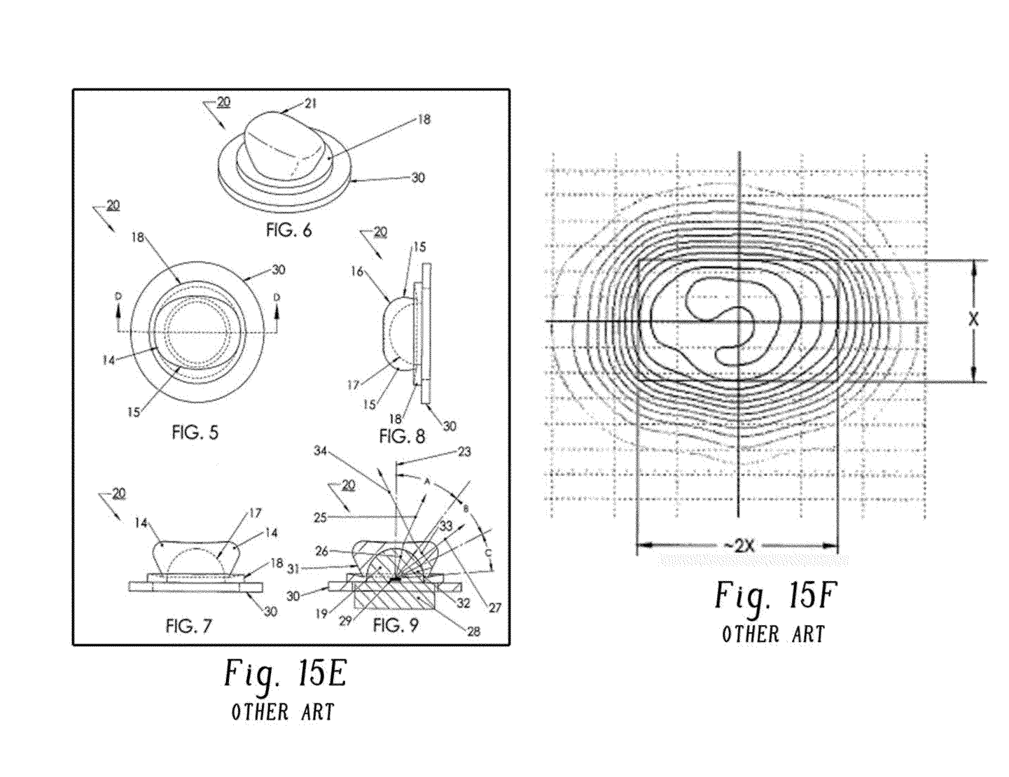

Resultant lens shape (shown here as our Prior Art FIG. 15A) is illustrated but not described, using a computer generated perspective mesh image that is too dark to discern much other than an overall dogbone shape in plan view with periphery shrinking as z height increases. The longer side is necked-in significantly and the shorter ends less so. Overall size is stated to be 40 mm×36 mm×10 mm high. There may be a slight depression in the top surface at the overall center of the shape.

In 2010 Yi Luo, et al. published their work on a “compact and smooth free-form lens”, with an objective of producing very high uniformity of luminance (light intensity) over the entire target rectangle. They used a feedback modification method starting with a lens shape derived from theoretical point source calculations. Using simulation software, they calculated a pattern that would result from a theoretical test using the present lens with a 1 mm “extended source”, compared it to an ideal uniformity pattern in the target area, then applied a feedback equation to modify the lens shape according to the differences (errors) between the two, resulting in a new lens to “test” in the next iteration. The lens shaping method used is a “variable separation mapping method” that requires a known surface shape to start with and then adjusts it to correct for the errors. The process was iterated a number of times. The feedback calculation required upper and lower limits to keep the calculation under control. Some very significant parameter differences and system simplifications make their results of limited usefulness for the current application.

By comparison to our list of objectives and constraints, Yi Luo, et al:
1. used a 1 mm×1 mm LED emitter/source in a 7 mm high freeform lens
2. no phosphor coating
3. freeform lens is the primary lens. LED is immersed in the “secondary” lens.
4. secondary lens:
   a. no cavity or inner surface or transition between primary and secondary lenses
   b. lens is manufactured with accurate positioning relative to immersed LED by default, but manufacturing LEDs with custom formed primary lenses is not practical.
   c. refractive index=1.59 (of the only lens)
   d. has freeform shape (but is undercut)
5. The freeform shape:
   a. directs light into a rectangle 30,000 mm×10,000 mm at a distance z of 10,000 mm=PH [symbol] rectangle is 3:1 ratio in PH units, which compared to type II rectangle of 6:1.75 PH is a similar ratio, but only 1/3.5=28% of the area. This means that refraction angle errors may be magnified relative to ours, but they are not worried about total lighting, only uniformity, which will only be measured in the center 28% of the area that we are using—a much easier goal.
   b. Luminance uniformity improved to 81% in simulated test results after 8 iterations, but could not be further improved by additional iterations.
   c. They state that this design method does not control efficiency. Their test results show that as the lens shape is adjusted to improve uniformity, the efficiency decreases as more light rays are refracted out of the target area.

Referring to our Prior Art FIG. 15B, their final lens shape is illustrated but not described in detail, using a computer generated perspective image that is difficult to discern. It appears to be a slightly squashed truncated circle in vertical cross section at the width-height plane in middle of length (i.e., x-z plane at y=0), with about 20% of the bottom cut off. The y-z plane at x=0 shows the same squashed truncated circle but elongated about 60%. The top center is mostly level for the length of the elongation in y-z plane, but the sides are not straight, gradually necking in as go down the x-z plane. It looks like two overlapping water drops on a very slippery plate. In general this shape appears to be very difficult to manufacture, and their design method is impractical (and untested with physical lenses and a large square LED). The overall dimensions are 14.6×8.9×7 mm, which is somewhat smaller than our lenses.

In addition to the problems noted above, another is the starting lens shape, which was selected with a constraint that it be smoothly curved, without discontinuities which they view as a problem due to causing Fresnel losses. (It will be seen that we take care of that problem in a novel way.) The design process they describe produces only a slight change in outside dimensions of length and width, but no change in height which may have been held constant as a simplification. The selected shape is severely undercut and appears to be impractical to manufacture.

Another deficiency is their use of a 1 mm extended light source with a lens that is comparable in size to ours. This is much smaller than the 3 mm square we need to use for a high output LED—probably proportionally small enough that the corners of the square shape can be ignored without much consequence. There is no indication in their report that they accounted for azimuthal changes in light output from this extended source. It appears that they approximated it as a 1 mm circle. Our design method specifically compensates for the corners as will be seen.

In 2010 Kai Wang, et al. published a paper in Optics Letters about a freeform lens designed to improve color uniformity in the light pattern of a white LED. As noted elsewhere in the present disclosure (with reference to FIG. 11A), this is a known problem caused by use of a thick layer (e.g., 0.5 mm) of conversion phosphor on top of the LED emitter. The LED emits “blue” light and the phosphor converts a portion of the light passing through it to “yellow”. The mixture of un-converted blue light with the yellow light being re-radiated by the phosphor will appear “white” if the mixture has the proper Yellow to Blue Ratio (YBR). Unfortunately, the fraction of the blue light that is converted to yellow increases as the thickness of phosphor passed-through increases. Blue light going straight up (elevation angle 90° will only pass through the thickness of the phosphor layer, so that beam will have the most blue and least yellow, i.e., a minimum value for YBR. As the elevation angle is reduced, the radiation passes through the phosphor at more of an angle which means a longer path through the phosphor, resulting in increasing YBR—more yellow. By the time it gets to 0°, the beam is passing horizontally through the entire width of the phosphor. This is significant because Kai Wang uses an LED having a phosphor layer that extends beyond the edge of the emitter surface.

FIG. 15C shows the YBR plotted versus “radiation angle” which is the spherical elevation angle θ (theta) from 0° (degrees) horizontal to 90° vertical, then continued back down on the diametric “other side” to 180° horizontal. It can be seen that for an LED with only its hemispherical primary lens, the YBR number is high (overbalanced to yellow) up to about 40°, and then levels out to a more blue-ish color (low YBR) at 90°. Kai Wang shows an Angular Color Uniformity (ACU) value of 0.334 for this overall beam pattern, where ACU equals the minimum YBR value divided by the maximum.

Kai Wang's solution is to make his lens surface change abruptly near the 40° elevation angle to create two discontinuous refracting surfaces (facets): a top surface and a side surface separated by a relatively sharp downturned “corner”, like a tuna fish can. This will cause rays passing through the side surface to bend upward, while those passing through the top surface will bend toward the horizontal. Thus the yellowish light will be mixed with the bluish light to create a more uniform “average” color where they overlap.

The light intensity distribution versus angle is also plotted in FIG. 15C, showing a Lambertian curve that concentrates the illumination around 90° in the middle of the pattern. For type II-V lighting distributions we want more light at the edges (low angles) because of the very wide spread that is to be lighted as uniformly as possible, therefor we use a secondary lens that is depressed in the center. Kai Wang also selected this basic lens form for his work so the second light intensity plot (for his freeform lens) shows the desired result—a “batwing” curve.

FIG. 15D illustrates the two different lens shapes. Kai Wang computer “modeled” the two shapes shown and then used a Monte Carlo ray-tracing method to produce the simulation results shown in FIG. 15C. The freeform lens produced a very consistent YBR over all angles, yielding an ACU of 0.957, almost completely uniform (in theory). The discontinuity concept is useful for our work, but Kai Wang's lens model and assumptions are oversimplified and/or inadequate, making the exact shape not very useful for us. In particular, he assumes complete azimuthal uniformity, so his lenses are uniformly rounded and the light pattern is a round circle. Furthermore, his theoretical calculations ignore both the square shape and the extended surface area of the LED emitter. Although he claims to use a 1 mm square LED, his calculations treat it as a point source at the origin, surrounded by 3 mm diameter round, domed cap of phosphor. This is very different from our situation.

By comparison to our list of objectives and constraints, Kai Wang, et al:
1. used a 1 mm×1 mm LED emitter/source in a 3 mm high freeform lens
2. phosphor coating is a 3 mm diameter domed (“spherical”) cap covering and extending beyond the edges of the emitter.
3. freeform lens is the primary lens, so LED is immersed in the “secondary” lens.
4. secondary lens:
   a. no cavity or inner surface or transition between primary and secondary lenses
   b. lens is manufactured with accurate positioning relative to immersed LED by default, but manufacturing LEDs with custom formed primary lenses is not practical.
   c. refractive index=1.50 (of the only lens)
   d. has freeform shape (but is undercut, and only 3 mm high)
5. The freeform shape:
   a. directs light into a circular “far field”, but really turns this into a two dimensional theoretical exercise by calculating results for rays in a plane including the z axis and a single azimuth angle.
   b. Color uniformity improved to 95% in simulated test results. There is no indication of how they arrived at a particular lens shape.
   c. Efficiency is not measured, but the batwing waveform appears to offer advantages.

In U.S. Pat. No. 7,674,018 (Holder et al., Mar. 9, 2010), a lens design for an “LED Device for Wide Beam Generation” is disclosed. With reference to their figures copied into the present FIGS. 15E-15F, we see that their design is an example of an azimuthally variable lens shape with undercut “lobes”, using internal reflection to re-direct low-angle rays (zone C). Their lens shape is determined using an iterative process to refine a transfer function between a “predetermined energy distribution pattern of the LED source” and the output illuminance pattern in the target area, which is copied in our FIG. 15F and shows that the resultant illuminance plot is oval, not rectangular.

It is important to note that Holder's description and his FIG. 9 confirm that:
the predetermined LED energy distribution (to the lens refracting surface) is assumed to be from a point source in middle of emitter (29), and
the LED output distribution to lens is assumed to be azimuthally uniform, such that the process can be done in two dimensions for selected azimuth planes, i.e., 2D in the x-z plane and 2D in the y-z plane to determine the shape for the different x and y dimensions of the rectangle, and then “loft” the lens surface curvature in between.
his process iterates determination of the transfer function according to feedback from the output results.

Our Design

In contrast with the prior art, we used a 3 mm×3 mm square extended source LED for our high power light source, and we produced actual freeform secondary lenses 56 that are manufacturable at a reasonable cost, particularly because of their symmetry.

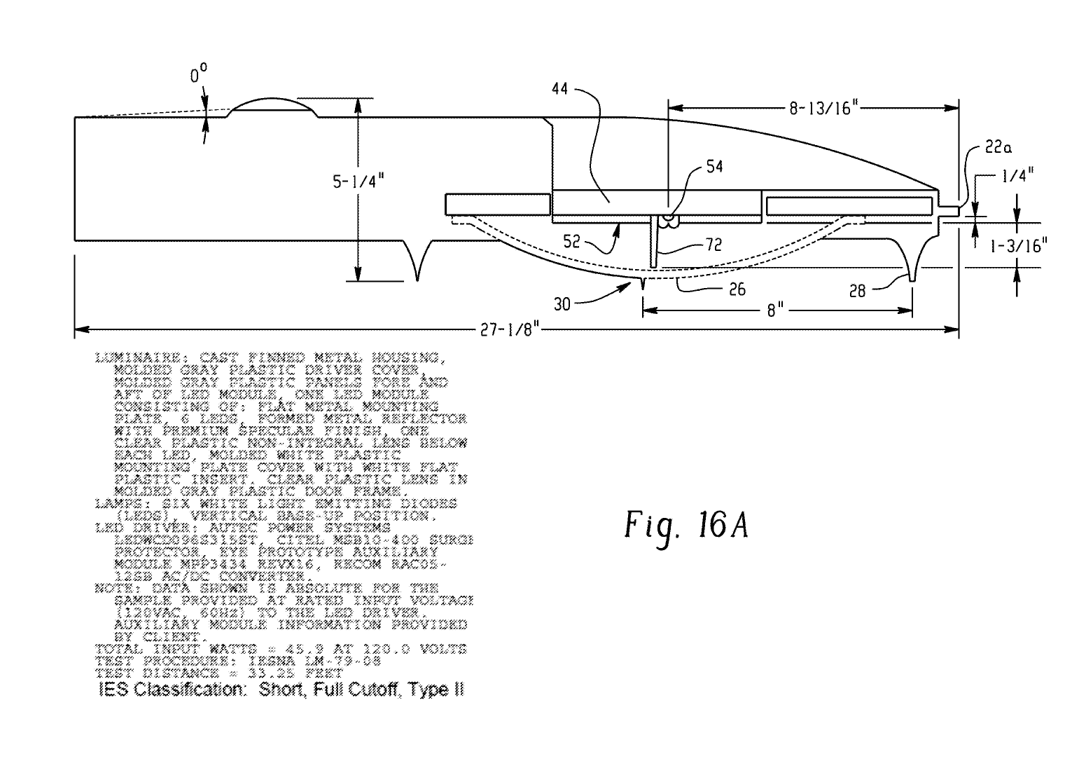

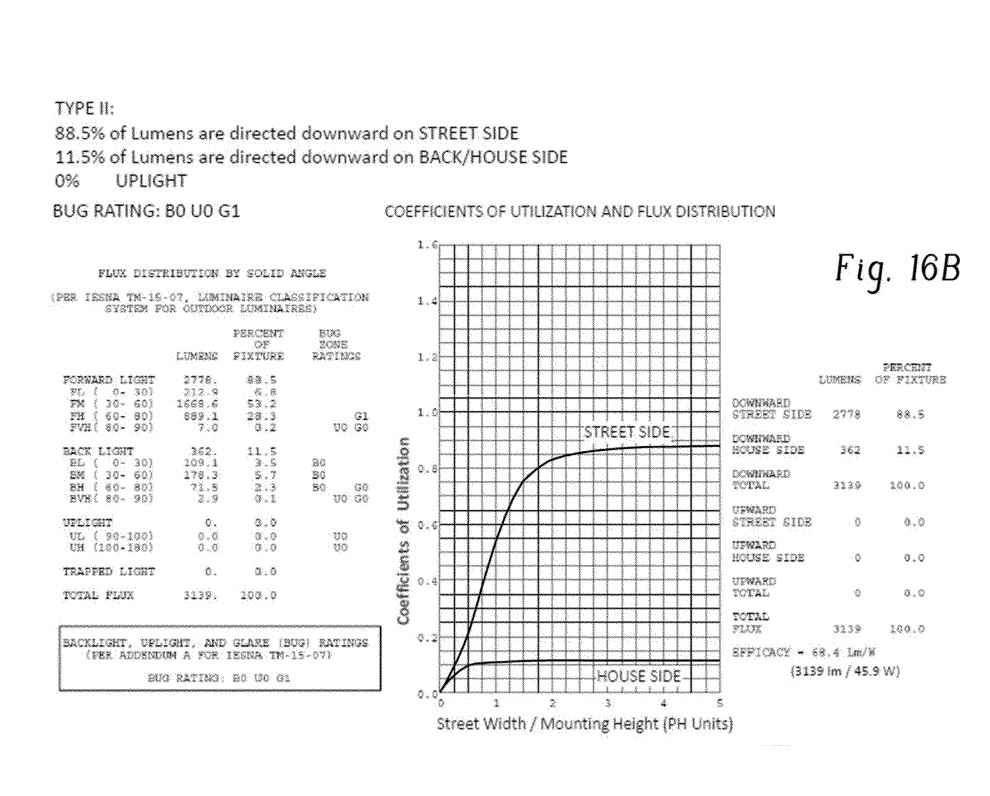

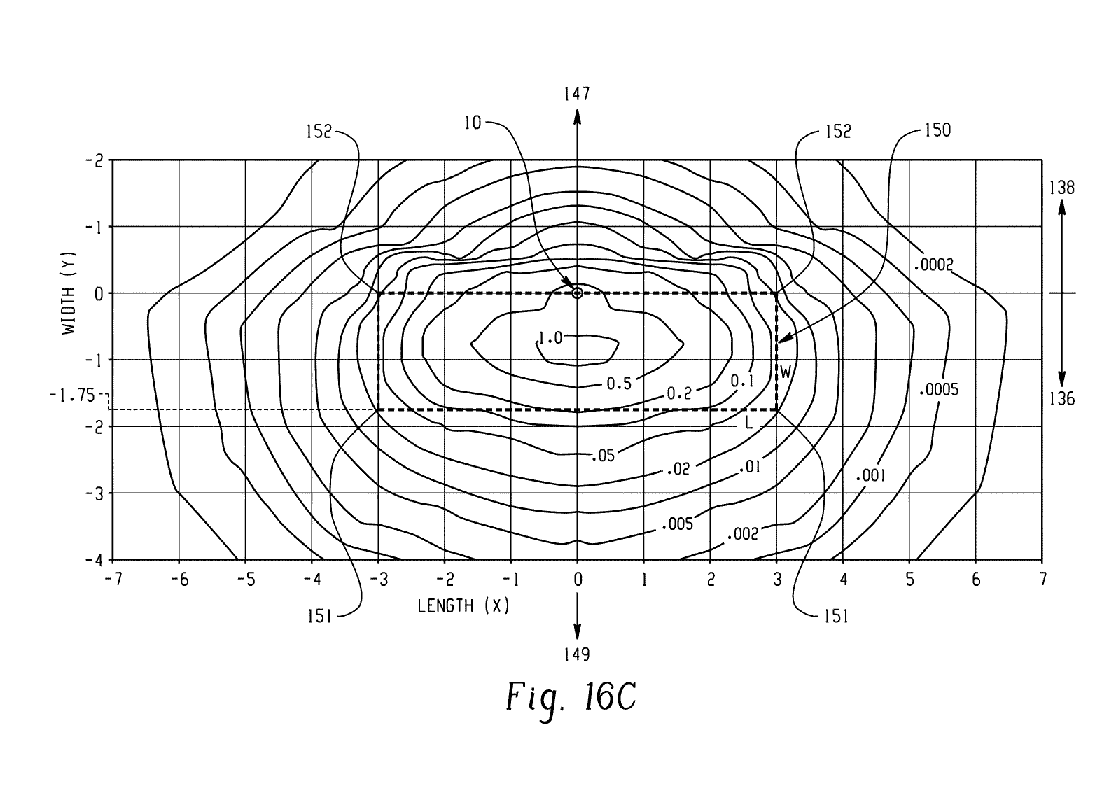

In addition to designing an efficient secondary lens, the other elements of the overall LED lighting apparatus 10 are designed to augment the lens efficiency such that the apparatus as a whole forms a lighting system that synergistically works together to maximize the total energy efficiency of utilizing the energy input to the combined LED light sources and converting that into light of uniform intensity distribution concentrated within the desired IES Type target pattern 150. This means that elements such as shields and reflectors are designed to work with the lenses to achieve, as close as possible, BUG ratings of zero—i.e., zero wasted light. (BUG stands for Backlight, Uplight, and Glare; and includes specs for various regions of each type of unwanted lighting). FIGS. 16A-16C show actual test results of a type II prototype assembled in plastic and tested near the end of our design efforts. According to these preliminary test results, 88.5% of total light output (lumens) were directed downward and forward with only slight glare; a permissible amount (11.5%) downward and backward with no glare; zero trapped light and no measurable uplight in any direction, to achieve a BUG rating of B0, U0, G1. System efficacy was 3139 lumens divided by 45.9 watts=68.4 Lm/W. The half-maximum candela trace is centered in, and substantially fills the type II target rectangle of +/−3.00 PH×1.75 PH from pole (fixture) forward.

Terminology

In the following description of lens shapes, naming conventions illustrated in FIGS. 12A-12F will be employed. Terms like “secondary lens shape 63”, “outer surface”, “contour”, and the like refer to the outer refracting surface 63 of the secondary lens 56, i.e., the body (63) of the lens part itself, exclusive of the flat flange 64 (and any features thereof) which surrounds it at the base plane, and also excluding the inner surface 82 which is a second refracting surface of the lens 56 and is therefor given a separate reference number (82). The line circumscribing the shape 63 as shown in plan view is the outermost periphery of the lens where it intersects the horizontal top surface of the flange 64, generally—but not necessarily—at a vertical right angle or close to it. Thus the surface contour shown at the flange intersection is a two dimensional (2D) profile in the x-y plane viewed from above (plan view), and any angles, slopes, curves etc. characterizing portions of that profile line are to be considered as 2D lines in the horizontal plane at constant z value. For example, “slope” in this context means dy/dx, and may be referenced as “horizontal slope”. Further in the plan view context, lines drawn within the outermost periphery are to be understood as vertical projections onto the base plane, i.e., in x-y-z coordinates, x and y held constant while z is collapsed to zero. These internal lines are shown as markers for significant surface features. For example, what is shown as a radial line (e.g., 96) extending out to an inflection (e.g., A) indicates that a similar inflection profile (type A) occurs at all of the points along that line (96)—in this case being a horizontal slope change across the line 96. The 3D surface shape 63 will be known if the z values for those points are known, so vertical cross-section views are also illustrated (e.g., in FIG. 12E). Horizontal cross-sections at different z values can be visualized as elevation map contour lines along a constant z value with relative surface curvature (horizontal “slope” angle) equating to variation of radius versus polar azimuth angle or variation of y-value versus x-value at constant z-value (whichever makes more sense in a particular context). In general, if a lens “shape” or “surface” or “characteristic” or “feature” etc. of “the surface” is mentioned, the terms should be interpreted as relating to the outer surface 63 of the secondary lens 56, unless stated otherwise or unless obvious from the context.

The relative curvature (profile) 63 shown at the z=0 periphery can be assumed to be similar along the radial lines but will gradually change to accommodate a shrinking distance between radial lines. Furthermore, since we are dealing with distance between points on a rounded surface, the rounded surface profile needs to be accounted for. Therefor we must consider both horizontal and vertical profiles of the surface. For our lens designs, our vertical profile (at constant azimuth angle) generally arcs steeply upward and radially inward to an apex 106 that is somewhat distant from the center z-axis. At the apex the profile curve levels off and then smoothly transitions to a shallow arc downward as it continues inward to the center. Ideally the vertical profiles may all end at a downward pointing cusp on the z-axis, however that is not practical for manufacturing so instead the profiles generally end with a more rounded (cup-like) intersection. The vertical cross section drawings and perspective views showing shapes and contours for the body 63 of each type II-V of secondary lens 56 are shown in various figures, especially FIG. 12E.

Another aid to visualization of the outer lens surface 63 comes from remembering that our lenses 56 are designed to have “two-axis orthogonal symmetry” as defined hereinabove. Another definition of our secondary lens' symmetry is: Any point (x1, y1, z1) on the lens surface at a horizontal distance r1 from the z axis and azimuth angle θ1 (theta) will have the same z value (z1) for the point (x2, y2, z2) that is 180 degrees around, i.e., at (r1, θ1+180)=(x2, y2, z1). In spherical coordinates, with elevation angle φ (phi) and radius ρ (rho) from the origin, (x1, y1, z1)=(ρ1, θ1, φ1) and (x2, y2, z2)=(ρ2, θ2, φ2)=(ρ1, θ1+180, φ1)=(x2, y2, z1).

When referring to a vertical cross-section view, the profile (of the outer surface) 63 is usually shown by the outermost line(s) and may be referenced as the “vertical profile”. The profile of the inner surface (cavity) 82 may also be shown and will be the innermost lines. In some cross-section views there may be other lens surface edges “behind” the cross-section plane that would be visible “around the edges” of the cross-section profile, so they are shown as lines farther outward than the actual cross-section profile lines. Cross-section shading may not be used, in which case the description, the context of the view, and other related views (e.g., a perspective view) will identify the various lines. Extra peripheral lines like this are assumed to be horizontal projections that collapse y-value to the single constant value of the cross-section plane. Vertical profile lines are 2D curves in an x-z plane at a constant y value relative to the overall 3D shape (arbitrarily labeling the horizontal axis in the plane as the x-axis). Similarly, the “slope” in this context is dz/dx (or dρ/dφ at a constant azimuth angle θ, sloping as the angle of elevation φ changes versus radius p relative to the origin (x=y=z=0), which is arbitrarily located in the plane if 2D polar coordinates are used). The slope in this context may be referenced as the “vertical slope” or “elevational slope”.

Inflections

Referring especially to FIG. 12C, there are shown reference numerals A, B, C . . . to J that are used to label “inflections” in the surface contour. These labels are used to reference different types and/or locations of inflections in the lens surface 63 where significant slope changes occur. In most cases this significant slope change is a discontinuity where the curvature makes an abrupt change rather than a smoothly changing transition. In other words, the rate of change of the surface slope is relatively high (or infinite) at an inflection point, but relatively low on either side.

Generally the inflections occur in a continuous line of the same type of inflection points, wherein the line is substantially orthogonal to the slope change at each inflection point in the line. For convenience, the inflection lines are given reference numbers as indicated on representative ones of the inflection lines in FIG. 12C. The line of type A inflections is referenced as inflection line 96, both types B and F are line 97 (compare the type II lens figure to the type IV), both types C and G are line 99 (see the type IV lens figure), and type J is inflection line 98 (see type II). Both C and G are given the same line reference number because they have the same type of inflection profile (groove-like with a horizontal slope change). However the amount of inflection is often different in the middle of the widthwise sides versus the middle of the lengthwise sides, therefor the two inflection locations are labeled separately as C and G respectively. As a result, the location of the C or G inflection may be labeled even when a corresponding line 99 is not present in a particular embodiment (but it could be in other embodiments of the same lens type). Similarly, the B and F inflections are the same type (a subtle discontinuity in horizontal slope) so they are given the same line number 97, but the amount of inflection may need to be different on the widthwise sides versus on the lengthwise sides, therefor the two locations are labeled separately as C and G respectively. Note that the “lengthwise side” references a global orientation (parallel to length L of the pattern 150), but that is not the same as the “longer side” of the lens which indicates the result of comparing dimensions L1 versus W1 of the lens body 63. The secondary inflection line 97 only occurs on the longer side of a non-square lens body 63 (L1 not equal to W1), and is labeled B or F according to where the line is located in global terms.

The inflection lines or features (e.g., 96, 97, 98, 99) occur in two main forms: radial, and rotational. They are named according to appearance in plan view, and ignoring the elevation changes along the line that are necessary to follow along the surface of the lens.

Lines 96, 97, and 99 are radial features because they extend radially relative to the center z-axis, i.e., changing radius but constant rotational (azimuth) angle. Polar coordinates are most convenient with these lines. Generally the radial inflection lines extend substantially all the way from axis to perimeter of the lens body 63.

Inflection line 98 (J type inflection) is a rotational inflection line characterized by a path with a constantly changing azimuth angle, i.e., it “rotates” around the center z-axis but not necessarily at a constant radius or elevation. For example, the line 98 illustrated is somewhat oval (elongated circle) in keeping with the overall elongated shape of the lens. Generally we use a rotational inflection line that is a closed curve bounding a top facet (e.g., 100) versus a bottom or side facet (e.g., 102).

The type A inflections are the most apparent inflection type for the present set of lens designs. Inflection A is a primary “radial line” feature 96 which is a relatively sharp “corner” where the surface 63 changes between a generally widthwise extending side and a generally lengthwise extending side (or face) of the lens, thereby defining the generally rectangular/square overall lens shape 63. This inflection has a substantially infinite rate of change wherein the line 96 is a vertex for an angle that may be as small as 90°. We define a radial line on the surface 63 as a line in a vertical plane (constant azimuth angle θ) that contains the 3D origin of the secondary lens 56. Thus it appears to be a radially extending line in plan view, although the radial line generally also has vertical slope and curvature (changing slope) in the vertical plane. For a radial inflection line (e.g., type A inflection line 96) the inflection is a significant slope change from one lateral side to the other lateral side of the inflection line (“lateral” in this context meaning at a different azimuth angle). This is easiest to visualize as a horizontal (dy/dx) slope change at constant z value, although the azimuthal (dρ/dθ) slope change at a constant elevational angle φ may be more relevant when considering light rays emanating from a source point near the lens origin (0,0,0).

The inflection line 98 is labeled a type “J” Inflection. It is the only non-radial (“rotational”) inflection line being disclosed herein. The line 98 is a generally horizontal, oval-like curve that roughly follows the apex 106 around the top of the lens, however it is modified by surface contour changes such as those caused by the radial inflection lines where they cross the line 98. The inflection J at the line 98 is a significant slope change from one radial side to the other radial side of the inflection line 98. This is easiest to visualize as a vertical slope change dz/dx or dr/dφ relative to a 2D origin in a vertical cross-section plane that is normal to the inflection line 98, however the elevational (dρ/dφ) slope change at a constant azimuth angle θ in a vertical plane that contains the 3D origin of the lens may be more relevant when considering light rays emanating from a source point near the lens origin (0,0,0).

In addition to being affected by them, the J inflection may in turn affect the shape of the radial inflections when they cross it. In fact, on the type II lens shown with a line 98, all of the radial inflection lines become inverted when they cross. FIGS. 13G-H illustrate an example of this.

The primary inflection line 96 (A) has a convex form of the azimuthal inflection A (i.e., a protruding V shaped vertex or ridge) when the line is on the radially outward side of the J inflection line 98, but it changes to an indented form of the A inflection inward from the line 98, labeled A˜ to indicate the inversion. Likewise, the secondary inflection line 97 has an indented B inflection that changes to a ridge-like inverted inflection B˜. Finally, as shown in FIG. 12E, due to the J-inflection, the normally concave junction of radial features at the z-axis is also inverted to form a small convex dome at the center.

From the corner A inflections, there is generally a gradually changing horizontal slope extending to the middle of a side, which is marked with the label C or G for inflections at the middle of the widthwise or lengthwise sides, respectively (noting that “lens length” is defined to be parallel to the length L of the lighting pattern 150, which happens to be across the narrow dimension of the flange for types II-IV, as shown in FIG. 12A.) In most lens design embodiments the mid-side inflections C and G have a very small change of slope, possibly a relatively tight radius but not a discontinuity. The type IV lens embodiment illustrated in FIG. 12C shows a radial groove 99 for the C and G inflections, where the groove may be very shallow at the axial center and then appears to fan out (dashed lines) as it gets deeper and broader approaching the outermost periphery.

Referring particularly to FIG. 12F, regardless of the severity of the mid-side inflection lines 99, it should be noted that the overall lens shape generally comprises four corners of type A inflection lines 96 wherein the corner vertexes define a rectangle (which could be square) with corner A-to-corner A dimensions of L2×W2. Between the corners A, each side has a generally outward bulge to yield overall lens body 63 dimensions of L1×W1 wherein L1 is greater than L2 and W1 is greater than W2. This can be seen as the result of applying the corner inflection lines 96 to a circular or oval lens initial shape (in plan view). In 3D, vertical profiles of the lens are derived from a generally semicircular form that has been modified to cause refraction of radial rays of light.

The B and F inflections only occur on the relatively longer sides of a non-square lens 63, generally near to the A inflection lines 96. The B or F inflections mark a “secondary” radial line feature 97 where the inflection is a horizontal slope change like A, and may even be a discontinuity, but the degree of slope change across line 97 is much less than across line 96—thus the titles “primary” (96) and “secondary” (97). The B type labels an inflection line 97 when it is on the widthwise sides of the lens; the F type is for the lengthwise sides. The primary and secondary inflection lines combine to form what looks like a “wedge or triangle” feature. As a combined feature, the inflection lines 96 and 97 work together to blend the light from a square extended area source to form a uniform rectangular distribution. Each “triangle” is bounded by a primary (obvious corner) inflection line 96 and a secondary inflection line 97 (much less of a transition and occurs along a side rather than a corner of the lens). It is always on the long side of a lens. Type V doesn't have this because it can produce a square distribution pattern using just the primary inflection line 96.

It can be seen in various drawings that the inflections are shown as being more pronounced in some embodiments compared to other drawings that show a different embodiment of the same lens type (e.g., FIG. 12A vs. 12B). The inflections may also curve in a different direction in different embodiments (e.g., FIG. 7C showing parts of a type II lens). Especially in a drawing like FIG. 12F, the curves, angles and feature dimensions are exaggerated to aid in visualizing their effects on ray tracing. Such drawings are to be understood as conceptual or schematic representations.

Lens Design Method

Referring to FIGS. 7A, 11A-11B 12A-12F, and using the theoretical assumptions, part choices, and design constraints disclosed herein, our lens design method/steps are as follows (where summarized, details may be found elsewhere in the disclosure). The method steps are numbered for convenience, but don't necessarily reflect a required or preferred sequential ordering of steps. Furthermore, steps may be included or not included according to need as determined by the lens designer. For example, even though a step may improve the lens output uniformity, such improvement may not be needed and/or not worth the time/cost of doing it. Thus for a target area (illuminance pattern area) 150 that has length L and width W, our secondary lens 56 design method steps may include:

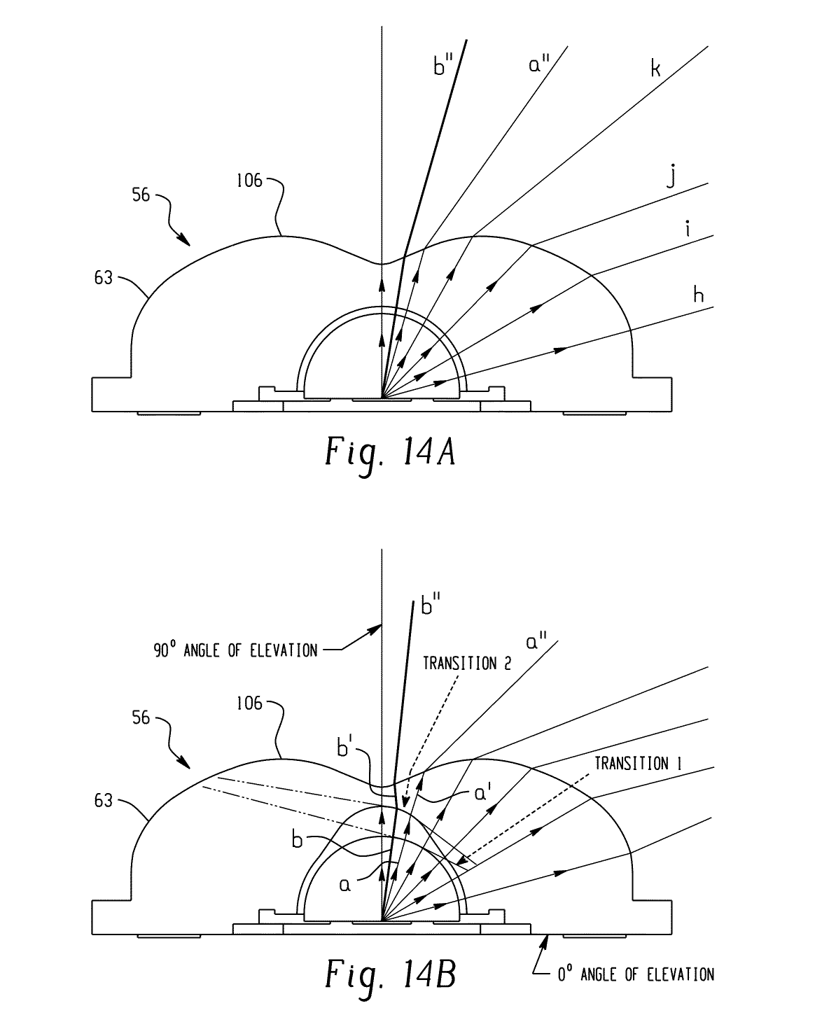

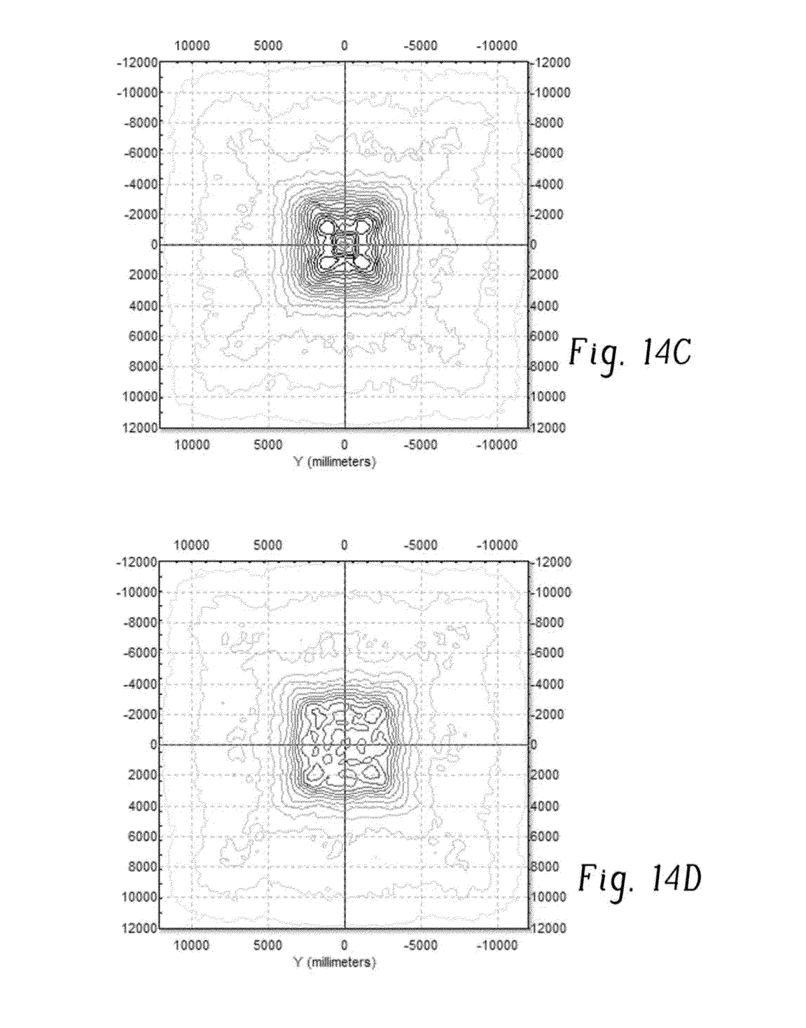

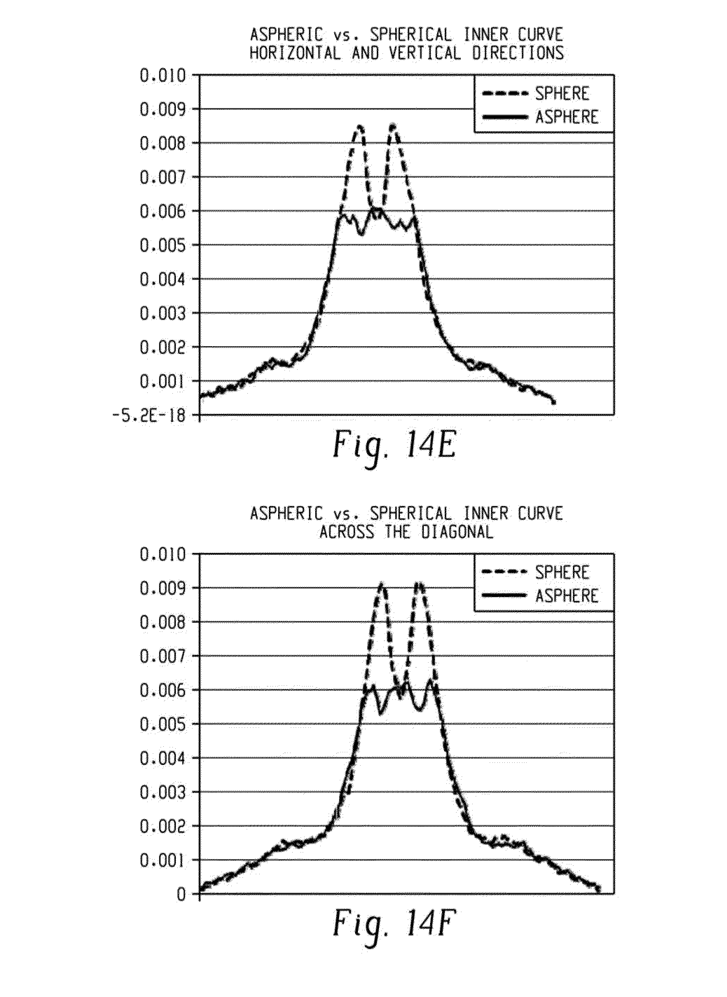

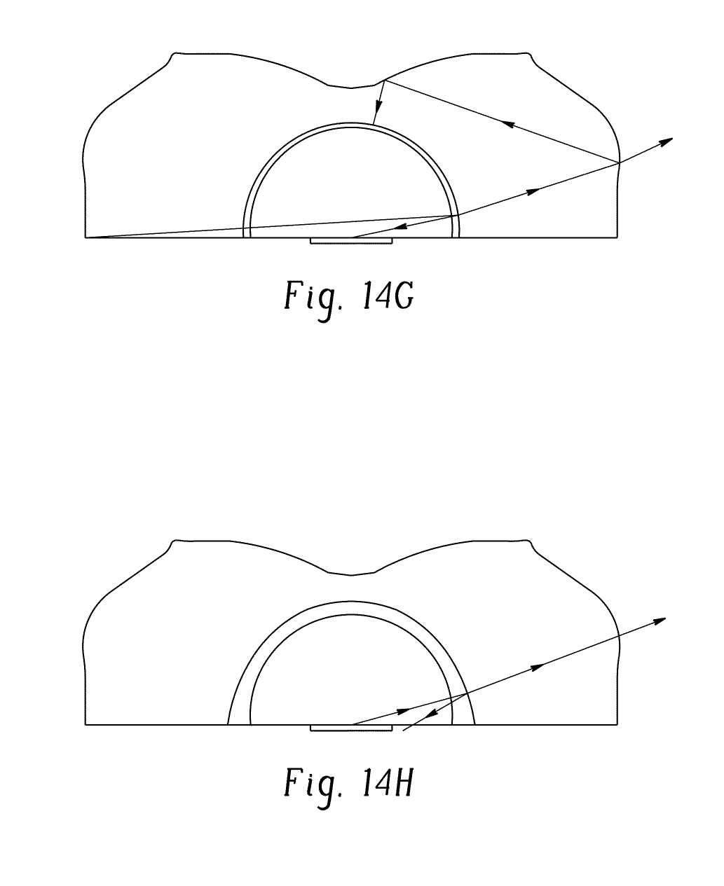

Step 1—Determine a Freeform Secondary Lens Starting Shape
(a) This starting shape can be a rough, first order approximation determined intuitively or empirically based on prior knowledge, or based on a previous design that needs improvement or modification for a changed design objective, etc. The starting shape is determined for a pre-selected LED device 54 (as defined above) but initially idealizing its total light output as coming from a single point at the origin (geometric center) of the LED emitter 86.
(b) The initial lens shape should be intended to refract the point source idealized light output uniformly into a square illuminance pattern 150, i.e., a rectangle with L=W, with one of the L or W dimensions being equal to the corresponding dimension in the design's target pattern area 150. Our method initially assumes that there is no net refracting interface between the emitter surface and the secondary lens surface. (Either no primary lens, or the LED has a hemispherical primary lens 55 surrounded by a co-axial hemispherical cavity in the secondary lens). Also assumed: a base plane 81 for the secondary lens (and primary lens) is fixed co-planar to an immersed LED emitter surface 86 (i.e., the x-y plane at z=0) and with the lens center axis (z-axis) origin (z=zero) positioned at the geometric center point (x=y=0) of the emitter 86. (Later steps will accommodate an extended area LED emitter, as well as a square-shaped extended area emitter (e.g., 3 mm square for our selected LED 54 which is described in full elsewhere.)
(c) We selected a starting secondary lens 56 that has a hemispheric shaped inner surface (cavity) 82 with uniform air gap around the primary lens 55 (and same hemisphere base plane and radial origin at x=y=z=0). This allows light rays emitted from the origin point to pass out of primary and into secondary lens with theoretically no refraction, due to perpendicular angles of incidence. (refer to FIG. 14A for an example) Air gap prevents alignment problems and lens surface damage.
(d) Based on prior knowledge, and referring particularly to FIG. 12E, the starting outer surface shape 63 is similar to a hemisphere that is truncated to invert the top to form a shallow concave top portion smoothly curving over an apex 106 to transition to the convex side portion(s), all being azimuthally symmetric and uniform. This should spread light away from the center z-axis, which corresponds to the straight-ahead downward direction, normal to the base plane 81 of the LED and lens.
(e) Also referring to FIGS. 14A-14B, to further spread out the light, the convex sides are vertically distorted to make a non-hemispherical vertical curve wherein the radius of curvature increases as the angle of elevation φ (phi) increases from zero at the base plane. FIG. 14A shows rays labeled h, i, j, k, a″, and b″ (in order of increasing φ) that radiate from the outside surface of a secondary lens that exemplifies such a shape. Ray h is un-refracted by a hemispherical surface with origin at LED origin, but rays i and j are increasingly refracted outward due to the changing curvature of the convex side surface. Rays k, a″, and b″ emerge after the apex 106 where the surface continues to curve as it transitions to concave, and therefor continues to refract the rays by an amount still increasing as elevation angle φ increases toward 90° at the center axis, where the surface levels off at 90° (no refraction).

Step 2—Horizontally Elongate the Lens to Elongate the Target Pattern (but Compensate for Use of Reflector)
(a) The amount of lens elongation is generally proportional to that of the target pattern 150, but for lighting patterns 150 wherein the target area is substantially on a preferential side of the light source (i.e., types II, III, and IV but not type V), we adapt the proportionality for our use of a vertical reflector 72 as follows: given target length L and width W; we horizontally elongate the lens to a freeform oval with lens length L1 and width W1 that are determined by using the following
   Lens Proportion Equations (first approximation):

L1=pL(p times L), and

W1=2pW

where “p” is a fractional constant of proportionality.
(b) The reason for the factor of two can be seen in FIG. 12F with reference to FIG. 10A that shows the secondary lens 56 positioned forward (direction 149) of the vertical reflector 72 such that most of the light rays 91 that are emitted through the back half of the lens 56 are reflected forward 149 (and downward 148) to overlap with the rays 90 that are emitted through the front half, such that light from the entire width W1 of the lens is directed into a target width W which is only half of the width that would be lighted by the same lens without a reflector 72 (as with a type V lens) in which case the pattern would extend behind the pole as much as in front of it.
(c) In effect, our secondary lens 56 is made to function as if it had been cut in half widthwise. FIG. 12F illustrates this by showing example rays that radiate from only half the width W1 but fill the entire width W and length L of the target. (Of course light is also emitted from the other half, but it is assumed to be reflected along the same effective paths as the light rays that are shown.) This is why the secondary lens 56 may be shown as having a greater lens “width” W1 then its “length” L1, even though the target area has L greater than W.

IMPORTANT . . . Like the rectangular target the secondary lens is orthogonally symmetric across the y-z plane at x=zero. If a lens is required to uniformly fill the rectangle that is offset entirely in positive y (widthwise) direction, then without using a vertical reflector the lens must be orthogonally asymmetric across the x-Z plane at y=zero (the front half will do what is wanted, but the back half must be shaped to refract backward directed light to forward direction; OR the base plane 81 of the LEDs must be tilted to direct the z-axis toward the widthwise center of the target area which would cause the distance traveled (rho in polar coordinates) by each forward ray 90 to be greater than that of a corresponding rearward directed ray 91. Because of this asymmetric widthwise variation of distances (rho) the light intensity for rays from a symmetric lens would be greatest at the near edge y=−W/2, and least at the far edge y=+W/2. To correct this, the rear half of lens must be different than the front half.

Step 3—Create Corners (Inflection A) on Lens to Fill Corners of Pattern
(a) Rather than create a dog-bone shaped lens, we add four ridge-like primary radial line features 96 to draw light away from the sides and into the corners of the pattern. The line 96 of type A inflections makes the lens have sharp “corners” that are a discontinuity in horizontal surface contour. (See FIGS. 12C and 12E for different views of these features.) Referring to FIG. 12F, the radial type A inflection lines 96 concentrate radial rays at the azimuth angles 0 (theta) near to the lens corners (marked A), drawing them together from both azimuthal sides of the corner by refracting toward the radially extending z-θ plane at the azimuth angles θ corresponding to the corner lines 96. NOTE: FIG. 12F is a conceptual sketch. For the sake of simplified illustration, the lens shape has been greatly exaggerated, and the light ray refraction angles are coarse estimations rather than being rigorously determined.
(b) The corner ridge lines 96 should be aligned with the corners of the target pattern 150, i.e., positioned at the same azimuth angles θ (theta). Thus for a square pattern (e.g., type V) the corners are at 45°, 135°, 225°, 315° (assuming that θ=0° is oriented as shown in FIG. 12C).
(c) The alignment of lens-corner to target-corner can be determined by using the above “Lens Proportion Equations”, however since the lens 56 may bulge out between corners A, we adapt the proportionality equations so that they use the length L2 and width W2 lens dimensions that are defined by the corners A instead of the less representative bulged side dimensions L1, W1.

Step 4—Add Mid-Side Inflections C and/or G to Spread Out Rays Between Corners
(a) The line 96 of “corner” inflections A take care of adding light to corners in the target area 150, but may produce an irregular shaped iso-candela pattern in the rectangular target area. In other words, the light intensity may be non-uniform (unacceptably variable) along the sides of the pattern. Thus we add C and/or G inflections as needed to uniformly spread the rays along straight sides of the target area, the amount of spreading being determined by the depth and width of the inflections C or G along the center side lines 99 (if present). The depth and width of the inflection can vary along the line 99, as shown by the dashed lines surrounding it in FIG. 12F. For example, the inflection typically becomes deeper and more spread out as get farther from the z-axis, which compensates for the overall spreading of the lens surface side width or length as move outward. The mid-side inflection lines 99 create better intensity uniformity along the target sides which are effectively “closer” to the light source than the corners, thereby theoretically producing a rectangular iso-candela pattern with dimensions matching the target's dimensions.

Step 5—Add Secondary Radial Line Inflections B or F to Compensate for Emitter Corners
(a) Refine design to account for a square extended area LED source with corners (e.g., 3×3 mm emitter surface 86) which make the LED light radiation distribution azimuthally variable, a factor which has not been considered by the prior art. (see notes about Holder patent above) Note that orthogonal symmetry helps reduce the effort of dealing with this, to:
   (i) determining the output in all directions (i.e., emission intensity distribution) from one quadrant of the emitter surface, charted as the angle of incidence and location of intersection with lens surface for representative rays of emitted light. This may be done first for output from a single point representing an “average” for the quadrant, but will be better result if use the optimizing method described hereinbelow for a plurality of point source locations. Note, however, that because of symmetry* the use of one point in a quadrant, e.g., in its “middle” as determined by a center-of-mass type calculation, yields the equivalent of four point sources, all about half way out from the center of the extended area, instead of a single point in the center to represent the whole extended area;
   (ii) determining the refraction effects at surface of all of the lens quadrants, for light from the one quadrant of the emitter;
   (iii) using symmetry* to obtain output at one lens quadrant due to emission from all four emitter quadrants;
   (iv) determining a total output intensity distribution for the one lens quadrant by combining (overlaying) the distributions due to emission from the four emitter quadrants; and
   (v) using symmetry* to replicate the output for the other three lens quadrants.

*Note:
An example of “using symmetry” follows, wherein the type of symmetry is the “orthogonal symmetry” described herein for our lens designs:
   Number source (emitter 86) and lens 56 quadrants in circle sequence such that quadrants Q1 and Q2 are “horizontally” opposed (e.g., as in FIG. 12F).
   For emission from Source Quadrant Q1 of 4, the resultant refracted output from the outside surface of the four lens quadrants Q1-Q4 is determined and then correspondingly labeled I, II, III, IV.
   By symmetry, then, the total output I′ from surface of lens quadrant Q1 is I′=(I)+(overlaid on) (horizontal minor reflection of II)+(diagonal reflection of III)+(vertical reflection of IV).
   Also by symmetry, II′=(H reflection of I′), III′=(Diagonal reflection of I′), and IV′=(V reflection of I′).
(b) The calculation work may be reduced by first determining the results for an extended area source that is azimuthally uniform (e.g., a 3mm diameter circle), then adding in the effects of the corners beyond the circle. For example, instead of individual point sources, the effect of a fixed length radial line source could be determined and integrated for θ=0-360°. For example, the effect of a fixed radius annular part of the source area (or quadrant of the source area) could be determined for min and max radii, interpolated between, and then integrated or averaged.
(c) As shown in FIG. 12F, the surface area of the LED emitter 86 is drawn in for the back half 63bh of the lens 56 (emitter size exaggerated for clarity). The corners 89 of the emitter determine where the secondary inflection lines 97 should be located (lined up with corners 89) but the primary inflection lines 96 (in lens' front half 63fh) line up with the front corners 151 of the rectangular target area 150. When folded by the reflector 72, the inflection lines 96 from the lens' back half 63bh overlap those of the lens' front half 63fh, so only the forwardmost corners 151 of the target “appear” to be aligned.
It may be noted that the inflection lines 96 from the lens' back half 63bh will line up with back corners 152 of the target area 150 for a type V lens for which we don't use a reflector (as indicated by the dashed lines extending the target area 150 to the back of the lens as target area 150′, with back corners 152′). The Type V lens doesn't need secondary lines 97 because the primary lines 96 are aligned by default with the target corners 151, 152 and also with the emitter corners 89, since both are square.)
Thus the secondary lines 97 are only needed for types II-IV, which have non-square targets. The more rectangular the target is, the more important the secondary line is, the more it will move apart (greater angle) from the primary line, and probably also the bigger and more apparent it will be, all in proportion to target L:W ratio.

Step 6—Optimize the Design
a) This is an important part of our design method wherein luminaire lighting efficiency is improved by our design method that accounts for light emitted from different points of the extended area LED emitter surface 86. This has not been done in the prior art. We recognize that, for any given point on the secondary lens surface 63 (or 82), that light rays received at the given point coming from geometrically different points of the emitter surface 86 will impinge at different angles of incidence, and therefor will be refracted at correspondingly different refraction angles. Because of this, the output from the lens will be more spread out and lower intensity than expected if a point source emitter is assumed, i.e., the output illumination pattern or intensity distribution is effectively “smeared”. Of course, the larger the emitter area is, the greater the smearing effect will be. Our optimization process adjusts the lens contour at a first point or set of points to compensate for the smearing effect at another point (or set of points) and iterates this process to achieve an optimum balance of these interacting point contour adjustments, optimum being the highest efficiency and best uniformity possible for a reasonable effort.
b) Optimization can be done at several stages of design, depending upon whether you want to do it after all major shape changes are made, or do it in between for smaller step changes. For example, for rectangular target areas, it may be best to do after the secondary inflection lines are added, or probably as a part of that design step but after placing the primary inflection lines. (Step 5 above describes an embodiment of this form of optimizing.) In another example, if another lens feature is added (like the color mixing facets described elsewhere) then it may be best to determine the shape and location of the new feature according to the optimization method.
c) FIGS. 13E-F can be used to illustrate the need for optimizing as we perceive it. In these views, a ring 98 of J inflections is a feature that has been added to a secondary lens 56. Now the best location for the ring 98 on the lens surface, and possibly also the shape for the inflection J is optimized to produce the best color mixing effect. FIG. 13E shows the color mixing effect using rays from the center point 86a of the emitter 86. Others have made calculations using this assumption of a central, single-point light source. FIG. 13F shows why it is important to account for the entire surface area of the extended area emitter. The emitter 86 is illustrated roughly in proportion to the lens when viewed in a cross section that cuts diagonally across the emitter 86, thereby showing the largest separation of light source points (right corner 86b to left corner 86c). On the right side of the lens the color mixing for rays from the right emitter corner 86b is shown, resulting in comparatively more mixing than for 13E (light from center 86a), because of the different angles of incidence for the corner rays when they hit the sides of the inflection J. On the left side of the lens, three solid lines are shown for rays from the same corner 86b but going to points of the left-hand lens contour that are equivalent (by symmetry) to the right-hand points with rays shown. For visual comparison, a copy of the right side rays is shown in dashed lines from the nearest corner 86c. We see that not only are the right-hand results for color mixing of light from the center 86a (FIG. 13E) different than for light from the right emitter corner 86b, but the left-hand results for light from the right corner 86b are even more different. By symmetry, the left-hand results for light from right corner 86b can be translated as a horizontal mirror reflection to be superimposed on the right hand results for light from the left corner 86c. Also the results of FIG. 13E for light from the center point 86a can be superimposed on the results shown in FIG. 13F. The resultant combined illustration will be very confusing to visualize, but exemplify how the smearing effect works.
d) Therefore, one form of our optimizing method is to separately determine the lens' surface shape 63 (or a representative portion of it, like a quadrant, or such as a matrix of points within the quadrant or along the line of an added feature) for refraction of rays from each of a plurality (e.g., number ‘n’) of point light sources (e.g., 86a, 86b, 86c . . . 86n), with the source points 86n selected to represent a matrix/array of points uniformly distributed over the entire extended area LED emitting surface 86. Alternatively, a representative portion (e.g., a quadrant) of the extended area LED emitting surface 86 can be used as a source for all quadrants of the secondary lens. Either way, the result will be a plurality (n) of determined surface contour shapes at each selected surface point. The final shape is determined for each of those surface points by taking a weighted average of the plurality n of surface point contours. The weighting factor may be determined by: for example, location of the refracted ray within the target area (e.g., proximity to a desired location); or for example, the amount of energy being refracted to a given direction; or for example, the amount of energy incident on the surface point from a 3D angle of incidence; or other determinations.
e) In an embodiment of our method, the lens outer surface shapes 63 were determined by an iterative spline curve-fitting procedure, iterated for different ray source points 86n distributed about the whole LED emitter surface 86, then the iterations were combined to get an optimized shape using a weighted average of the iteration results.

In an embodiment of our method, the lens outer surface shapes 63 were determined by an iterative ray tracing procedure which is repeated for rays emitted from a plurality of points selected to approximate the entire area of the extended area LED emitter 86.

The aspheric secondary lens inner surface shapes 82 are determined by a similar iterative process, but the curve fitting is done to an aspheric polynomial equation. Result is shown in FIG. 14I. (docket eli-112)

### Optional Improvement Steps

Step—Smooth Out Color Transition Due to Phosphor Thickness (ELI-111)
Refine the lens design to smooth out a changing color due to phosphor thickness vs. angle effect on light color.
Benefit: Smoothing out undesirable color nonuniformity from the LED device 54, while achieving higher efficiency, better uniformity, and more desirable distribution pattern. This is most effective for the type II lens, because it has the most narrow illuminance pattern, meaning the transition will be most apparent due to the short range of view that is sufficient to observe the entire range of color change. Therefor our design for implementing this improvement is focused on the type II lens.

The reason for the problem is illustrated in FIG. 11A. When light is emitted from a “white” LED the color changes with elevation angle φ of light emission because a relatively thick phosphor coating 88 is used on the LED emitting surface 86 to convert the LED output from blue or UV to “white”. Unfortunately, the amount of color correction is related to thickness of phosphor coating 88. The blue LED emission is not completely corrected within about 30° of straight ahead, but light rays emitted at small elevation angles φ relative to the emitting plane will travel though more yellow phosphor, thus overcorrecting color to appear to be yellowish. This variance in phosphor thickness verses angle (cosine effect) will cause a color shift from bluish at the center to yellowish at the edges of the illuminance pattern, because each source angle φ corresponds to one position in the illumination pattern 150 so the source angle color variation maps to a steadily changing gradient of color versus distance from the center of the illumination pattern. A consistent trend like this is readily noticed by the human eye. In the new lens design, most positions on the illumination patch correspond to a mixture of overlapping light from multiple source angles.

The design solution is to create a top, ridge-like feature 98 (inflection type J) that divides the lens outer surface 63 into two distinct facets (a top facet 100 being within the oval (oblong or elongated circle) line of inflection 98; and a side/bottom facet 102 outside of the oval). As illustrated in FIGS. 13E-13F, each facet spreads light into the other facet's portion of the irradiance pattern, yielding color mixing because the first facet's light is blue-white and the second facet's light is yellow-white. The crisscross pattern shows the overlapping irradiance from each facet. If complete overlap can be accomplished on average, then the range of color change will be reduced to almost zero. If less than complete, then the color will be uniform over most of the pattern, changing to yellow at the outer edges and blue in the center. Since the majority of pattern is at a mixed, therefore intermediate color, the magnitude of change at each transition will be cut in half and separated so much that it will be hardly noticeable.

The J-type inflection is a rounded discontinuity producing a rapid change in vertical surface slope rather than an A-type corner-like discontinuity producing an abrupt change as shown in the cross section views of the type II lens (e.g., FIG. 12E) and as discussed in more detail hereinabove. The top facet 100 and the side facet 102 each have a generally convex surface, but the J-type inflection adds a rounded ridge between them, where the broadly curved vertically convex side facet 102 rapidly curls into a vertically concave surface that then quickly transitions to a vertically convex curve with an even smaller radius of curvature, which then levels off to the gradually curving convex top facet 100.

Prior work has provided color correction surface features for an effectively point source emitter and an azimuthally uniform, circular horizontal profile. As a result their surface feature is also circular and horizontally level. We have designed a feature for an oblong, even rectangular, square-cornered lens 56 such as we describe herein. Our surface feature 98 is a complex non-circular feature that accommodates and works with all the other of our design features. FIG. 13A shows the profile for a section taken along the long axis of the lens, and FIG. 13B along the short axis. The inflection line 98 (see FIG. 13C) is elongated because of the different lengths of the two sides (length not equal to width). A mixing angle φₘ is determined from among elevation angles φ that are in the middle “rapid change” region indicated in FIG. 11A. As shown, the J inflection line 98 is placed at roughly the same elevation angle φ=φₘ, all the way around (all azimuth angles θ). FIG. 13B shows how the shorter horizontal dimension causes a steeper vertical profile in general, and causes the inflection point on line 98 to be pulled inward and therefore downward in order to intersect the same elevation angle (mixing angle φₘ). The shorter side dimension also causes the apex 106 to be at a lower apex height AH(S) than that of the long side, AH(L), and also pulled in. The apex location was already determined by the side length, independent of the J inflection line 98, so the two features interact. Thus the J inflection line 98 is a horizontally elongated closed curve, with a vertical height that “wobbles” like a washer bent to a gradual curve around a diameter line. This is a result of interacting with the effect of the A inflection lines 96 which elongated the lens in general. The apex height variation is seen in FIGS. 12E, 13E and 13F which include “background” edges that are omitted from FIGS. 13A and 13B (for better clarity).

As discussed hereinabove with reference to FIG. 13G, another interaction is that all of the radial inflection line features 96, 97, 99 are inverted when they cross over the J inflection line 98. This can be explained by considering that the purpose of the J inflection is to refract light in opposite directions so that the output of the two facets 100, 102 will cross and mix. Therefore it makes sense that the refraction effects of the radial features should also be made opposite in the two facets. Thus we have not only adapted a secondary lens to cause color blending, but we have done that for an elongated lens that produces a more uniform square or rectangular illumination pattern (A, C and G inflections), and also one that corrects for a square extended area source being refracted into a non-square, rectangle target (B and F inflections). This is all new compared to the rudimentary Prior Art work for color blending with circular lenses and point sources being refracted into a circular target area.

Even further, we optimize the lens shape to accommodate emission from all points of an extended area source (e.g., a square 3×3 mm LED emitting surface 86). This is detailed above in step 6c of the design method.

Optional Improvement Step

Step—Improve Intensity Uniformity for the Square (Type V) Light Distribution (ELI-112b)
For type V lens, an aspheric inner surface 82 is added, (providing a dome-like bubble above the primary lens) with curvature designed to improve uniformity of square light distribution. Moved some light into dark center of pattern, and leveled excess/hot spot light band around the center. Could also be done for other types except that size limitations on lenses II-IV resulted in not enough thickness for a domed inner surface 82. It would work on types II-IV if top center part was thicker. Type V is thick enough because overall lens L×W is bigger (due to 50 mm LED spacing).

The inner curve was profiled as an asphere to improve uniformity and efficiency for each distribution type. (raises all points in pattern to be closer to average, by redistributing excess “wasted” light in hot spots). Curve is determined by iterative spline curve fitting calculations using an aspheric polynomial.

The curve can be optimized for light from the entire LED emitter surface as described above.

Wikipedia Definition:

An aspheric lens or asphere or aspherical lens is a lens whose surfaces have a profile that is rotationally symmetric, but is not a portion of a sphere. The asphere's more complex surface profile can reduce or eliminate spherical aberration and also reduce other optical aberrations compared to a simple lens. A single aspheric lens can often replace a much more complex multi-lens system.

Referring to FIG. 14B, at the top of cavity 82 (highest elevation angles φ, or z values), the aspherical dome has a smaller radius of curvature than the primary lens, so it has to be raised into a dome to avoid hitting the primary. At the middle angles φ, where the tails of the dome have curved inward too far, the surface 82 curves back out to join the bottom shape of the inner surface 82 (which may be hemispheric or could be another aspheric shape such as is discussed below).

The aspheric (domed) inner curve has the effect of spreading out the irradiance of the near normal flux from the source. For example, the third and fourth rays (k and l) are bent outward more in the asphere FIG. 14B than originally in the FIG. 14A with the standard hemispherical inner curve. Rays are shown at 15 degree increments of elevation angle, plus a 7.5 degree increment (ray b-b′-b″) added next to the vertical ray. The latter shows how a slight correction in the middle provides added light to fill the “hole” at center of pattern.

FIG. 14A shows a type V secondary lens with spherical inner curve 82. It is a hemisphere with the same origin, centerline z-axis, and equatorial x-y base plane as the primary lens. Therefore there is a constant primary to secondary lens surface spacing, meaning no refraction at boundary of either lens because radial rays are perpendicular to each hemispherical surface.

The problem this causes is shown in the FIG. 14C irradiance map (i.e., target area pattern 150). There are hot spots and lines along the diagonals to the corners, and a darker hole at the center surrounded by a bright circle fading to a square.

FIG. 14B illustrates our aspherical inner curve. Relative to the standard hemispherical inner curve shown in FIG. 14A, the asphere has the same starting points, i.e., the same spacing away from the primary lens surface at the hemispherical base plane which is co-planar with the emitter surface and is coaxially centered on the same z-axis through the origin of the primary lens. However, the asphere doesn't have a single “origin” for its radius of curvature. At angles lower than the “transition 1” the curve is approximately hemispherical like the primary, so rays don't refract at the inner surface. Between transition 1 and 2, the radial rays intersect the curve where it has slope a′ that is steeper than the slope (a) of primary lens, which causes the ray to bend “down” at (a′). Above transition 2 the rays intersect curve where it has slope b′ that is less steep than the primary slope (b), which causes the ray to bend in toward the centerline.

The result is shown in FIG. 14D: a wider spread of light at intermediate angles of elevation φ, which levels out the hot spots, and at high angles this effect reverses to cause more concentration of light near the centerline, thus filling in the center “hole” in the pattern.

Both irradiance photos show a +/−12,000 mm (i.e., 24 meter L×W) square ground surface area, with light source at 2,995 mm height above ground. (˜10 foot pole height PH?? seems short?) “Horizontal” is left-right 0 degree X-axis; “Vertical” is bottom-top 90 degree Y-axis of pattern on ground. (Due to symmetry of the lens and source X and Y profiles are substantially the same.) Likewise, a diagonal profile corner to corner should be the same for either pair of corners.

FIGS. 14E-F compare irradiance intensity from the original spherical to the new aspheric inner curve. FIG. 14G superimposes the plots to show the dramatic differences in both distribution uniformity and leveling of intensity below the hot spot values (which means that the available light is being spread around more, to use it more efficiently)

Optional Improvement Step

Step—Minimize Fresnel Losses Due to Internal Reflection (ELI-112a)
Refine previous designs to minimize Fresnel losses due to internal reflection. Result is aspheric inner surface (spread outward from hemispheric shape at base). Most important for types II-IV, but may also be done for type V (probably not needed—not enough benefit to justify the effort because the wider dimension of the outer surface makes a given elevation angle ray hit higher on the side of the lens). Note that, as described above (e.g., with FIGS. 7A-7C), reflections (Fresnel or whatever) that are directed at the area below the secondary lens, including those angling into the flange underneath the module cover, will be diffusely reflected back outward toward the fixture cover lens by the PCB reflector 68. The roughened bottom surface 66 of the secondary lens 56 (both body 63 and flange 64) assures diffuse reflection, and also helps prevent internal reflections within the flange which can act as a light pipe directed under the module cover (as shown by Holder et al, in their FIGS. 12-13). It should also be noted that the inside edges of the module cover 58 openings 62 for the secondary lenses are diffusely reflective such that very low angle rays from the LED and any other misdirected rays will be aided in escaping into the output beam of the fixture 10, where they belong, rather than being absorbed and wasted as heat. (See FIGS. 10A-10B for illustration).

FIG. 14H shows a ray trace using a spherical inner curve (matching the LED primary lens dome). A strong Fresnel reflection is created at the secondary lens' outer surface for rays emitted at lower elevation angles φ. Also there can be a weak Fresnel reflection at the inner surface. As shown, both internal reflections are likely wasted—being reflected back into the LED or out to the flange (not shown).

FIG. 14I shows a ray trace using the same elevation angle, but passing through our aspheric inner surface curve. The weak Fresnel reflection at the inner surface is now directed at the PCB reflector 68 below the lens, where the diffuse reflections will be randomly directed outward and added to the general lighting emitted outward (see FIGS. 7A-7C). In addition, the aspheric shape causes a low angle ray to be refracted at the inner surface 82, thereby being bent to a higher elevation angle where it will be less likely to reflect back from the higher point on the outer surface profile 63. Thus the aspherical inner curve not only reduces Fresnel reflection at the inner surface, but also causes more light to be directed at high enough angles to avoid significant Fresnel reflection at the outer lens surface.

The aspheric inner curve 82 is unchanged (i.e., left as hemispheric) except for the bottom portion where it spreads out (less curvature than the hemisphere). This could be combined with the “domed” aspheric shape used for the top portion of type V lenses, if desirable. We haven't combined the curves for our types II-IV lenses because they don't have room (not enough top thickness) due to smaller outside dimensions compared to type V. The inner curve used for types II, III, and IV can be described by the aspheric polynomial curve equation:

$$z = \frac{{cr}^{2}}{1 + \sqrt{1 - ( 1 + cc ) {c}^{2} {r}^{2}}} + {a}_{4} {r}^{4} + {a}_{6} {r}^{6} + {a}_{8} {r}^{8} + {a}_{10} {r}^{10} + {a}_{12} {r}^{12} + {a}_{14} {r}^{14}$$

where the variables are:

z=vertical axis height

r=radius from polar center (at z=zero)

and the constants are:

c=curvature=1/(radius of curvature)

cc=“conic constant”

a#=polynomial coefficients

For example, our inner curve has the following values for the aspheric curve constants:

c=−0.25

cc=−0.6

and a ray tracing polynomial curve fitting process, optimized by iterating for all ray source points, yields:

a4=−0.002

The inside curve could have been re-optimized for the outside dimensions that vary as rotate about the z axis, but it was not deemed to be worth the effort, so inner curve was left rotationally symmetric.

Added Notes and Info

This detailed description is focused on providing support for claims regarding certain aspects of a newly designed LED Lighting Apparatus that incorporates many improvements on the prior art in order to meet the “desires” and objectives stated hereinabove, especially in the Background section. The following table (copied from the Docket ELI-113 provisional application benefiting the present utility application) provides the reader with an overview that summarizes the more notable aspects, i.e., the features presently believed to have the most potential for claims of novel and non-obvious inventions. Although this table is also “incorporated by reference” it is literally presented here as a readily available aid to further clarify the reader's understanding of the present claims to a specific feature, given that individual features function synergistically with other features within the context of the entire newly designed LED Lighting Apparatus. It may be noted that the features being claimed in a particular Docket's application are listed according to the plans in place at the time this table was presented in the provisional application, therefor the utility applications may implement them in differently labeled Dockets. For example, the utility applications for Dockets ELI-109 and 113 are filed with some of the listed features being switched between the Dockets.

| ITEM | DOCKET | POTENTIALLY CLAIMABLE (summarized) |
|---|---|---|
| 1 | ELI-109 | LED LIGHTING APPARATUS WITH REFLECTORS |
| | | Single row of LEDs (types II-IV) with close vertical reflector (specular) |
| | | Also horizontal reflectors (diffuse) in several places. |
| 2 | ELI-110 | EXTENDED LED LIGHT SOURCE WITH OPTIMIZED FREE- |
| | | FORM OPTICS |
| | | Lens designs create rectangular (includes square) distribution optimized for |
| | | use with an extended LED source |
| 3 | ELI-111 | EXTENDED LED LIGHT SOURCE WITH COLOR DISTRIBUTION |
| | | CORRECTING OPTICS |
| | | Lens design mixes colors to prevent noticeable color gradient in light pattern |
| | | (from extended LED source) |
| 4 | ELI-112 | ASPHERICAL INNER SURFACE FOR LED SECONDARY LENS |
| | | a) Lens design has aspheric inner curve to minimize Fresnel losses (from |
| | | extended LED source) |
| | | b) Lens has aspheric inner curve to improve distribution uniformity (from |
| | | extended LED source) |
| 5 | ELI-113 | BACK REFLECTOR OPTIMIZED FOR LED LIGHTING FIXTURE |
| | | Vertical reflector has wrapped ends and arched top edge to maximize |
| | | forward lighting with a shallow cover lens to create a compact fixture. |
| | | Backlight shield outside cover lens is aligned to assist. |

| | Can | |
|---|---|---|
| | add | |
| ITEM | to | Optional Additional Concepts (summarized) |
| A | ELI- | Diffuse reflective top surfaces (“horizontal”) to capture Fresnel reflected |
| (orig 4) | 109 | light from cover lens (change angle of light) |
| | | What's New: Deliberate use of diffuse reflected surface on all reasonably |
| | | achievable surfaces under the cover lens. Diffuse reflection is needed to |
| | | efficiently redirect the light that has been reflected via Fresnel reflection off the |
| | | cover lens such that it can escape from the fixture upon redirection. ALSO |
| | | WHITE PAINT ON ADJACENT BOX COVERS |
| | | Benefit: Higher efficiency compared to ignoring the Fresnel reflections or trying |
| | | to redirect using specular reflection. |
| B | ELI- | Type V LED layout to minimize module surface area while not interfering |
| (orig 5) | 110 | with each other. COMBINE WITH Item G. |
| | | What's New: Type V layout was optimized to be as small as possible area |
| | | without the light from one LED impeding another LED. |
| | | Benefit: Highest possible efficiency with better uniformity and smallest fixture. |
| C | ELI- | Uplight and backlight baffles (shields) on main housing |
| (orig 8) | 109, | What's New: Utilizing the fixture housing as an integral part of the optical system |
| | 113 | to minimize backlight and prevent uplight. The ring prevents uplight while the |
| | | “eyelid” reduces backlight. Can be exchanged with type V ring (shorter uplight |
| | | shield, no backlight shield) |
| | | Benefit: Designing shields as part of the overall fixture design allows for |
| | | optimum compactness and eliminates the need to add blockers or baffles as a |
| | | future add-on to achieve desired uplight and backlight performance. |
| | | Interchangeability enables us to use a single universal housing for all LED |
| | | lighting types. |
| D | ELI- | Using integrated cover lens for environmental and vandal protection |
| (9) | 109, | What's New: The fixture (including the entire optical system) was designed with |
| | 113 | an integrated cover lens (attached inside bottom housing with gasket seal). |
| | | Benefit: Provides maximum protection from the elements. Also, the lens material |
| | | and thickness can be changed to achieve various levels of vandal protection - |
| | | without the usual undesirable loss of lumens and high cost associated with an |
| | | aftermarket vandal shield. Also can exchange for a more shallow lens to use with |
| | | type V. |
| E | ELI- | Combination of specular mirror and diffuse secondary lens bottom surface |
| (10) | 109 | to create a diffuse reflection |
| | | What's New: A diffuse reflection is desired off the bottom surface of secondary |
| | | lens to achieve best efficiency and uniformity. Traditional approach is to have |
| | | smooth/specular lens bottom surface over a diffuse reflector. This limits the |
| | | options for the reflector material. Our approach used a diffuse/scattering surface |
| | | (e.g., grit-blasted mold) on the lens bottom along with an inexpensive reflector |
| | | which can be specular. |
| | | Benefit: Lower cost while still achieving desired efficiency and distribution. |
| F | ELI- | Self-centering secondary lens - molded bore on underside of lens aligns with |
| (11) | 110 | 4 lobes on LED package |
| | | What's New: Molded into the lens is a circular bore that encircles the 4 |
| | | protruding lobes present in the LED package. This self-centers the lens, reducing |
| | | component count and assembly cost while ensuring maximum performance. The |
| | | circular bore is inherently aligned to the lens inner and outer optical surfaces. |
| | | Optionally make (at least one) sides of bore straight (a secant) to line up two |
| | | adjacent corner lobes. Preferably add to the recess to also enclose the square LED |
| | | substrate. |
| | | Benefit: Lower cost while simultaneously achieving excellent alignment between |
| | | the LED and the lens. |
| G | ELI- | Common/universal LED module circuit board (PCB) achieves both II-IV |
| (12) | 110 | and type V, along with multiple lumen levels, depending on LED placement |
| | | What's New: A common board design including circuit traces and LED solder |
| | | pads achieves all distribution and lumen level requirements. Distribution type (II-IV |
| | | or V) and lumen level (6, 9 or anything in between # of LEDs) is determined |
| | | by where the LEDs are placed. OPTIMIZED FOR 6 or 9-in-row type II-IV, or 3 × 3 |
| | | array type V (double spaced LEDs) COMBINE WITH Item B. |
| | | Benefit: This minimizes board development cost, inventory SKUs, and board set |
| | | up/run costs. |

Although the invention has been illustrated and described in detail in the drawings and foregoing description, the same is to be considered as illustrative and not restrictive in character—it being understood that the embodiments shown and described have been selected as representative examples including presently preferred embodiments plus others indicative of the nature of changes and modifications that come within the spirit of the invention(s) being disclosed and within the scope of invention(s) as claimed in this and any other applications that incorporate relevant portions of the present disclosure for support of those claims. Undoubtedly, other “variations” based on the teachings set forth herein will occur to one having ordinary skill in the art to which the present invention most nearly pertains, and such variations are intended to be within the scope of the present disclosure and of any claims to invention supported by said disclosure.

What is claimed is:

1. A shaped lens for use with an LED device to produce a rectangular light pattern on a surface; wherein the LED device comprises a square extended area LED emitting surface (an emitter greater than 1 mm square), the shaped lens comprising:
a refracting surface extending upward from a horizontal x-y plane having the square emitter extending horizontally and centered at the x-y-z origin, wherein the lens surface exhibits both two-axis orthogonal symmetry and 180 degree rotational symmetry about the central z-axis;
and wherein the lens surface profile around the periphery of any horizontal section is generally rectangular with obtuse corner angles and is generally convex between corner angles;
and further wherein the lens surface profile in any vertical section passing through the origin is generally convex upward and inward from the base plane through an apex and continuing convex downward and inward to an intermediate height end point at the z-axis.
